(19) United States
(12) Patent Application Publication
(10) Pub. No.: US 2025/0378311 A1
(43) Pub. Date: Dec. 11, 2025

(54) MACHINE LEARNING ARCHITECTURE FOR MODELING LOCAL AND GLOBAL FEATURES

(71) Applicants: President and Fellows of Harvard College, Cambridge, MA (US); The Broad Institute, Inc., Cambridge, MA (US); Massachusetts Institute of Technology, Cambridge, MA (US)

(72) Inventors: Pardis Sabeti, Cambridge, MA (US); Michael Mitzenmacher, Cambridge, MA (US); Krithik Ramesh, Cambridge, MA (US); Sameed Siddiqui, Cambridge, MA (US)

(21) Appl. No.: 19/231,037

(22) Filed: Jun. 6, 2025

Related U.S. Application Data
(60) Provisional application No. 63/657,738, filed on Jun. 7, 2024.
(60) Provisional application No. 63/763,083, filed on Feb. 25, 2025.

(51) Int. Cl. G06N 3/0464; G06N 3/08

(52) U.S. Cl. CPC G06N 3/0464; G06N 3/08

(57) ABSTRACT

Deep learning tools such as convolutional neural networks (CNNs) and transformers have spurred great advancements in computational biology. However, existing methods are constrained architecturally in context length, computational complexity, and model size. This application introduces a sub-quadratic architecture for modeling, which combines projected gated convolutions and structured state spaces to achieve local and global context with, for example, single-nucleotide resolution. These models outperform CNN-, GPT-, BERT-, and long convolution-based models in many tested genomics tasks without pre-training and with 4×-781× fewer parameters. In the proteomics domain, these models similarly outperform pretrained attention-based models, including ESM-1B and TAPE-BERT, on remote homology prediction without pre-training and while using 3,308×-23,636× fewer parameters.

### CROSS-REFERENCE TO RELATED APPLICATIONS

This application is a non-provisional application, which claims the benefit of priority to U.S. Provisional Application No. 63/657,738, filed Jun. 7, 2024, and U.S. Provisional Application No. 63/763,083, filed Feb. 25, 2025. The contents of the above-identified applications are hereby fully incorporated herein by reference in their entirety.

### TECHNICAL FIELD

The subject matter disclosed herein is generally directed to methods, systems, and devices for novel machine learning architectures.

### BACKGROUND

Increasingly sophisticated deep learning models are used to understand biological systems, with emergent work relying on larger pre-trained models to capture the underlying sequence-function relationships hidden in the genomic and proteomic landscapes. While these techniques have shown promise, they still possess inherent limitations that hinder efficient modeling of sequences at scale, a challenge particularly relevant in fields such as genomics with large datasets and complex chemical relationships between sequences.

Two architectural paradigms have dominated in computational biology: convolutional neural networks (CNNs), and more recently, transformers. Convolutions are highly parallelizable primitives which demonstrate strong performance on determining localized patterns, like motifs in DNA sequences (Zhou & Troyanskaya, 2015; Xiang et al., 2021). However, CNNs are constrained by an inherently low receptive field, a consequence of fixed-length kernels that are typically smaller than the sequence length. This limitation makes it challenging to capture relationships over extensive distances such as tens of thousands of base pairs, a task that remains difficult even when employing multiple filters and dilated convolutions (Avsec et al., 2021). On the other hand, transformers excel in modeling global pairwise relationships and have demonstrated remarkable success in generative and classification tasks (Li et al., 2023; Avsec et al., 2021). However, transformers are limited by their quadratic complexity in computing attention, constraining context size and sequence representation.

Integrating both local and global contexts is crucial for maximizing performance in biological tasks, which involve a complex interplay of short-range and long-range interactions between sequence elements. While transformers excel in capturing global context, they face challenges in effectively integrating local sequence details, leading to a reliance on combining them with CNNs for a more comprehensive understanding. This underscores the need for architectures that can inherently balance and integrate both local and global contexts efficiently.

Current efforts in model development are directed towards refining attention mechanisms in transformers to maintain input-dependent interactions while balancing efficiency with the global and local tradeoff. In response to these limitations, a new generation of models, namely the State Spaces Sequence-to-Sequence model (S4) and Hyena, have emerged (Gu et al., 2021a; Poli et al., 2023). These models pivot towards enhancing convolutions by leveraging state space theory and multi-layer perceptrons to implicitly create dynamic, input-dependent long convolution kernels.

While state space and long convolution models have pushed the boundaries in reasoning and context length in computational biology, certain challenges in modelling remain to be addressed (Nguyen et al., 2023). While S4 and its variants produce input-dependent filters for convolutions, they struggle with in-context learning and associative recall tasks (Arora et al., 2023). Furthermore, while expanding the context window in the biological variant of Hyena, HyenaDNA (Nguyen et al., 2023), has proven beneficial for certain genomic tasks, it paradoxically diminishes performance on tasks involving shorter sequences. These issues suggests a deeper, foundational problem: how to effectively model sequences akin to transformers while still supporting extensive in-context learning for long sequences (Arora et al., 2023).

A key to understanding this problem lies in the mechanics of attention in transformers. Specifically, the attention mechanism enables a selection of key features in the data using an input-dependent gating strategy, in contrast to S4 which only has learnable filters without an input-dependent selection. This leads to poor performance in associative recall and in tasks which require an understanding of sequence interactions, as the modelling is dictated by static model parameters. To imbue convolutions with a similar level of adaptability and responsiveness found in attention mechanisms, there is a need for both gating mechanisms and input-dependent filters.

Further, conventional systems configured to assess local and global features based on human assessments of input data are inefficient, impractical, and require an unnecessarily long period of time. Human systems are unable to capture vast amounts of input data in real time. Unlike a machine learning system or artificial intelligence system, systems that rely on humans are unable to draw the subtle conclusions required to identify local and global features. Human systems are unable to create predictive models based on combined data collected from, for example, one or more nucleic acid sequences, one or more guide-target pairs, and/or one or more amino acid sequence.

Citation or identification of any document in this application is not an admission that such a document is available as prior art to the present invention.

### SUMMARY

In an embodiment, the technology described herein includes computer-implemented methods, computer program products, and systems to carry out machine learning architecture for modeling local and global features.

In an embodiment, the techniques described herein relate to a machine learning computer-implemented method, including: (a) receiving, by one or more computing devices, input data; (b) processing the input data with a projected gate convolution module and generating, by the projected gate convolution module, a first output data; and (c) processing the first output data with a state space module and generating, by the state space module, a second output data.

In an embodiment, the techniques described herein relate to a method, further including transmitting, by the one or more computing devices, the second output data to a user device associated with a user.

In an embodiment, the techniques described herein relate to a method, wherein the input data is first processed by one or more linear projections module, one or more root mean square (RMS) normalizations modules, or a combination thereof.

In an embodiment, the techniques described herein relate to a method, wherein the projected gate convolution module includes of one or more linear projections module, one or more root mean square (RMS) normalizations modules, or a combination thereof.

In an embodiment, the techniques described herein relate to a method, further including processing the second output data by the one or more linear projections module, one or more root mean square (RMS) normalizations modules, or a combination thereof; generating, by the one or more linear projections module, one or more root mean square (RMS) normalizations modules, or a combination thereof, a third output data; and transmitting, by the one or more computing devices, the third output data to a user device associated with a user.

In an embodiment, the techniques described herein relate to a method, wherein the one or more linear projections module includes of one or more weight matrix modules, one or more bias vector modules, one or more learnable filters module, or a combination thereof.

In an embodiment, the techniques described herein relate to a method, wherein the one or more weight matrix modules, the one or more bias vector modules, or a combination thereof independently include of a probability distribution or random assignment of matrix or vector components.

In an embodiment, the techniques described herein relate to a method, wherein the projected gate convolution module is not pre-trained.

In an embodiment, the techniques described herein relate to a method, wherein the probability distribution is a gaussian distribution.

In an embodiment, the techniques described herein relate to a method, wherein the one or more linear projections module, one or more root mean square (RMS) normalizations modules, or combination thereof are carried out in parallel.

In an embodiment, the techniques described herein relate to a method, wherein the projected gate convolution module includes of one or more convolutional layer.

In an embodiment, the techniques described herein relate to a method, wherein the one or more convolution layer includes of a one dimensional (1D) convolutional layer.

In an embodiment, the techniques described herein relate to a method, wherein the projected gate convolution module includes of Fast Fourier Transform (FFT).

In an embodiment, the techniques described herein relate to a method, wherein the 1D convolutional layer includes of FFT.

In an embodiment, the techniques described herein relate to a method, wherein the first output data includes of local features of the input data, global features of the input data, or a combination thereof.

In an embodiment, the techniques described herein relate to a method, wherein the first output data includes of a combination of the local features and the global features.

In an embodiment, the techniques described herein relate to a method, wherein the local and global features are processes and generated in parallel.

In an embodiment, the techniques described herein relate to a method, wherein the projected gate convolution module includes of embedding.

In an embodiment, the techniques described herein relate to a method, wherein the state space module is a structured state space module.

In an embodiment, the techniques described herein relate to a method, there the structured state space module is a diagonalized structured state space module.

In an embodiment, the techniques described herein relate to a method, wherein the state space module includes of a linear ordinary differential model or a convolutional model.

In an embodiment, the techniques described herein relate to a method, wherein the linear ordinary differential model or a convolutional model includes of a learning parameter module.

In an embodiment, the techniques described herein relate to a method, wherein the state space module includes of one or more convolutional kernels.

In an embodiment, the techniques described herein relate to a method, wherein the one or more convolutional kernels parallelizes training and generating an output.

In an embodiment, the techniques described herein relate to a method, wherein the one or more convolutional kernels perform the computations independently.

In an embodiment, the techniques described herein relate to a method, wherein the input data includes of one or more strings of characters.

In an embodiment, the techniques described herein relate to a method, wherein the one or more strings of characters includes of one or more amino acid sequence, one or more nucleic acid sequence, or a combination thereof.

In an embodiment, the techniques described herein relate to a method, wherein the input data further includes of feature data of the one or more amino acid sequence, one or more nucleic acid sequence, or a combination thereof.

In an embodiment, the techniques described herein relate to a method, wherein the one or more strings includes of one or more text.

In an embodiment, the techniques described herein relate to a method, wherein the one or more text includes of health records.

In an embodiment, the techniques described herein relate to a method, wherein the method includes of regression or classification.

In an embodiment, the techniques described herein relate to a method, wherein the second output data includes one or more correlation or classification of one or more feature of the input data.

In an embodiment, the techniques described herein relate to a method, wherein the projected gate convolution module includes of generating local and global features in parallel, the method of the projected gate convolution module including of: (a) processing the input data by embedding the input data into a data structure including one or more features of the input data; (b) transforming the embedded data with one or more transformation layers; (c) projecting the transformed data with two or more weight matrix modules and two or more bias vector modules; (d) normalizing the projected data with two or more RMS normalizations modules, thereby generating preliminary local data and global data; (e) processing the preliminary local data with one or more 1D convolutional layers, the one or more 1D convolutional layers include of one or more learnable filters and the one or more bias vector modules, thereby generating local data structure; (f) combining the local data and the global data, thereby generating universal data; (g) projecting the universal data with the one or more weight matrix modules and the one or more bias vector modules; and (h) normalizing the universal data with the one or more RMS normalizations modules, thereby generating the first output data including of the universal data.

In an embodiment, the techniques described herein relate to a method, further including training the projected gate convolution module, state space module, or a combination thereof with training data.

In an embodiment, the techniques described herein relate to a method, wherein the training data includes of biological data, chemical data, or a combination thereof.

In an embodiment, the techniques described herein relate to a method, wherein the biological data, chemical data, or a combination thereof includes of genomic data, proteomic data, epidemiological data, pharmacological data, epistatic data, or a combination thereof.

In an embodiment, the techniques described herein relate to a method, wherein the training data includes of health record data.

In an embodiment, the techniques described herein relate to a method, wherein the training data includes of diagnostic data.

In an embodiment, the techniques described herein relate to a method, wherein the projected gate convolution module, state space module, or a combination thereof is trained using a method selected independently from the group consisting of unsupervised learning, supervised learning, semi-supervised learning, reinforcement learning, transfer learning, incremental learning, curriculum learning, learning to learn, and contrastive learning.

In an embodiment, the techniques described herein relate to a method, wherein the state space module includes of no less than 3,000 parameters or no more than one million parameters.

In an embodiment, the techniques described herein relate to a method, wherein the state space module includes of no more than 5,000 parameters, no more than 10,000 parameters, no more than 50,000 parameters, no more than 100,000 parameters, no more than 250,000 parameters, no more than 500,000 parameters, no more than 750,000 parameters, no more than one million parameters.

In an embodiment, the techniques described herein relate to a method, wherein the state space module comprises one or more state space module data structures.

In an embodiment, the techniques described herein relate to a method, wherein the one or more state space module data structures includes at least three matrix data structures.

In an embodiment, the techniques described herein relate to a method, wherein the at least three matrix data structure comprises of a dynamic matrix data structure, a map matrix data structure, and a projection matrix data structure.

In an embodiment, the techniques described herein relate to a method, wherein the projected gate convolution module, state space module, or both comprises of one or more hidden dimensions.

In an embodiment, the techniques described herein relate to a method, wherein the one or more hidden dimension are independently selected from 2, 4, 8, 16, 32, 64, 128, 256, or 512 dimensions.

In an embodiment, the techniques described herein relate to a method of determining chromatin profiling comprising any method as described herein, wherein the input data is one or more nucleic acid sequences, and the second output data is one or more chromatin feature.

In an embodiment, the techniques described herein relate to a method of classifying gene regulating regions comprising any method as described herein, wherein the input data is one or more nucleic acid sequences, and the second output data is a determination of one or more gene regulating regions.

In an embodiment, the techniques described herein relate to a method of generating guide molecules for programmable molecules such as, but not limited to, CRISPR-Cas, IscB, IsrB, TnpB, and Fanzor comprising any method as described herein, wherein the input data is one or more target sequences, and the second output data is activity of the one or more guide molecules.

In an embodiment, the techniques described herein relate to a method of determining protein fitness comprising any method as described herein, wherein the input data is one or more amino acid sequence, and the second output data is stability, binding affinity, or a combination thereof of the one or more amino acid sequence.

In an embodiment, the techniques described herein relate to a method of modeling protein features comprising of any method as described herein, wherein the input data is one or more amino acid sequence, and the second output data is remote homology, fluorescence, protein stability, or a combination thereof.

In an embodiment, the techniques described herein relate to a system to carry out a machine learning method, including: a storage device; and a processor communicatively coupled to the storage device, wherein the processor executes application code instructions that are stored in the storage device to cause the system to: (a) receive, by one or more computing devices, input data; (b) process the input data with a projected gate convolution module and generating, by the projected gate convolution module, a first output data; and (c) process the first output data with a state space module and generating, by the state space module, a second output data

In an embodiment, the techniques described herein relate to a system, further including transmitting, by the one or more computing devices, the second output data to a user device associated with a user.

In an embodiment, the techniques described herein relate to a system, wherein the input data is first processed by one or more linear projections module, one or more root mean square (RMS) normalizations modules, or a combination thereof.

In an embodiment, the techniques described herein relate to a system, wherein the projected gate convolution module includes of one or more linear projections module, one or more root mean square (RMS) normalizations modules, or a combination thereof.

In an embodiment, the techniques described herein relate to a system, further including processing the second output data by the one or more linear projections module, one or more root mean square (RMS) normalizations modules, or a combination thereof; generating, by the one or more linear projections module, one or more root mean square (RMS) normalizations modules, or a combination thereof, a third output data; and transmitting, by the one or more computing devices, the third output data to a user device associated with a user.

In an embodiment, the techniques described herein relate to a system, wherein the one or more linear projections module includes of one or more weight matrix modules, one or more bias vector modules, one or more learnable filters module, or a combination thereof.

In an embodiment, the techniques described herein relate to a system, wherein the one or more weight matrix modules, the one or more bias vector modules, or a combination thereof independently include of a probability distribution or random assignment of matrix or vector components.

In an embodiment, the techniques described herein relate to a system, wherein the projected gate convolution module is not pre-trained.

In an embodiment, the techniques described herein relate to a system, wherein the probability distribution is a gaussian distribution.

In an embodiment, the techniques described herein relate to a system, wherein the one or more linear projections module, one or more root mean square (RMS) normalizations modules, or combination thereof are carried out in parallel.

In an embodiment, the techniques described herein relate to a system, wherein the projected gate convolution module includes of one or more convolutional layer.

In an embodiment, the techniques described herein relate to a system, wherein the one or more convolution layer includes of a one dimensional (1D) convolutional layer.

In an embodiment, the techniques described herein relate to a system, wherein the projected gate convolution module includes of Fast Fourier Transform (FFT).

In an embodiment, the techniques described herein relate to a system, wherein the 1D convolutional layer includes of FFT.

In an embodiment, the techniques described herein relate to a system, wherein the first output data includes of local features of the input data, global features of the input data, or a combination thereof.

In an embodiment, the techniques described herein relate to a system, wherein the first output data includes of a combination of the local features and the global features.

In an embodiment, the techniques described herein relate to a system, wherein the local and global features are processes and generated in parallel.

In an embodiment, the techniques described herein relate to a system, wherein the projected gate convolution module includes of embedding.

In an embodiment, the techniques described herein relate to a system, wherein the state space module is a structured state space module.

In an embodiment, the techniques described herein relate to a system, there the structured state space module is a diagonalized structured state space module.

In an embodiment, the techniques described herein relate to a system, wherein the state space module includes of a linear ordinary differential model or a convolutional model.

In an embodiment, the techniques described herein relate to a system, wherein the linear ordinary differential model or a convolutional model includes of a learning parameter module.

In an embodiment, the techniques described herein relate to a system, wherein the state space module includes of one or more convolutional kernels.

In an embodiment, the techniques described herein relate to a system, wherein the one or more convolutional kernels parallelizes training and generating an output.

In an embodiment, the techniques described herein relate to a system, wherein the one or more convolutional kernels perform the computations independently.

In an embodiment, the techniques described herein relate to a system, wherein the input data includes of one or more strings of characters.

In an embodiment, the techniques described herein relate to a system, wherein the one or more strings of characters includes of one or more amino acid sequence, one or more nucleic acid sequence, or a combination thereof.

In an embodiment, the techniques described herein relate to a system, wherein the input data further includes of feature data of the one or more amino acid sequence, one or more nucleic acid sequence, or a combination thereof.

In an embodiment, the techniques described herein relate to a system, wherein the one or more strings includes of one or more text.

In an embodiment, the techniques described herein relate to a system, wherein the one or more text includes of health records.

In an embodiment, the techniques described herein relate to a system, wherein the system includes of regression or classification.

In an embodiment, the techniques described herein relate to a system, wherein the second output data includes one or more correlation or classification of one or more feature of the input data.

In an embodiment, the techniques described herein relate to a system, wherein the projected gate convolution module includes of generating local and global features in parallel, the method of the projected gate convolution module including of: (a) processing the input data by embedding the input data into a data structure including one or more features of the input data; (b) transforming the embedded data with one or more transformation layers; (c) projecting the transformed data with two or more weight matrix modules and two or more bias vector modules; (d) normalizing the projected data with two or more RMS normalizations modules, thereby generating preliminary local data and global data; (e) processing the preliminary local data with one or more 1D convolutional layers, the one or more 1D convolutional layers include of one or more learnable filters and the one or more bias vector modules, thereby generating local data structure; (f) combining the local data and the global data, thereby generating universal data; (g) projecting the universal data with the one or more weight matrix modules and the one or more bias vector modules; and (h) normalizing the universal data with the one or more RMS normalizations modules, thereby generating the first output data including of the universal data.

In an embodiment, the techniques described herein relate to a system, further including training the projected gate convolution module, state space module, or a combination thereof with training data.

In an embodiment, the techniques described herein relate to a system, wherein the training data includes of biological data, chemical data, or a combination thereof.

In an embodiment, the techniques described herein relate to a system, wherein the biological data, chemical data, or a combination thereof includes of genomic data, proteomic data, epidemiological data, pharmacological data, epistatic data, or a combination thereof.

In an embodiment, the techniques described herein relate to a system, wherein the training data includes of health record data.

In an embodiment, the techniques described herein relate to a system, wherein the training data includes of diagnostic data.

In an embodiment, the techniques described herein relate to a system, wherein the projected gate convolution module, state space module, or a combination thereof is trained using a method selected independently from the group consisting of unsupervised learning, supervised learning, semi-supervised learning, reinforcement learning, transfer learning, incremental learning, curriculum learning, learning to learn, and contrastive learning.

In an embodiment, the techniques described herein relate to a system, wherein the state space module includes of no less than 3,000 parameters or no more than one million parameters.

In an embodiment, the techniques described herein relate to a system, wherein the state space module includes of no more than 5,000 parameters, no more than 10,000 parameters, no more than 50,000 parameters, no more than 100,000 parameters, no more than 250,000 parameters, no more than 500,000 parameters, no more than 750,000 parameters, no more than one million parameters.

In an embodiment, the techniques described herein relate to a system, wherein the state space module comprises one or more state space module data structures.

In an embodiment, the techniques described herein relate to a system, wherein the one or more state space module data structures includes at least three matrix data structures.

In an embodiment, the techniques described herein relate to a system, wherein the at least three matrix data structure comprises of a dynamic matrix data structure, a map matrix data structure, and a projection matrix data structure.

In an embodiment, the techniques described herein relate to a system, wherein the projected gate convolution module, state space module, or both comprises of one or more hidden dimensions.

In an embodiment, the techniques described herein relate to a system, wherein the one or more hidden dimension are independently selected from 2, 4, 8, 16, 32, 64, 128, 256, or 512 dimensions.

In an embodiment, the techniques described herein relate to a method of determining chromatin profiling comprising any method as described herein, wherein the input data is one or more nucleic acid sequences, and the second output data is one or more chromatin feature.

In an embodiment, the techniques described herein relate to a system of classifying gene regulating regions comprising any system as described herein, wherein the input data is one or more nucleic acid sequences, and the second output data is a determination of one or more gene regulating regions.

In an embodiment, the techniques described herein relate to a system of generating guide molecules for programmable nucleases such as, but not limited to, CRISPR-Cas, IscB, IsrB, TnpB, and Fanzor CRISPR-Cas using any system as described herein, wherein the input data is one or more target sequences, and the second output data is activity of the one or more guide molecules.

In an embodiment, the techniques described herein relate to a system of determining protein fitness comprising any system as described herein, wherein the input data is one or more amino acid sequence, and the second output data is stability, binding affinity, or a combination thereof of the one or more amino acid sequence.

In an embodiment, the techniques described herein relate to a system of modeling protein features comprising any system as described herein, wherein the input data is one or more amino acid sequence, and the second output data is remote homology, fluorescence, protein stability, or a combination thereof.

In an embodiment, the techniques described herein relate to a computer program product, including: a non-transitory computer-readable storage device having computer-executable program instructions embodied thereon that when executed by a computer cause the computer to carry out a machine learning method, the computer-executable program instructions including: (a) receive, by one or more computing devices, input data; (b) process the input data with a projected gate convolution module and generating, by the projected gate convolution module, a first output data; and (c) process the first output data with a state space module and generating, by the state space module, a second output data.

In an embodiment, the techniques described herein relate to a product, further including transmitting, by the one or more computing devices, the second output data to a user device associated with a user.

In an embodiment, the techniques described herein relate to a product, wherein the input data is first processed by one or more linear projections module, one or more root mean square (RMS) normalizations modules, or a combination thereof.

In an embodiment, the techniques described herein relate to a product, wherein the projected gate convolution module includes of one or more linear projections module, one or more root mean square (RMS) normalizations modules, or a combination thereof.

In an embodiment, the techniques described herein relate to a product, further including processing the second output data by the one or more linear projections module, one or more root mean square (RMS) normalizations modules, or a combination thereof; generating, by the one or more linear projections module, one or more root mean square (RMS) normalizations modules, or a combination thereof, a third output data; and transmitting, by the one or more computing devices, the third output data to a user device associated with a user.

In an embodiment, the techniques described herein relate to a product, wherein the one or more linear projections module includes of one or more weight matrix modules, one or more bias vector modules, one or more learnable filters module, or a combination thereof.

In an embodiment, the techniques described herein relate to a product, wherein the one or more weight matrix modules, the one or more bias vector modules, or a combination thereof independently include of a probability distribution or random assignment of matrix or vector components.

In an embodiment, the techniques described herein relate to a product, wherein the projected gate convolution module is not pre-trained.

In an embodiment, the techniques described herein relate to a product, wherein the probability distribution is a gaussian distribution.

In an embodiment, the techniques described herein relate to a product, wherein the one or more linear projections module, one or more root mean square (RMS) normalizations modules, or combination thereof are carried out in parallel.

In an embodiment, the techniques described herein relate to a product, wherein the projected gate convolution module includes of one or more convolutional layer.

In an embodiment, the techniques described herein relate to a product, wherein the one or more convolution layer includes of a one dimensional (1D) convolutional layer.

In an embodiment, the techniques described herein relate to a product, wherein the projected gate convolution module includes of Fast Fourier Transform (FFT).

In an embodiment, the techniques described herein relate to a product, wherein the 1D convolutional layer includes of FFT.

In an embodiment, the techniques described herein relate to a product, wherein the first output data includes of local features of the input data, global features of the input data, or a combination thereof.

In an embodiment, the techniques described herein relate to a product, wherein the first output data includes of a combination of the local features and the global features.

In an embodiment, the techniques described herein relate to a product, wherein the local and global features are processes and generated in parallel.

In an embodiment, the techniques described herein relate to a product, wherein the projected gate convolution module includes of embedding.

In an embodiment, the techniques described herein relate to a product, wherein the state space module is a structured state space module.

In an embodiment, the techniques described herein relate to a product, there the structured state space module is a diagonalized structured state space module.

In an embodiment, the techniques described herein relate to a product, wherein the state space module includes of a linear ordinary differential model or a convolutional model.

In an embodiment, the techniques described herein relate to a product, wherein the linear ordinary differential model or a convolutional model includes of a learning parameter module.

In an embodiment, the techniques described herein relate to a product, wherein the state space module includes of one or more convolutional kernels.

In an embodiment, the techniques described herein relate to a product, wherein the one or more convolutional kernels parallelizes training and generating an output.

In an embodiment, the techniques described herein relate to a product, wherein the one or more convolutional kernels perform the computations independently.

In an embodiment, the techniques described herein relate to a product, wherein the input data includes of one or more strings of characters.

In an embodiment, the techniques described herein relate to a product, wherein the one or more strings of characters includes of one or more amino acid sequence, one or more nucleic acid sequence, or a combination thereof.

In an embodiment, the techniques described herein relate to a product, wherein the input data further includes of feature data of the one or more amino acid sequence, one or more nucleic acid sequence, or a combination thereof.

In an embodiment, the techniques described herein relate to a product, wherein the one or more strings includes of one or more text.

In an embodiment, the techniques described herein relate to a product, wherein the one or more text includes of health records.

In an embodiment, the techniques described herein relate to a product, wherein the product includes of regression or classification.

In an embodiment, the techniques described herein relate to a product, wherein the second output data includes one or more correlation or classification of one or more feature of the input data.

In an embodiment, the techniques described herein relate to a product, wherein the projected gate convolution module includes of generating local and global features in parallel, the method of the projected gate convolution module including of: (a) processing the input data by embedding the input data into a data structure including one or more features of the input data; (b) transforming the embedded data with one or more transformation layers; (c) projecting the transformed data with two or more weight matrix modules and two or more bias vector modules; (d) normalizing the projected data with two or more RMS normalizations modules, thereby generating preliminary local data and global data; (e) processing the preliminary local data with one or more 1D convolutional layers, the one or more 1D convolutional layers include of one or more learnable filters and the one or more bias vector modules, thereby generating local data structure; (f) combining the local data and the global data, thereby generating universal data; (g) projecting the universal data with the one or more weight matrix modules and the one or more bias vector modules; and (h) normalizing the universal data with the one or more RMS normalizations modules, thereby generating the first output data including of the universal data.

In an embodiment, the techniques described herein relate to a product, further including training the projected gate convolution module, state space module, or a combination thereof with training data.

In an embodiment, the techniques described herein relate to a product, wherein the training data includes of biological data, chemical data, or a combination thereof.

In an embodiment, the techniques described herein relate to a product, wherein the biological data, chemical data, or a combination thereof includes of genomic data, proteomic data, epidemiological data, pharmacological data, epistatic data, or a combination thereof.

In an embodiment, the techniques described herein relate to a product, wherein the training data includes of health record data.

In an embodiment, the techniques described herein relate to a product, wherein the training data includes of diagnostic data.

In an embodiment, the techniques described herein relate to a product, wherein the projected gate convolution module, state space module, or a combination thereof is trained using a method selected independently from the group consisting of unsupervised learning, supervised learning, semi-supervised learning, reinforcement learning, transfer learning, incremental learning, curriculum learning, learning to learn, and contrastive learning.

In an embodiment, the techniques described herein relate to a product, wherein the state space module includes of no less than 3,000 parameters or no more than one million parameters.

In an embodiment, the techniques described herein relate to a product, wherein the state space module includes of no more than 5,000 parameters, no more than 10,000 parameters, no more than 50,000 parameters, no more than 100,000 parameters, no more than 250,000 parameters, no more than 500,000 parameters, no more than 750,000 parameters, no more than one million parameters.

In an embodiment, the techniques described herein relate to a product, wherein the state space module comprises one or more state space module data structures.

In an embodiment, the techniques described herein relate to a product, wherein the one or more state space module data structures includes at least three matrix data structures.

In an embodiment, the techniques described herein relate to a product, wherein the at least three matrix data structure comprises of a dynamic matrix data structure, a map matrix data structure, and a projection matrix data structure.

In an embodiment, the techniques described herein relate to a product, wherein the projected gate convolution module, state space module, or both comprises of one or more hidden dimensions.

In an embodiment, the techniques described herein relate to a product, wherein the one or more hidden dimension are independently selected from 2, 4, 8, 16, 32, 64, 128, 256, or 512 dimensions.

In an embodiment, the techniques described herein relate to a product of determining chromatin profiling comprising any product as described herein, wherein the input data is one or more nucleic acid sequences, and the second output data is one or more chromatin feature.

In an embodiment, the techniques described herein relate to a product of classifying gene regulating regions comprising any product as described herein, wherein the input data is one or more nucleic acid sequences, and the second output data is a determination of one or more gene regulating regions.

In an embodiment, the techniques described herein relate to a composition comprising guide molecules for programmable nucleases such as, but not limited to, CRISPR-Cas, IscB, IsrB, TnpB, and Fanzor using any method or system as described herein, wherein the input data is one or more target sequences, and the second output data is activity of the one or more guide molecules.

In an embodiment, the techniques described herein relate to a protein designed using any method or system described herein, wherein the input data is one or more amino acid sequence, and the second output data is stability, binding affinity, or a combination thereof of the one or more amino acid sequence.

In an embodiment, the techniques described herein relate to a product of modeling protein features comprising any product as described herein, wherein the input data is one or more amino acid sequence, and the second output data is remote homology, fluorescence, protein stability, or a combination thereof.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present invention will be obtained by reference to the following detailed description that sets forth illustrative embodiments, in which the principles of the invention may be utilized, and the accompanying drawings of which:

FIG. 1—Overview of Janus (aka Lyra) applied to protein sequence analysis. The architecture employs a Projected Gated Convolution (PGC) to encode one-hot encoded (OHE) protein sequences into a rich feature representation, capturing local interaction patterns within the protein backbone. These PGC embeddings are further processed through an S4D layer, which integrates both local and global sequence information. The model effectively combines local structural insights with global contextual relationships, enabling accurate prediction of protein properties.

FIG. 2—A block diagram depicting a portion of a communications and processing architecture of a typical system to acquire input data from a user or database and perform machine learning methods resulting in a modeling architecture, in accordance with certain examples of the technology disclosed herein.

FIG. 3—A block flow diagram depicting methods to carry out the operation of machine learning methods, in accordance with certain examples of the technology disclosed herein.

FIG. 4—A block diagram depicting a computing machine and modules, in accordance with certain examples of the technology disclosed herein.

FIG. 5—(Left) The Lyra architecture introduces an efficient approach for biological sequence modeling, combining projected gated convolutions for local feature extraction with state space models for capturing long-range dependencies. (Center) Lyra addresses the fundamental challenge of modeling epistasis—complex interactions between sequence elements—by leveraging SSMs' natural ability to approximate polynomials. This mathematical alignment enables efficient O(N log N) scaling with sequence length, compared to the O(N²) complexity of attention-based approaches. (Right) Lyra's broad utility across biological domains: in proteomics, genomics, and CRISPR applications. Without pre-training and using orders of magnitude fewer parameters (up to 127,272× reduction), Lyra matches or exceeds state-of-the-art performance while providing substantial speedups compared to Transformer-based foundation models (on average 64.18× faster for batch size 2) in inference time.

FIG. 6A-6F—Lyra architecture enables efficient modeling of epistatic interactions through learned local and global relationships (6A) Architectural overview showing protein sequence processing through PGC (projected gated convolutions) and S4D layers (diagonalized state space models). (6B) (left) Mathematical formulation of architectural components, including projected gated convolutions and state space model representation of signals. (right) Visualization of different types of matrices (dense, Vandermonde, Toeplitz) used in various machine learning architectures. The convolution filters produced by the S4D layer of Lyra are materialized through a Vandermonde matrix, enabling the system to learn a set of basis polynomials. (6C) Visualization of different S4D kernels for a system with 16 filters of length 96. (6D) Comparison of polynomial approximation capabilities on synthetic data between Lyra and a similarly-sized Transformer model. (6E) Regression performance across different orders of epistatic interactions (1st-11th order), demonstrating Lyra's superior ability to accurately model higher-order interactions. (6F) Fitness landscape visualization showing how Lyra better characterizes the distribution of protein fitness compared to a similarly-sized Transformer model.

FIG. 7A-7E—Lyra achieves state-of-the-art performance across diverse protein prediction tasks. (7A) Schematic of intrinsically disordered protein regions prediction tasks. Performance comparison on disorder prediction tasks as conducted by Pang et al [41], demonstrating Lyra performance compared to models using input position-specific scoring matrices, one-hot encoding, or protein-language based feature representations ProtT5 [41] and ProtBERT [41] (7B) Performance of Lyra on deep mutational scanning (DMS) tasks[44,45] compared to baseline models [24,46-49] across multiple protein families. Lyra achieves state-of-the-art accuracy with a significantly smaller parameter count, highlighting its efficiency in mutation effect prediction. (7C) Lyra achieves state-of-the-art detection accuracy for RNA-dependent RNA polymerases (RDRPs) with significantly lower computational requirements. Performance is compared to baseline models using sequence-based and structure-aware versions of LucaProt[50]. (7D) Lyra accurately predicts protein fitness landscapes for antibody tasks and fluorescent protein brightness[51]. Performance is benchmarked against existing models, demonstrating Lyra's ability to capture complex sequence-function relationships (7E) Lyra achieves state-of-the-art regression performance on the Pentelute cell-penetrating peptide (CPP) dataset[52], surpassing previous models in accuracy while maintaining computational efficiency.

FIG. 8A-8F—Lyra performance on DNA and RNA sequence analysis tasks. (8A) (left) Schematic of promoter strength prediction, showing how sequence variations influence transcription levels. (right) Model parameter count and performance comparison for promoter activity prediction. (8B) Overview of RNA prediction tasks: splice site detection, ribosome loading efficiency, non-coding RNA classification, and polyadenylation site prediction. (8C) Comparison of relative model performance (where the best performing model in a task is normalized to 1) with respect to model size. Here, Lyra (dark gray-right) is compared to the best performing models (light grays—left and center) of different parameter size ranges. Secondary structure prediction—∘; Structural score imputation—□; Splice site prediction—⋄, APA Isoform Prediction—Δ; noncoding RNA classification—∇; RNA Modification— [symbol] ; Mean ribosome loading— [symbol] , Programmable RNA switches [symbol] , CRISPR-Off target rate prediction—X. (8D) Schematic of CRISPR Cas9 and Cas13 cleavage. (8E-8F) Comparison of Lyra and various models.

FIG. 9A-9E—Computational efficiency analysis of Lyra compared to existing models. (9A) Wall clock time versus sequence length, demonstrating Lyra's favorable scaling compared to Transformer-based (ESM-1b[9], DistilProtBert) and other convolutional (HyenaDNA) architectures. (9B) Memory requirements comparison across models, highlighting Lyra's reduced resource needs. (9C) Performance on the selective copying synthetic task, where models are evaluated on their ability to identify mutations occurring at non-uniform intervals. The task is based on GFP sequence mutations, and models are assessed using accuracy metrics. (9D) Visualization of convolution filters in S4D and Hyena, alongside model outputs for the same sequence in PGC and Transformer encoder attention layers. Includes an investigation of singular values across different sequence modeling primitives. (9E) Benchmarking results across regulatory genomics (left, middle) and proteomics tasks, with comparisons to equivalently-sized Hyena and Transformer models.

The figures herein are for illustrative purposes only and are not necessarily drawn to scale.

### DETAILED DESCRIPTION OF THE EXAMPLE EMBODIMENTS

### Overview

The embodiments disclosed herein can utilize a machine learning architecture for modeling local and global features, as further defined below, which in turn allows for a simpler and faster machine learning model.

In one aspect, technologies herein provide methods to machine learning architecture for modeling local and global features. In one aspect, technology includes a machine learning architecture to operate on user computing devices. The application may be a downloadable application or application programming interface for use on a computing device.

In another aspect, the technology includes applications and systems to machine learning architecture for modeling local and global features. For example, applications may be provided to individual users capable of communicating through wireless means.

In one aspect, technologies herein provide methods to use machine learning systems to analyze input data to output data. In an embodiment, a graphical user interface is used to display a visualization of the output data.

Because of the immense amount of data that is acquired, processed, and categorized, any number of human users would be unable to create the predictive models or perform the operations described herein.

The methods, systems, and devices represents an advance in computer engineering that represents a substantial advancement over existing practices. The data acquired to prepare the predictive models are technical data relating to input data. The outputs of the machine learning systems are not obtainable by humans or by conventional methods. Implementing a projected gate convolution module and state space module creates a predictive system and is a non-conventional, technical, real-world output and benefit that is not obtainable with conventional systems. The methods and systems described herein are more consistent, accurate, and efficient than manual/human analysis, which is prone to bias and doesn't scale to the amount of qualitative data that is generated today.

Standard techniques related to making and using aspects of the invention may or may not be described in detail herein. Various aspects of computing systems and specific computer programs to implement the various technical features described herein are well known.

### Example System Architectures

Turning now to the drawings, in which like numerals represent like (but not necessarily identical) elements throughout the figures, example embodiments are described in detail.

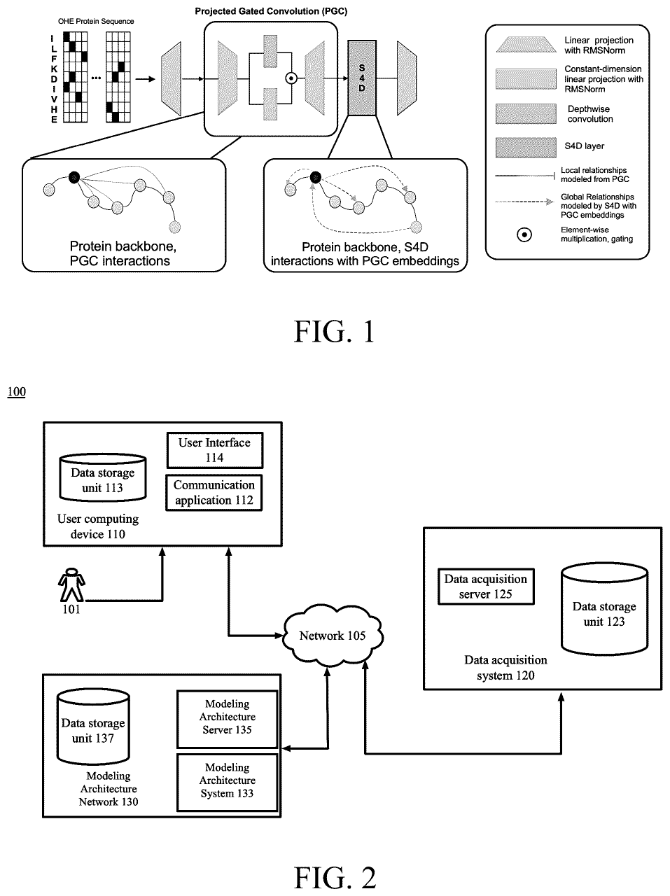

FIG. 2 is a block diagram depicting a system 100 to perform machine learning on input data. In one example embodiment, a user 101 associated with a user computing device 110 must install an application, and or make a feature selection to obtain the benefits of the techniques described herein.

As depicted in FIG. 2, the system 100 includes network computing devices/systems 110, 120, and 130 that are configured to communicate with one another via one or more networks 105 or via any suitable communication technology.

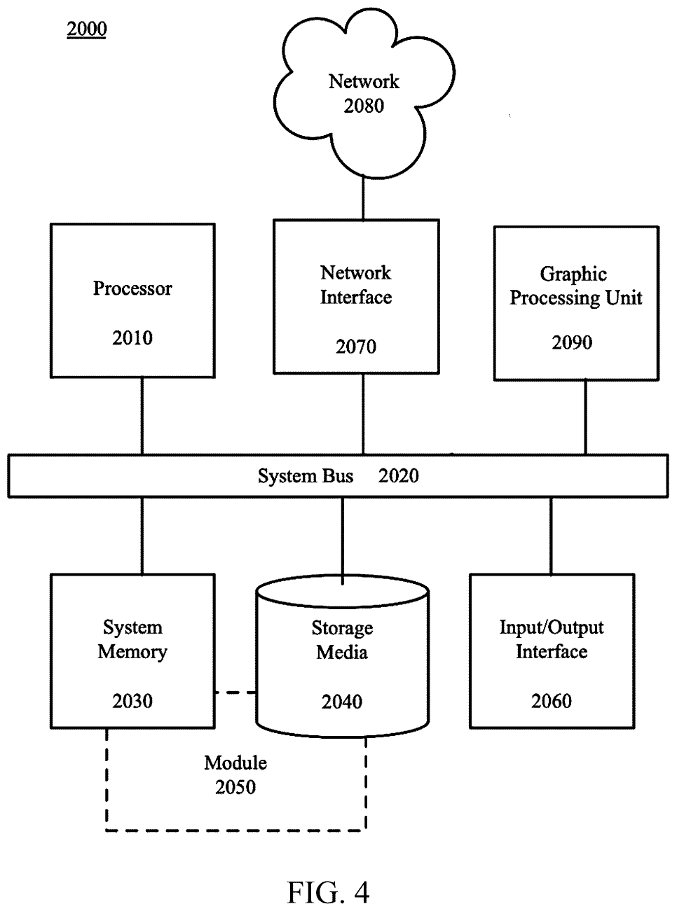

Each network 105 includes a wired or wireless telecommunication means by which network devices/systems (including devices 110, 120, and 130) can exchange data. For example, each network 105 can include any of those described herein such as the network 2080 described in FIG. 4 or any combination thereof or any other appropriate architecture or system that facilitates the communication of signals and data. Throughout the discussion of example embodiments, it should be understood that the terms “data” and “information” are used interchangeably herein to refer to text, images, audio, video, or any other form of information that can exist in a computer-based environment. The communication technology utilized by the devices/systems 110, 120, and 130 may be similar networks to network 105 or an alternative communication technology.

Each network computing device/system 110, 120, and 130 includes a computing device having a communication module capable of transmitting and receiving data over the network 105 or a similar network. For example, each network device/system 110, 120, and 130 can include any computing machine 2000 described herein and found in FIG. 4 or any other wired or wireless, processor-driven device. In the example embodiment depicted in FIG. 2, the network devices/systems 110, 120, and 130 are operated by user 101, data acquisition system operators, and modeling architecture network operators, respectively.

The user computing device 110 includes a user interface 114. The user interface 114 may be used to display a graphical user interface and other information to the user 101 to allow the user 101 to interact with the data acquisition system 120, the modeling architecture network 130, and others. The user interface 114 receives user input for data acquisition and/or machine learning and displays results to user 101. In another example embodiment, the user interface 114 may be provided with a graphical user interface by the data acquisition system 120 and or the modeling architecture network 130. The user interface 114 may be accessed by the processor of the user computing device 110. The user interface may display 114 may display a webpage associate with the data acquisition system 120 and/or the modeling architecture network 130. The user interface 114 may be used to provide input, configuration data, and other display direction by the webpage of the data acquisition system 120 and/or the modeling architecture network 130. In another example embodiment, the user interface 114 may be managed by the data acquisition system 120, the modeling architecture network 130, or others. In another example embodiment, the user interface 114 may be managed by the user computing device 110 and be prepared and displayed to the user 101 based on the operations of the user computing device 110.

The user 101 can use the communication application 112 on the user computing device 110, which may be, for example, a web browser application or a stand-alone application, to view, download, upload, or otherwise access documents or web pages through the user interface 114 via the network 105. The user computing device 110 can interact with the web servers or other computing devices connected to the network, including the data acquisition server 125 of the data acquisition system 120 and the modeling architecture server 135 of the modeling architecture network 130. In another example embodiment, the user computing device 110 communicates with devices in the data acquisition system 120 and/or the modeling architecture network 130 via any other suitable technology, including the example computing system described below.

The user computing device 110 also includes a data storage unit 113 accessible by the user interface 114, the communication application 112, or other applications. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In another example embodiments, the data storage unit 113 may reside in a cloud-based computing system.

An example data acquisition system 120 comprises a data storage unit 123 and an acquisition server 125. The data storage unit 123 can include any local or remote data storage structure accessible to the data acquisition system 120 suitable for storing information. The data storage unit 123 can include one or more tangible computer-readable storage devices, or the data storage unit 123 may be a separate system, such as a different physical or virtual machine or a cloud-based storage service.

In one aspect, the data acquisition server 125 communicates with the user computing device 110 and/or the modeling architecture network 130 to transmit requested data. The data may include input data as described further herein.

An example modeling architecture network 130 comprises a modeling architecture system 133, a modeling architecture server 135, and a data storage unit 137. The modeling architecture server 135 communicates with the user computing device 110 and/or the data acquisition system 120 to request and receive data. The data may comprise the data types previously described in reference to the data acquisition server 125.

The modeling architecture system 133 receives an input of data from the modeling architecture server 135. The modeling architecture system 133 can comprise one or more functions to implement any of the mentioned training methods to learn an output from an input. In an embodiment, the machine learning program may include a projected gate convolution module and/or state space module. In an embodiment, the projected gate convolution module includes of one or more linear projections module, one or more root mean square (RMS) normalizations modules, or a combination thereof. In an embodiment, one or more linear projections module comprises of one or more weight matrix modules, one or more bias vector modules, one or more learnable filters module, or a combination thereof. In an embodiment, the projected gate convolution module includes of one or more convolutional layer. In an embodiment, wherein the state space module is a structured state space module. In an embodiment, there the structured state space module is a diagonalized structured state space module. In an embodiment, the state space module comprises of a linear ordinary differential model or a convolutional model. In an embodiment, the linear ordinary differential model or a convolutional model comprises of a learning parameter module. In an embodiment, the state space module comprises of a convolutional kernel.

The data storage unit 137 can include any local or remote data storage structure accessible to the modeling architecture network 130 suitable for storing information. The data storage unit 137 can include one or more tangible computer-readable storage devices, or the data storage unit 137 may be a separate system, such as a different physical or virtual machine or a cloud-based storage service.

In an alternate embodiment, the functions of either or both of the data acquisition system 120 and the modeling architecture network 130 may be performed by the user computing device 110.

It will be appreciated that the network connections shown are examples, and other means of establishing a communications link between the computers and devices can be used. Moreover, those having ordinary skill in the art having the benefit of the present disclosure will appreciate that the user computing device 110, data acquisition system 120, and the modeling architecture network 130 illustrated in FIG. 2 can have any of several other suitable computer system configurations. For example, a user computing device 110 embodied as a mobile phone or handheld computer may not include all the components described above.

In an embodiment, the network computing devices and any other computing machines associated with the technology presented herein may be any type of computing machine such as, but not limited to, those discussed in more detail with respect to FIG. 4. Furthermore, any modules associated with any of these computing machines, such as modules described herein or any other modules (scripts, web content, software, firmware, or hardware) associated with the technology presented herein may by any of the modules discussed in more detail with respect to FIG. 4. The computing machines discussed herein may communicate with one another as well as other computer machines or communication systems over one or more networks, such as network 105. The network 105 may include any type of data or communications network, including any of the network technology discussed with respect to FIG. 4.

### Example Processes

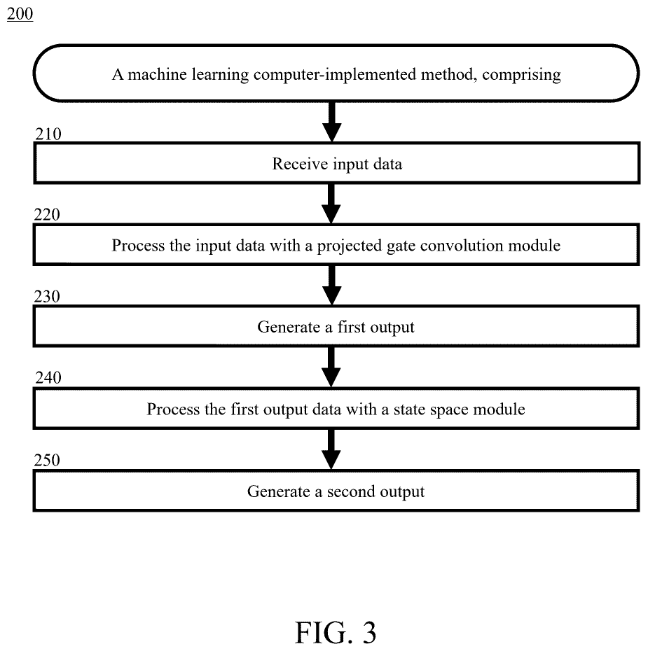

The example methods illustrated in FIG. 3 is described hereinafter with respect to the components of the example architecture 100. The example methods also can be performed with other systems and in other architectures including similar elements.

Referring to FIG. 3, and continuing to refer to FIG. 2 for context, a block flow diagram 200 illustrates a machine learning computer-implemented method, in accordance with certain examples of the technology disclosed herein.

In block 210, the modeling architecture network 130 receives input data. The modeling architecture network 130 may receive the input data from the user computing device 110, the data acquisition system 120, or any other suitable source of input data via the network 105 to the modeling architecture network 130, discussed in more detail in other sections herein. The acquisition engine comprises any software or hardware individually or in combination described herein that is capable of communicating with a user device, such as fetching, receiving, or sending information, thereby allowing access to the input data and/or output data by the modeling architecture network 130 or the data acquisition system 120.

### Input Data

The methods, systems, and devices described herein take in input data and produces output data. The input data and output data can include string data types, integer data types, floating point data types, or a combination thereof. A string data type includes a sequence of characters. Generally, the sequence includes characters or text of characters (e.g., ABC, AbC, abc, etc.), but may also include numbers and/or symbols (e.g., A1B, A@b, etc.). An integer data type includes numbers (e.g., 1234, etc.) and a floating-point data type includes numbers that may or may not include fractional components (e.g., 1234, 1.234, etc.). The input data and output data may be the same data type or different data types. In an embodiment, the input comprises of one or more strings of characters. In an embodiment, the one or more strings comprises of one or more text.

In an embodiment, the one or more strings of characters comprises of one or more amino acid sequence, one or more nucleic acid sequence, or a combination thereof. In an embodiment, the input further comprises of feature data of the one or more amino acid sequence, one or more nucleic acid sequence, or a combination thereof. Feature data of an amino acid sequence and/or a nucleic acid sequence may include biochemical properties, biophysical properties, compositional properties, or a combination thereof. Biochemical properties, biophysical properties, and compositional properties of an amino acid sequence or nucleic acid sequence may include size, shape, solubility, hydrophobicity, ionization properties of its R group, polarity, charge, primary structure, secondary structure, tertiary structure, molecular volume, codon diversity, electrostatic charge, or any combination thereof.

In an embodiment, the one or more text comprises of health records. The health records may include electronic health records (EHRs), which include of a subject's, physician-generated, electronic medical records (EMRs) as well as a personal health record (PHR). Table 1 of Ambinder EP. Electronic health records. J Oncol Pract. 2005 July; 1 (2): 57-63, incorporated herein by reference, lists common functions of an EHR, which provide for the type of data an EHR may comprise. Similarly, Table 2 of Ambinder, incorporated herein by reference, lists some common medical and oncology-specific data elements (data fields), which EHRs may comprise. EMRs may comprise the clinical and administrative interactions between a provider (physician, nurse, telephone triage nurse, and others) and a subject. EMRs may further comprise the practice style, job function, knowledge and skill of the providers who contribute to it. EMRs may comprise unique data structures and data elements corresponding to the contributors of the EMR. An EMR may comprise a computer-based patient record (CPR), which is defines the basic functions of an EMR as defined by the Institute of Medicine. PHRs are medical record maintained by a subject. PHRs may comprise electronic copies of information subjects have received from their providers.

In an embodiment, the health record data comprises of longitudinal primary care data. In general, longitudinal primary care data (i.e., longitudinal patient data or longitudinal subject data) is information collected through a series of repeated observations of the same subject (i.e., person) over some period of time. For example, longitudinal primary care data may comprise of how a subject has interacted with various aspects of healthcare such as primary care, emergency visits, prescriptions, medication adherence, etc.

In block 220, the modeling architecture system 133 processes the input data. In an embodiment, the input data is processed with a projected gate convolution module. In an embodiment, the input data is processed by a projected gate convolution module based on data collected by the data acquisition system 120. Accordingly, human analysis or cataloging is not required. The process is performed automatically by the modeling architecture network 130 without human intervention, as described in the machine learning section below. The amount of data typically collected includes thousands to tens of thousands of data items for input data. The total number of users may include all users accessing the system or a portion of users using a particular aspect of the system (e.g., the portion of users using the mobile application as opposed to those using a web-browser portal). Human intervention in the process is not useful or required because the amount of data is too great. A team of humans would not be able to catalog or analyze the data in any useful manner. Moreover, a human cannot access the input data and perform the method steps and, from that data, generate a second output in an achievable amount of time.

In block 230, the projected gate convolution module generates a first output. In an embodiment, the first output is passed to the model architecture system 133 wherein the first output data may be further processed.

### Output Data

### First Output Data

In an embodiment, processing the input data with a projected gate convolution module and generating, by the projected gate convolution module, a first output data. The first output data may include local features of the input, global features of the input, or a combination thereof. The local features include data describing a connection between local parts of the input. Local parts of the input may be located within and including 50% from each other relative to the input data. For example, if the input data includes an amino acid sequence of 100 amino acids in lengths, the local data may include information on any two or more amino acids within and including 50 amino acids from each other (e.g., amino acid 25 and amino acid 75).

The global features include data describing a connection between global parts of the input. Global parts of the input may be located at positions greater than 50% from each other relative to the input data. For example, if the input data includes an amino acid sequence of 100 amino acids in lengths, the global data may include information on any two or more amino acids greater than 50 amino acids from each other (e.g., amino acid 20 and amino acid 80). In an embodiment, global features may also be referred to long-range dependencies.

In an embodiment, local data and global data is combined generating universal data. The universal data includes information such as, for example, patterns and/or dependencies from the input sequence connected between local data and global data.

In an embodiment, the projected gate convolution module comprises of generating local and global features in parallel. In an embodiment, the method of the projected gate convolution module includes processing the input data by embedding the input data into a data structure comprising one or more features of the input data. Embedding is further described herein.

In an embodiment, the method of the projected gate convolution module includes transforming the embedded data with one or more transformation layers. Transforming can include, for example, linear projection, RMS normalizations, or both of the embedded data.

In an embodiment, the method of the projected gate convolution module includes projecting the transformed data with two or more weight matrix modules and two or more bias vector modules.

In an embodiment, the method of the projected gate convolution module includes normalizing the projected data with two or more RMS normalizations modules, thereby generating preliminary local data and global data. In an embodiment, the method of the projected gate convolution module includes normalizing the projected data with two or more RMS normalizations modules, thereby generating preliminary local data and preliminary global data.

In an embodiment, the method of the projected gate convolution module includes processing the preliminary local data with one or more 1D convolutional layers, the one or more 1D convolutional layers comprise of one or more learnable filters and the one or more bias vector modules, thereby generating local data structure.

In an embodiment, the method of the projected gate convolution module includes processing the preliminary global data with one or more linear projections, thereby generating global data structure.

In an embodiment, the method of the projected gate convolution module includes combining the local data and the global data, thereby generating universal data. In an embodiment, the local data and global data are combined element-wise or component wise. In an embodiment, local data and global data are contained in a vector data structure or matrix data structure and the data structures are combined. In an embodiment, the vector data structure or matrix data structure are combined by vector or matrix multiplication.

In an embodiment, the method of the projected gate convolution module includes projecting the universal data with the one or more weight matrix modules and the one or more bias vector modules.

In an embodiment, the method of the projected gate convolution module includes normalizing the universal data with the one or more RMS normalizations modules, thereby generating the first output data comprising of the universal data.

In block 240, the modeling architecture system 133 processes the first output data. In an embodiment, the first output data is processed with a state space module. In an embodiment, the first output data is processed by a state space module based on data collected by the data acquisition system 120. Accordingly, human analysis or cataloging is not required. The process is performed automatically by the modeling architecture network 130 without human intervention, as described in the machine learning section below. The amount of data typically collected includes thousands to tens of thousands of data items for first output data. Human intervention in the process is not useful or required because the amount of data is too great. A team of humans would not be able to catalog or analyze the data in any useful manner. Moreover, a human cannot access the first output data and perform the method steps and, from that data, generate a second output in an achievable amount of time.

In block 230, the projected gate convolution module generates a second output. In an embodiment, the second output is passed to the model architecture system 133. In an embodiment, the second output data may be further processed.

### Second Output Data

In an embodiment, processing the first output data with a state space module and generating, by the state space module, a second output data. In an embodiment, the second output data comprises one or more correlation or classification of one or more feature of the input data. For example, the second output may include one or more chromatin features, a determination of one or more gene regulating regions, activity of the one or more guide molecules, stability and/or binding affinity of an amino acid sequence, remote homology fluorescence protein stability, or any combination thereof. In an embodiment, references to ‘an output’ or ‘the output’ recited herein may refer to second output data and will be apparent to one of ordinary skill in the art.

### Third Output Data

In an embodiment, the second output data is processed by the one or more linear projections module, one or more root mean square (RMS) normalizations modules, or a combination thereof. In an embodiment, the one or more linear projections module, one or more root mean square (RMS) normalizations modules, or a combination thereof, generate a third output data. The third output data may be transmitted, by one or more computing devices, the third output data to a user device associated with a user. The third output data may generally be further refined second output data. Processing the second output with any one or more linear projections module and or one or more root mean square (RMS) normalizations modules may further refine the second output data.

In an embodiment, a second output may refer to a third output. In other words, the recitation of the second output may imply the second output was processed with the one or more linear projections module, one or more root mean square (RMS) normalizations modules, or a combination thereof. In an embodiment, references to ‘an output’ or ‘the output’ recited herein may refer to second output data and will be apparent to one of ordinary skill in the art.

### Types of Output Data

In an embodiment, the output data comprises of biological data, chemical data, or a combination thereof. Biological data may include hierarchical data. Biological hierarchical data includes biological data at various scales such as molecular, cellular, tissue/organs, and/or systems. Chemical data may include a typically includes atomic data, chemical name, structure, molecular formula, and physical properties. Physical properties of chemical data may include transition point (e.g., melting point, boiling point, freezing point), density, electrostatics, pH, physical state (e.g., solid, liquid, gas), solubility, and/or vapor pressure.

In an embodiment, the biological data, chemical data, or a combination thereof comprises of genomic data, proteomic data, epidemiological data, pharmacological data, epistatic data, or a combination thereof. Genomic data may include one or more nucleic acid sequences, position of a gene, function of a gene, variation of nucleotide and/or gene, regulatory elements, and/or interactions between different genes and proteins. Proteomic data may include expression data (e.g., quantitative and/or qualitative protein expression, disease data associated with a protein, signal transduction), structural data (e.g., three-dimensional structure, crystal structure), and/or functional data (e.g., function of a protein, molecular mechanism(s), protein partner(s) and their interactions, signaling pathways). Epidemiological data may include disease data, demographic data, and/or geographic data. Pharmacological data may include drug(s), ligand(s), drug class(es), and/or their targets. Epistatic data may include a phenotypical effect between two or more nucleic acid and/or amino acid sequences (e.g., the presence of a gene affecting another gene, presence of one or more amino acid affecting protein function).

In an embodiment, biological data, chemical data, or a combination thereof includes: disorder annotations (e.g., disorder functions such as protein-binding, DNA-binding, RNA-binding, ion-binding, lipid-binding, and flexible linker regions); mutational landscapes (e.g., enzyme activity, RNA-binding, and fluorescent protein function); RNA-dependent RNA polymerase (RDRP) classification; protein fitness (e.g., stability and affinity, enrichment, or fluorescence values); cell-penetrating peptide (CPP) efficacy; RNA tasks such as secondary structure, structural score, splice site classification (e.g., nucleotide acceptor, donor, or neither), APA isoforms (e.g., usage ratio of the proximal polyadenylation site (PAS) in 3′ untranslated region (3′ UTR)), noncoding RNA (e.g., microRNAs (miRNAs), long noncoding RNAs (lncRNAs), and small interfering RNAs (siRNAs)), RNA modification, mean ribosome loading (e.g., an MRL value representing the level of mRNA translation activity into proteins), programmable RNA switch, CRISPR Off-Target Rate (an off-target frequency score quantifying CRISPR-induced mutations at unintended genomic locations); CRISPR Cas13a (e.g., guide-target pairs); CRISPR Cas9 (e.g., guide-target activity information); promoter task (e.g., synthetic modifications of the Ptre promoter, for example, via engineered and characterized through iterative mutation-construction-screening cycles); or any combination thereof.

Any of the input data and output data described herein may be used for training purposes of the method, systems, and devices described herein.

In an embodiment, the output (e.g., first, second, or third output) is transmitted back to the user via the network 105. In an embodiment, the resulting user information (i.e., output data) is stored on the data storage unit 137. In an embodiment, the resulting user information is immediately transmitted to the user's device. In an embodiment, the resulting user information is transmitted across the network 105 to the data acquisition system for subsequent access by the user associated device 110 or modeling architecture network 130.

The ladder diagrams, scenarios, flowcharts and block diagrams in the figures and discussed herein illustrate architecture, functionality, and operation of example embodiments and various aspects of systems, methods, and computer program products of the present invention. Each block in the flowchart or block diagrams can represent the processing of information and/or transmission of information corresponding to circuitry that can be configured to execute the logical functions of the present techniques. Each block in the flowchart or block diagrams can represent a module, segment, or portion of one or more executable instructions for implementing the specified operation or step. In an embodiment, the functions/acts in a block can occur out of the order shown in the figures and nothing requires that the operations be performed in the order illustrated. For example, two blocks shown in succession can executed concurrently or essentially concurrently. In another example, blocks can be executed in the reverse order. Furthermore, variations, modifications, substitutions, additions, or reduction in blocks and/or functions may be used with any of the ladder diagrams, scenarios, flow charts and block diagrams discussed herein, all of which are explicitly contemplated herein.

The ladder diagrams, scenarios, flow charts and block diagrams may be combined with one another, in part or in whole. Coordination will depend upon the required functionality. Each block of the block diagrams and/or flowchart illustration as well as combinations of blocks in the block diagrams and/or flowchart illustrations can be implemented by special purpose hardware-based systems that perform the aforementioned functions/acts or carry out combinations of special purpose hardware and computer instructions. Moreover, a block may represent one or more information transmissions and may correspond to information transmissions among software and/or hardware modules in the same physical device and/or hardware modules in different physical devices.

The present techniques can be implemented as a system, a method, a computer program product, digital electronic circuitry, and/or in computer hardware, firmware, software, or in combinations of them. The system may comprise distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as CPU or GPU.

The computer program product can include a program tangibly embodied in an information carrier (e.g., computer readable storage medium or media) having computer readable program instructions thereon for execution by, or to control the operation of, data processing apparatus (e.g., a processor) to carry out aspects of one or more embodiments of the present invention. It will be understood that each block of the flowchart illustrations and/or block diagrams, and combinations of blocks in the flowchart illustrations and/or block diagrams, can be implemented by computer readable program instructions.

The computer readable program instructions can be performed on general purpose computing device, special purpose computing device, or other programmable data processing apparatus to produce a machine, such that the instructions, which execute via, at least partially, by one or more processors that are temporarily configured (e.g., by software) or permanently configured to perform the functions/acts specified in the flowchart and/or block diagram block or blocks. The processors, either: temporarily or permanently; or partially configured, may comprise processor-implemented modules. The present techniques referred to herein may, in an embodiment, comprise processor-implemented modules. Functions/acts of the processor-implemented modules may be distributed among the one or more processors. Moreover, the functions/acts of the processor-implements modules may be deployed across a number of machines, where the machines may be located in a single geographical location or distributed across a number of geographical locations.

The computer readable program instructions can also be stored in a computer readable storage medium that can direct one or more computer devices, programmable data processing apparatuses, and/or other devices to carry out the function/acts of the processor-implemented modules. The computer readable storage medium containing all or partial processor-implemented modules stored therein, comprises an article of manufacture including instructions which implement aspects, operations, or steps to be performed of the function/act specified in the flowchart and/or block diagram block or blocks.

Computer readable program instructions described herein can be downloaded to a computer readable storage medium within a respective computing/processing devices from a computer readable storage medium. Optionally, the computer readable program instructions can be downloaded to an external computer device or external storage device via a network. A network adapter card or network interface in each computing/processing device can receive computer readable program instructions from the network and forward the computer readable program instructions for permanent or temporary storage in a computer readable storage medium within the respective computing/processing device.

Computer readable program instructions described herein can be assembler instructions, instruction-set-architecture (ISA) instructions, machine instructions, machine dependent instructions, microcode, firmware instructions, state-setting data, or either source code or object code. The computer readable program instructions can be written in any programming language such as compiled or interpreted languages. In addition, the programming language can be object-oriented programming language (e.g. “C++”) or conventional procedural programming languages (e.g. “C”) or any combination thereof may be used to as computer readable program instructions. The computer readable program instructions can be distributed in any form, for example as a stand-alone program, module, subroutine, or other unit suitable for use in a computing environment. The computer readable program instructions can execute entirely on one computer or on multiple computers at one site or across multiple sites connected by a communication network, for example on user's computer, partly on the user's computer, as a stand-alone software package, partly on the user's computer and partly on a remote computer or entirely on a remote computer or server. If the computer readable program instructions are executed entirely remote, then the remote computer can be connected to the user's computer through any type of network or the connection can be made to an external computer. In examples embodiments, electronic circuitry including, but not limited to, programmable logic circuitry, field-programmable gate arrays (FPGA), or programmable logic arrays (PLA) can execute the computer readable program instructions. Electronic circuitry can utilize state information of the computer readable program instructions to personalize the electronic circuitry, to execute functions/acts of one or more embodiments of the present invention.

Example embodiments described herein include logic or a number of components, modules, or mechanisms. Modules may comprise either software modules or hardware-implemented modules. A software module may be code embodied on a non-transitory machine-readable medium or in a transmission signal. A hardware-implemented module is a tangible unit capable of performing certain operations and may be configured or arranged in a certain manner. In an embodiment, one or more computer systems (e.g., a standalone, client or server computer system) or one or more processors may be configured by software (e.g., an application or application portion) as a hardware-implemented module that operates to perform certain operations as described herein.

In an embodiment, a hardware-implemented module may be implemented mechanically or electronically. In an embodiment, hardware-implemented modules may comprise permanently configured dedicated circuitry or logic to execute certain functions/acts such as a special-purpose processor or logic circuitry (e.g., a field programmable gate array (FPGA) or an application-specific integrated circuit (ASIC)). In an embodiment, hardware-implemented modules may comprise temporary programmable logic or circuitry to perform certain functions/acts. For example, a general-purpose processor or other programmable processor.

The term “hardware-implemented module” encompasses a tangible entity. A tangible entity may be physically constructed, permanently configured, or temporarily or transitorily configured to operate in a certain manner and/or to perform certain functions/acts described herein. Hardware-implemented modules that are temporarily configured need not be configured or instantiated at any one time. For example, if the hardware-implemented modules comprise a general-purpose processor configured using software, then the general-purpose processor may be configured as different hardware-implemented modules at different times.

Hardware-implemented modules can provide, receive, and/or exchange information from/with other hardware-implemented modules. The hardware-implemented modules herein may be communicatively coupled. Multiple hardware-implemented modules operating concurrently, may communicate through signal transmission, for instance appropriate circuits and buses that connect the hardware-implemented modules. Multiple hardware-implemented modules configured or instantiated at different times may communicate through temporarily or permanently archived information, for instance the storage and retrieval of information in memory structures to which the multiple hardware-implemented modules have access. For example, one hardware-implemented module may perform an operation, and store the output of that operation in a memory device to which it is communicatively coupled. Consequently, another hardware-implemented module may, at some time later, access the memory device to retrieve and process the stored information. Hardware-implemented modules may also initiate communications with input or output devices, and can operate on information from the input or output devices.

In an embodiment, the present techniques can be at least partially implemented in a cloud or virtual machine environment.

### Machine Learning

Machine learning is a field of study within artificial intelligence that allows computers to learn functional relationships between inputs and outputs without being explicitly programmed. Machine learning involves a module comprising algorithms that may learn from existing data by analyzing, categorizing, or identifying the data. Such machine-learning algorithms operate by first constructing a model from training data to make predictions or decisions expressed as outputs. In an embodiment, the training data includes data for one or more identified features and one or more outcomes, for example see those described herein. Although example embodiments are presented with respect to a few machine-learning algorithms, the principles presented herein may be applied to other machine-learning algorithms.

Data supplied to a machine learning algorithm can be considered a feature, which can be described as an individual measurable property of a phenomenon being observed. The concept of feature is related to that of an independent variable used in statistical techniques such as those used in linear regression. The performance of a machine learning algorithm in pattern recognition, classification and regression is highly dependent on choosing informative, discriminating, and independent features. Features may comprise numerical data, categorical data, time-series data, strings, graphs, or images. Features of the invention may further include those described herein.

In general, there are two categories of machine learning problems: classification problems and regression problems. Classification problems, also referred to as categorization problems, aim at classifying items into discrete category values. Training data teaches the classifying algorithm how to classify. In an embodiment, features to be categorized may include input data, which can be provided to the classifying machine learning algorithm and then placed into categories of, for example, output data. Regression algorithms aim at quantifying and correlating one or more features. Training data teaches the regression algorithm how to correlate the one or more features into a quantifiable value. In an embodiment, features can be provided to the regression machine learning algorithm resulting in one or more continuous values.

### Root Mean Square Normalization

In an embodiment, the input data is first processed by one or more root mean square (RMS) normalizations modules. A RMS normalization module may regularize the summed inputs into an output in one layer. RMS normalization may include re-scaling invariance, which keeps the output representations intact when both inputs and weights are randomly scaled, and learning rate adaptation ability. RMS normalization regularizes the summed inputs according to the RMS statistic:

$${\overline{a}}_{i} = \frac{{a}_{i}}{RMS ( a )} {g}_{i} , where \qquad ( {i}^{″} )$$

$$RMS ( a ) = \sqrt{\frac{1}{n} {\sum }_{i = 1}^{n} {a}_{i}^{2}} .$$

RMS measures the quadratic mean of inputs. In RMS normalization, the summed inputs are computed into a √n-scaled unit sphere. Regardless of the scaling of input and weight distributions, the output distribution remains. This offers stability of layer activations. See e.g., Zhang, Biao, and Rico Sennrich. “Root mean square layer normalization.” Advances in Neural Information Processing Systems 32 (2019). In an embodiment, the projected gate convolution module comprises of one or more root mean square (RMS) normalizations modules. In an embodiment, the second output data is processed by one or more root mean square (RMS) normalizations modules.

### Embedding

In one example, the machine learning module may use embedding to provide a lower dimensional representation, such as a vector, of features to organize them based off respective similarities. In some situations, these vectors can become massive. In the case of massive vectors, particular values may become very sparse among a large number of values (e.g., a single instance of a value among 50,000 values). Because such vectors are difficult to work with, reducing the size of the vectors, in some instances, is necessary. A machine learning module can learn the embeddings along with the model parameters. In an embodiment, embedded semantic meanings are utilized. Embedded semantic meanings are values of respective similarity. For example, the distance between two vectors, in vector space, may imply two values located elsewhere with the same distance are categorically similar. Embedded semantic meanings can be used with similarity analysis to rapidly return similar values. In an embodiment, input data is embedded. In an embodiment, the projected gate convolution module includes embedding. In an embodiment, the methods herein are developed to identify meaningful portions of the vector and extract semantic meanings between that space.

### Natural Language Processing

In an embodiment, input data is processed with a natural language processing (NPL) model. NPL is a computational approach to evaluating text. General applications of NPL may comprise information retrieval, information extraction, question-answering, summarization, machine translation, dialogue systems. Information extraction comprises of recognition, tagging, and extraction into a structured representation. For example, key elements of information, such as persons, companies, locations, and/or organizations, are extracted from collections of text. The key elements of information may include physical properties (e.g., quantifiable/measurable) recited in the text and/or subjective properties (e.g., feelings). Question-answering (QA) comprises of generating a list of documents corresponding to a user's query. For example, QA may comprise generating either just the text of the answer or answer-providing passages. Summarization comprises of reducing a large amount of text into a smaller amount of text. For example, summarization may comprise of an abbreviated narrative representation of the original document. Machine translation (MT) comprises of either rule-based or probabilistic methods (e.g., machine learning) for translating text to speech or vice versa, or from one language to another. For example, MT attempts to capture contextual, idiomatic and pragmatic nuances of language. Dialogue systems comprise of conversational communications through communication modes such as text, speech, and images.

NPL may comprise of different levels of language. For example, ascending levels of language may comprise of phonology, morphology, lexical, syntactic, semantic, discourse, and pragmatic. The phonology level comprises of the interpretation of speech sounds. For example, phonological analysis may comprise of phonetic rules, phonemic rules, and prosodic rules. Morphology comprises of the nature of words, which comprise of morphemes (i.e., smallest units of meaning). For example, the suffix-ed to a verb indicates the action of the verb took place in the past. The lexical level comprises of interpreting the meaning of individual words. For example, words may be assigned part-of-speech tags based on context. The syntactic level comprises of analyzing the words in a sentence to extract the grammatical structure of the sentence. For example, syntactic processes attempt to compute the meaning of a sentence from the order and dependency of the words in a sentence. The semantic level comprises of determining the meaning of a sentence by analyzing the interactions between word-level meanings in a sentence. For example, a semantic process may comprise disambiguation wherein words with multiple meanings are reduced into a singular meaning based on the context of the sentence. The discourse level comprises of determining the meaning of more than one sentence. For example, discourse processing may comprise of anaphora resolution and discourse/text structure recognition. The pragmatic level comprises of determining the use of language based on the context of the text, not necessarily the content of the text. For example, pragmatic processes deduce extra meanings read into text that are not necessarily encoded into the text.

NPL may also comprise different approaches to language processing. For example, the approaches may comprise of symbolic, statistical, connectionist, and hybrid. Symbolic approaches comprise of using explicit representations of facts through well-understood knowledge representation schemes to analyze linguistic phenomena. For example, symbolic approaches may comprise of logic or rule-based systems. Statical approaches comprise of using text corpa to determine generalized models of linguistic phenomena. For example, a statical approach may use a HMM to determine speech recognition, lexical acquisition, parsing, part-of-speech tagging, collocations, statistical machine translation, statistical grammar learning, etc. Connectionist approach comprises of combining statistical learning with various theories of representation. For example, a connectionist approach may comprise of a network of interconnected local processing units with knowledge stored as weights in the connections between units wherein local interactions may result in an observed global behavior. See e.g., Liddy, E. D. 2001. Natural Language Processing. In Encyclopedia of Library and Information Science, 2nd Ed. NY. Marcel Decker, Inc.

NLP tasks may comprise: sentence boundary detection (e.g., abbreviations and titles—‘m.g.,’ ‘Dr.’); tokenization (e.g., hyphens, forward slashes—‘10 mg/day,’ ‘N-acetylcysteine’); part-of-speech assignment to individual words (e.g., homographs and gerunds); morphological decomposition (e.g., lemmatization); shallow parsing (chunking) (e.g., identifying phrases); problem-specific segmentation (e.g., segmenting text into meaningful groups); spelling/grammatical error identification and recovery (e.g., recovering false positives); named entity recognition (e.g., identifying persons, locations, diseases, genes, or medication); word sense disambiguation (e.g., determining a homograph's correct meaning); negation and uncertainty identification (e.g., inferring whether a named entity is present or absent); relationship extraction (e.g., determining relationships between entities or events); temporal inferences/relationship extraction (e.g., inferring that something has occurred in the past or may occur in the future); and information extraction (e.g., extracting a patient's current diagnoses involves NER, WSD, negation detection, temporal inference, and anaphoric resolution).

### Latent Dirichlet Allocation (LDA)

In an embodiment, input data is processed with Latent Dirichlet Allocation (LDA). LDA is a topic model for classifying text, wherein a document or more generally a set of text represents a random mixture over latent topics and each topic is characterized by a distribution of words. LDA is capable of identifying similar groups of text and associating them with certain topics. Generally, topics are identified by searching for groups of text in a document and taking a probability distribution that a group of text belongs to a topic and is likely to be found in the document.

In an embodiment, LDA is used on input data to identify output data. First, a number of topics are selected to be determined from the plurality of input data. The topics may comprise any topic related to output data described herein. The LDA model then needs to be trained to learn the selected topics. First, a set of training text is used as input for the LDA model. The text is randomly distributed among the selected topics. In an iterative process, the LDA model determines the proportion of text in a set that are currently assigned to a selected topic, then determines the proportion of assignments to the selected topic over all the sets and reassigns the word to a different topic based off a computed probability. This process is complete once a steady state of acceptable assignments is determined. The LDA model can then be used to determine topics from user data, which can then be passed to the machine learning network. See e.g., Blei, David M., Andrew Y. Ng, and Michael I. Jordan. “Latent dirichlet allocation.” Journal of machine Learning research 3. January (2003): 993-1022 incorporated herein by reference.

### Algorithms

Different machine-learning algorithms have been contemplated to carry out the embodiments discussed herein. For example, linear regression (LiR), logistic regression (LoR), Bayesian networks (for example, naive-bayes), random forest (RF) (including decision trees), neural networks (NN) (also known as artificial neural networks), matrix factorization, a hidden Markov model (HMM), support vector machines (SVM), K-means clustering (KMC), K-nearest neighbor (KNN), a suitable statistical machine learning algorithm, and/or a heuristic machine learning system for classifying or evaluating input data.

### Linear Regression (LiR)

In one example embodiment, linear regression machine learning is implemented. LiR is typically used in machine learning to predict a result through the mathematical relationship between an independent and dependent variable, such as input data and output data, respectively. A simple linear regression model would have one independent variable (x) and one dependent variable (y). A representation of an example mathematical relationship of a simple linear regression model would be y=mx+b. In this example, the machine learning algorithm tries variations of the tuning variables m and b to optimize a line that includes all the given training data.

The tuning variables can be optimized, for example, with a cost function. A cost function takes advantage of the minimization problem to identify the optimal tuning variables. The minimization problem preposes the optimal tuning variable will minimize the error between the predicted outcome and the actual outcome. An example cost function may comprise summing all the square differences between the predicted and actual output values and dividing them by the total number of input values and results in the average square error.

To select new tuning variables to reduce the cost function, the machine learning module may use, for example, gradient descent methods. An example gradient descent method comprises evaluating the partial derivative of the cost function with respect to the tuning variables. The sign and magnitude of the partial derivatives indicate whether the choice of a new tuning variable value will reduce the cost function, thereby optimizing the linear regression algorithm. A new tuning variable value is selected depending on a set threshold. Depending on the machine learning module, a steep or gradual negative slope is selected. Both the cost function and gradient descent can be used with other algorithms and modules mentioned throughout. For the sake of brevity, both the cost function and gradient descent are well known in the art and are applicable to other machine learning algorithms and may not be mentioned with the same detail.

LiR models may have many levels of complexity comprising one or more independent variables. Furthermore, in an LiR function with more than one independent variable, each independent variable may have the same one or more tuning variables or each, separately, may have their own one or more tuning variables. The number of independent variables and tuning variables will be understood to one skilled in the art for the problem being solved. In an embodiment, input data are used as the independent variables to train a LiR machine learning module, which, after training, is used to estimate, for example, output data.

### Logistic Regression (LoR)

In one example embodiment, logistic regression machine learning is implemented. Logistic Regression, often considered a LiR type model, is typically used in machine learning to classify information, such as input data into categories such as output data. LoR takes advantage of probability to predict an outcome from input data. However, what makes LoR different from a LiR is that LoR uses a more complex logistic function, for example a sigmoid function. In addition, the cost function can be a sigmoid function limited to a result between 0 and 1. For example, the sigmoid function can be of the form ƒ(x)=1/(1+e^{-x}), where x represents some linear representation of input features and tuning variables. Similar to LiR, the tuning variable(s) of the cost function are optimized (typically by taking the log of some variation of the cost function) such that the result of the cost function, given variable representations of the input features, is a number between 0 and 1, preferably falling on either side of 0.5. As described in LiR, gradient descent may also be used in LoR cost function optimization and is an example of the process. In an embodiment, input data are used as the independent variables to train a LoR machine learning module, which, after training, is used to estimate, for example, output data.

### Projected Gate Convolution

The project gate convolution (PGC) blocks are designed to capture contextualized local dependencies in the input sequence. In an embodiment, the PGC is the first stage of the method, system, and/or product describe herein. The PG is designed to process biological sequences and extract both local and global features. In an embodiment, each layer begins by linearly projecting the input sequence. In an embodiment, linear projection includes reducing or expanding the features of the input dimensionality to an intermediate size. In an embodiment, the PGC includes one or more hidden dimensions are independently selected from 2, 4, 8, 16, 32, 64, 128, 256, or 512 dimensions. In an embodiment, the projection is followed by Root Mean Square Layer Normalization (RMSNorm).

A RMSNorm enhances the representation by emphasizing global context. In an embodiment, the input (e.g., transformed sequence) is processed through two parallel pathways: pathway one (1) applies a depth-wise 1D convolution to extract local dependencies, while the other (i.e., pathway two (2) uses a linear projection to model global relationships. In an embodiment, the two outputs from the two pathways are combined using element-wise multiplication. The combination of the outputs from the two pathways may produce the integration of local and global data. In an embodiment, the combined features are projected back to the original input feature dimensionality and normalized again with RMSNorm. The PGC may capture complex patterns and dependencies in the input data.

In an embodiment, the input data is processed with a projected gate convolution module. In an embodiment, a first input is generated by the projected gate convolution module. By way of an example, given an input u∈R^{N×d}, operator for layer l is defined as:

$$𝒴 := {\underbrace{( u \cdot {W}^{ℓ} + {b}_{1}^{ℓ} )}}_{Linear Projeciion} ⊙ {\underbrace{( {h}^{ℓ} * u + {b}_{2}^{ℓ} )}}_{Convolution} \qquad ( {i}^{′} )$$

where the layer is parameterized by learnable filters module h∈R^{N×d}, a linear projection module W¹∈R^{d×d}, and ‘bias’ matrix data structures b₁, b₂∈R^{N×d}. The ⊙ is component-wise product and convolution of two matrix data structures computed as a convolution of the corresponding columns of the data structures. For example, each layer l uses Õ(Nd+d²) parameters and can be computed in Õ(Nd²) operations. The weight matrix W¹ may include a class of matrix data structures that support near-linear time matrix multiplication (e.g., Kaleidoscope matrices). In this example, the module uses Õ(Nd) parameters and Õ(Nd) FLOPs.

An (N, L, d, N′, d′)-projected gate convolution module may be a stacked sequence to sequence model with L layers such that: input and output are N×d matrices; a layer's operations may include element-wise gating, convolution, linear projection, or a combination thereof; and individual gated convolution layers accept, for example, N′×d′ matrices and output N′×d′ matrices. In an embodiment, the input u∈R^{N×d} is embedded into u′∈R^{N′×d′} such that

$${u}^{′} [ n , t ] = \{ \begin{matrix}u [ n , t ] & if n < N , t < d \\ 0 & otherwise\end{matrix} \qquad ( {ii}^{′} )$$

In an embodiment, the output from the last layer z∈R^{N′×d′} is transformed into output y∈R^{N×d} by extracting the top left N×d entries in z. In an embodiment, the weight matrix data structures may include W∈R^{m×m} See e.g., Arora, Simran, et al. “Zoology: Measuring and improving recall in efficient language models.” arXiv preprint arXiv:2312.04927(2023).

### Linear Projections

The linear projection module may include a matrix data structure as the weight matrix W∈R^{m×m} taken to be a K-matrix data structure. Each matrix data structure W may include Õ(m) parameters and runtime for matrix vector multiplication. The general linear transformations may be represented with low-depth linear arithmetic circuits. Linear projection module may further include linear maps for m<n, where each map takes the corresponding square matrices from the output of a linear projection module and note that such matrices have Õ(n) parameters and runtime for matrix vector multiplication. In an embodiment, the weight matrix W∈R^{d×d} above is taken to be a dense matrix data structure. See e.g., Arora, Simran, et al. “Zoology: Measuring and improving recall in efficient language models.” arXiv preprint arXiv:2312.04927(2023).

### Distributions

In an embodiment, the one or more weight matrix modules, the one or more bias vector modules, or a combination thereof independently comprise of a probability distribution or random assignment of matrix or vector components. In an embodiment, the probability distribution is a gaussian distribution.

### Fast Fourier Transform (FFT)

In an embodiment, the methods, systems, and devices herein include Fast Fourier Transform (FFT). In computer technology, FFT includes the Discrete Fourier Transform (DFT) of input data into a frequency representations of the input data. This increases a computers computation speed by factorizing a DFT matrix data structure. This reduces computation complexity from O(N²) to O(N log N). The FFT may be implemented in form, some examples of which include Cooley-Tukey FFT, Prime-factor FFT, Bruun's FFT, Rader's FFT, Chirp Z-transform, and hexagonal FFT. In an embodiment, the projected gate convolution module comprises of FFT.

### State Space

A diagonal state space model (SSM) may parameterize and compute convolution kernels for modeling. The kernel, which captures dependencies across the input data, is parameterized through at least three data structures including matrices, e.g., A, B, and C. Matrix A data structure governs the dynamics of the system, encoding exponential decay and oscillatory behavior. Matrix B data structure maps the input into the state space. Matrix C data structure projects the state back into the output space.

In an embodiment, a convolution kernel is computed using a Vandermonde matrix data structure. A Vandermonde matrix data structure may organize, for example, the contributions of matrix A, B, and C into a data structure that allows for efficient evaluation of the kernel as a sum of weighted exponential terms. In an embodiment, the state matrix A data structure is initialized as Legendre polynomials. The Legendre polynomials may provide an orthogonal basis for approximating polynomials up to the degree of the state size. In an embodiment, the SSM decomposes input signals into basis functions. Basis functions may capture both local and long-range dependencies. The SSM may parameterize a long convolution to model long-range dependencies.

State space models (SSM) are parameterized maps on signals u(t)→y(t). SSMs are linear time-invariant systems that can be represented either as a linear ODE (equation (i)) or convolution (equation (ii)).

$${x}^{′} ( t ) = Ax ( t ) + Bu ( t ) \qquad ( i )$$

$$y ( t ) = Cx ( t )$$

$$K ( t ) = {Ce}^{tA} B \qquad ( ii )$$

$$y ( t ) = ( K * u ) ( t )$$

A is a state matrix data structure A∈C^{N×N} and B and C are cross matrix data structures B∈C^{N×1} and C∈C^{1×N}. Aₙ, Bₙ, Cₙ data structures denotes the input of the parameters. In an embodiment, a learning parameter module includes the A, B, and C data structures. The convolution kernel (ii) may be implemented as a linear combination (controlled by C) of basis kernels Kₙ(t) (controlled by A, B)

$$K ( t ) = {\sum }_{n = 0}^{N - 1} {C}_{n} {K}_{n} ( t ) \qquad ( iii )$$

$${K}_{n} ( t ) := {e}_{n}^{⊤} {e}^{tA} B$$

The basis may be implemented as K(t)=K_{A,B}(t)=e^{tA}B; note that it is a vector data structure of N functions. In the case of diagonal SSMs, each function Kₙ(t) is just e^{tAn}Bₙ.

In an embodiment, the convolutional form (ii) can be transformed into a temporal recurrence that is faster for autoregressive applications. A real-valued matrix A data structure (iv) were constructed so that the basis kernels Kₙ(t) data structures have closed-forms Lₙ(e^{-t}), where Lₙ(t) are normalized Legendre polynomials, giving it long-range modeling abilities. In an embodiment, the A matrix data structure is decomposed using a particular parameterization into the sum of a normal and rank-1 matrix (v) data structure, which may be unitarily conjugated into a (complex) diagonal plus rank-1 matrix data structure. The convolution kernel (ii) data structure may be computed for state matrices data structures that are diagonal plus low-rank (DPLR).

$${A}_{nk} = - \{ \begin{matrix}{( 2 n + 1 )}^{\frac{1}{2}} {( 2 k + 1 )}^{\frac{1}{2}} & n > k \\ n + 1 & n = k \\ 0 & n < k\end{matrix} \qquad ( iv )$$

$${B}_{n} = {( 2 n + 1 )}^{\frac{1}{2}} {P}_{n} = {( n + 1 / 2 )}^{\frac{1}{2}}$$

$${A}_{nk}^{( N )} = - \{ \begin{matrix}{( n + \frac{1}{2} )}^{1 / 2} {( k + \frac{1}{2} )}^{1 / 2} & n > k \\ \frac{1}{2} & n = k \\ {( n + \frac{1}{2} )}^{1 / 2} {( k + \frac{1}{2} )}^{1 / 2} & n < k\end{matrix} \qquad ( v )$$

$$A = {A}^{( N )} - {PP}^{⊤} , {A}^{( D )} := eig ( {A}^{( N )} )$$

Diagonal State Spaces (DSS) were motivated by searching for a diagonal state matrix data structure, which is even more structured than the SSM. However, the matrix data structure (iv) cannot be stably transformed into diagonal form and resulted in the (v) formulation. Removing the low-rank portion of (v) resulted in a diagonal matrix data structure. The initialization is the diagonal matrix A^{(D)} data structure, or the diagonalization of A^{(N)} in (v). See e.g., Gu, Albert, et al. “On the parameterization and initialization of diagonal state space models.” Advances in Neural Information Processing Systems 35 (2022): 35971-35983.

In an embodiment, the SSM includes one or more hidden dimensions are independently selected from 2, 4, 8, 16, 32, 64, 128, 256, or 512 dimensions

### Parameters

In an embodiment, the state space module includes one or more parameters. In an embodiment, the learning parameter module includes one or more parameters. In an embodiment, the state space module comprises of no less than 3,000 parameters or no more than one million parameters. In an embodiment, the state space module comprises of no more than 5,000 parameters, no more than 10,000 parameters, no more than 50,000 parameters, no more than 100,000 parameters, no more than 250,000 parameters, no more than 500,000 parameters, no more than 750,000 parameters, no more than one million parameters.

### Neural Networks

In one example embodiment, Neural Networks (NNs) are implemented. NNs are a family of statistical learning models influenced by biological neural networks of the brain. NNs can be trained on a relatively large dataset (e.g., 50,000 or more) and used to estimate, approximate, or predict an output that depends on a large number of inputs/features. NNs can be envisioned as so-called “neuromorphic” systems of interconnected processor elements, or “neurons”, and exchange electronic signals, or “messages”. Similar to the so-called “plasticity” of synaptic neurotransmitter connections that carry messages between biological neurons, the connections in NNs that carry electronic “messages” between “neurons” are provided with numeric weights that correspond to the strength or weakness of a given connection. The weights can be tuned based on experience, making NNs adaptive to inputs and capable of learning. For example, an NN for output data is defined by a set of input neurons that can be given input data such as input data. The input neuron weighs and transforms the input data and passes the result to other neurons, often referred to as “hidden” neurons. This is repeated until an output neuron is activated. The activated output neuron produces a result. In an embodiment, input data are used to train the neurons in a NN machine learning module, which, after training, is used to estimate output data.

In an embodiment, a NN layer (e.g., input, hidden, and output) has 1 or more neurons. In an embodiment, the NN layer has 1-500 neurons. In an embodiment, the NN layer has about 1 neuron, 5 neurons, 10 neurons, 15 neurons, 20 neurons, 25 neurons, 30 neurons, 35 neurons, 40 neurons, 45 neurons, 50 neurons, 55 neurons, 60 neurons, 65 neurons, 70 neurons, 75 neurons, 80 neurons, 85 neurons, 90 neurons, 95 neurons, 100 neurons, 105 neurons, 110 neurons, 115 neurons, 120 neurons, 125 neurons, 130 neurons, 135 neurons, 140 neurons, 145 neurons, 150 neurons, 155 neurons, 160 neurons, 165 neurons, 170 neurons, 175 neurons, 180 neurons, 185 neurons, 190 neurons, 195 neurons, 200 neurons, 205 neurons, 210 neurons, 215 neurons, 220 neurons, 225 neurons, 230 neurons, 235 neurons, 240 neurons, 245 neurons, 250 neurons, 255 neurons, 260 neurons, 265 neurons, 270 neurons, 275 neurons, 280 neurons, 285 neurons, 290 neurons, 295 neurons, 300 neurons, 305 neurons, 310 neurons, 315 neurons, 320 neurons, 325 neurons, 330 neurons, 335 neurons, 340 neurons, 345 neurons, 350 neurons, 355 neurons, 360 neurons, 365 neurons, 370 neurons, 375 neurons, 380 neurons, 385 neurons, 390 neurons, 395 neurons, 400 neurons, 405 neurons, 410 neurons, 415 neurons, 420 neurons, 425 neurons, 430 neurons, 435 neurons, 440 neurons, 445 neurons, 450 neurons, 455 neurons, 460 neurons, 465 neurons, 470 neurons, 475 neurons, 480 neurons, 485 neurons, 490 neurons, 495 neurons, 500 neurons, or any range between any two number of neurons listed.

### Convolutional Neural Network (CNN)

In an example embodiment, a convolutional neural network is implemented. CNNs is a class of NNs further attempting to replicate the biological neural networks, but of the animal visual cortex. CNNs process data with a grid pattern to learn spatial hierarchies of features. Wherein NNs are highly connected, sometimes fully connected, CNNs are connected such that neurons corresponding to neighboring data (e.g., pixels) are connected. This significantly reduces the number of weights and calculations each neuron must perform.

In general, input data comprises of a multidimensional vector. A CNN, typically, comprises of three layers: convolution, pooling, and fully connected. The convolution and pooling layers extract features and the fully connected layer combines the extracted features into an output, such as output data.

In particular, the convolutional layer comprises of multiple mathematical operations such as of linear operations, a specialized type being a convolution. The convolutional layer calculates the scalar product between the weights and the region connected to the input volume of the neurons. These computations are performed on kernels, which are reduced dimensions of the input vector. The kernels span the entirety of the input. The rectified linear unit (i.e., ReLu) applies an elementwise activation function (e.g., sigmoid function) on the kernels.

CNNs can optimized with hyperparameters. In general, there three hyperparameters are used: depth, stride, and zero-padding. Depth controls the number of neurons within a layer. Reducing the depth may increase the speed of the CNN but may also reduce the accuracy of the CNN. Stride determines the overlap of the neurons. Zero-padding controls the border padding in the input.

The pooling layer down-samples along the spatial dimensionality of the given input (i.e., convolutional layer output), reducing the number of parameters within that activation. As an example, kernels are reduced to dimensionalities of 2×2 with a stride of 2, which scales the activation map down to 25%. The fully connected layer uses inter-layer-connected neurons (i.e., neurons are only connected to neurons in other layers) to score the activations for classification and/or regression. Extracted features may become hierarchically more complex as one layer feeds its output into the next layer. See O'Shea, K.; Nash, R. An Introduction to Convolutional Neural Networks. arXiv 2015 and Yamashita, R., et al Convolutional neural networks: an overview and application in radiology. Insights Imaging 9, 611-629 (2018).

### Matrix Factorization

In an embodiment, Matrix Factorization is implemented. Matrix Factorization machine learning exploits inherent relationships between two entities drawn out when multiplied together. Generally, the input features are mapped to a matrix F which is multiplied with a matrix R containing the relationship between the features and a predicted outcome. The resulting dot product provides the prediction. The matrix R is constructed by assigning random values throughout the matrix. In this example, two training matrices are assembled. The first matrix X contains training input features and the second matrix Z contains the known output of the training input features. First the dot product of R and X are computed and the square mean error, as one example method, of the result is estimated. The values in R are modulated and the process is repeated in a gradient descent style approach until the error is appropriately minimized. The trained matrix R is then used in the machine learning model. In an embodiment, input data are used to train the relationship matrix R in a matrix factorization machine learning module. After training, the relationship matrix R and input matrix F, which comprises vector representations of input data, results in the prediction matrix P comprising output data.

### Example Architecture

In an embodiment, the method, system and/or product described herein includes at least two core components: a Projected Gated Convolution (PGC) block, followed by a state-space layer with an optional depth-wise convolution (S4D). In an embodiment, the method, system and/or product described herein includes two or more PGC blocks. In an embodiment, the method, system and/or product described herein includes of approximately 55,000 parameters. In an embodiment, a first PGC block operates with a hidden dimension. In an embodiment, the hidden dimension is approximately 16. In an embodiment, a second PBC block uses a hidden dimension of approximately 128. In an embodiment, the S4D layer has a hidden dimension of approximately 64; includes a residual connection; sequence pre-normalization using Root Mean Square Layer Normalization (RMSNorm); or a combination thereof.

### Training Methods

In an embodiment, the machine learning module can be trained using techniques such as unsupervised, supervised, semi-supervised, reinforcement learning, transfer learning, incremental learning, curriculum learning techniques, and/or learning to learn. Training typically occurs after selection and development of a machine learning module and before the machine learning module is operably in use. In one aspect, the training data used to teach the machine learning module can comprise input data and the respective target output data.

In an embodiment, the training data comprises of biological data, chemical data, or a combination thereof. Biological data may include hierarchical data. Biological hierarchical data includes biological data at various scales such as molecular, cellular, tissue/organs, and/or systems. Chemical data may include a typically includes atomic data, chemical name, structure, molecular formula, and physical properties. Physical properties of chemical data may include transition point (e.g., melting point, boiling point, freezing point), density, electrostatics, pH, physical state (e.g., solid, liquid, gas), solubility, and/or vapor pressure.

In an embodiment, the biological data, chemical data, or a combination thereof comprises of genomic data, proteomic data, epidemiological data, pharmacological data, epistatic data, or a combination thereof. Genomic data may include one or more nucleic acid sequences, position of a gene, function of a gene, variation of nucleotide and/or gene, regulatory elements, and/or interactions between different genes and proteins. Proteomic data may include expression data (e.g., quantitative and/or qualitative protein expression, disease data associated with a protein, signal transduction), structural data (e.g., three-dimensional structure, crystal structure), and/or functional data (e.g., function of a protein, molecular mechanism(s), protein partner(s) and their interactions, signaling pathways). Epidemiological data may include disease data, demographic data, and/or geographic data. Pharmacological data may include drug(s), ligand(s), drug class(es), and/or their targets. Epistatic data may include a phenotypical effect between two or more nucleic acid and/or amino acid sequences (e.g., the presence of a gene affecting another gene, presence of one or more amino acid affecting protein function).

In an embodiment, biological data, chemical data, or a combination thereof includes: disorder annotations (e.g., disorder functions such as protein-binding, DNA-binding, RNA-binding, ion-binding, lipid-binding, and flexible linker regions); mutational landscapes (e.g., enzyme activity, RNA-binding, and fluorescent protein function); RNA-dependent RNA polymerase (RDRP) classification; protein fitness (e.g., stability and affinity, enrichment, or fluorescence values); cell-penetrating peptide (CPP) efficacy; RNA tasks such as secondary structure, structural score, splice site classification (e.g., nucleotide acceptor, donor, or neither), APA isoforms (e.g., usage ratio of the proximal polyadenylation site (PAS) in 3′ untranslated region (3′ UTR)), noncoding RNA (e.g., microRNAs (miRNAs), long noncoding RNAs (lncRNAs), and small interfering RNAs (siRNAs)), RNA modification, mean ribosome loading (e.g., an MRL value representing the level of mRNA translation activity into proteins), programmable RNA switch, CRISPR Off-Target Rate (an off-target frequency score quantifying CRISPR-induced mutations at unintended genomic locations); CRISPR Cas13a (e.g., guide-target pairs); CRISPR Cas9 (e.g., guide-target activity information); promoter task (e.g., synthetic modifications of the Ptre promoter, for example, via engineered and characterized through iterative mutation-construction-screening cycles); or any combination thereof.

### Pre-Trained Learning

In an embodiment, the machine learning module is not pre-trained. A pre-trained machine learning model is a model that has been previously trained to solve a similar problem. The pre-trained machine learning model is generally pre-trained with similar input data to that of the new problem. A pre-trained machine learning model further trained to solve a new problem is generally referred to as transfer learning, which is described herein. In some instances, a pre-trained machine learning model is trained on a large dataset of related information. The pre-trained model is then further trained and tuned for the new problem. Using a pre-trained machine learning module provides the advantage of building a new machine learning module with input neurons/nodes that are already familiar with the input data and are more readily refined to a particular problem. For example, a machine learning module previously trained using similar or the same input data may be further trained to estimate the same or similar output. See e.g., Diamant N, et al. Patient contrastive learning: A performant, expressive, and practical approach to electrocardiogram modeling. PLoS Comput Biol. 2022 Feb. 14; 18(2):e1009862.

In some examples, after the training phase has been completed but before producing predictions expressed as outputs, a trained machine learning module can be provided to a computing device where a trained machine learning module is not already resident, in other words, after training phase has been completed, the trained machine learning module can be downloaded to a computing device. For example, a first computing device storing a trained machine learning module can provide the trained machine learning module to a second computing device. Providing a trained machine learning module to the second computing device may comprise one or more of communicating a copy of trained machine learning module to the second computing device, making a copy of trained machine learning module for the second computing device, providing access to trained machine learning module to the second computing device, and/or otherwise providing the trained machine learning system to the second computing device. In an embodiment, a trained machine learning module can be used by the second computing device immediately after being provided by the first computing device. In some examples, after a trained machine learning module is provided to the second computing device, the trained machine learning module can be installed and/or otherwise prepared for use before the trained machine learning module can be used by the second computing device.

After a machine learning model has been trained it can be used to output, estimate, infer, predict, generate, produce, or determine, for simplicity these terms will collectively be referred to as results. A trained machine learning module can receive input data and operably generate results. As such, the input data can be used as an input to the trained machine learning module for providing corresponding results to kernel components and non-kernel components. For example, a trained machine learning module can generate results in response to requests. In an embodiment, a trained machine learning module can be executed by a portion of other software. For example, a trained machine learning module can be executed by a result daemon to be readily available to provide results upon request.

In an embodiment, a machine learning module and/or trained machine learning module can be executed and/or accelerated using one or more computer processors and/or on-device co-processors. Such on-device co-processors can speed up training of a machine learning module and/or generation of results. In some examples, trained machine learning module can be trained, reside, and execute to provide results on a particular computing device, and/or otherwise can make results for the particular computing device.

Input data can include data from a computing device executing a trained machine learning module and/or input data from one or more computing devices. In an embodiment, a trained machine learning module can use results as input feedback. A trained machine learning module can also rely on past results as inputs for generating new results. Unsupervised and Supervised Learning

In an example embodiment, unsupervised learning is implemented. Unsupervised learning can involve providing all or a portion of unlabeled training data to a machine learning module. The machine learning module can then determine one or more outputs implicitly based on the provided unlabeled training data. In an example embodiment, supervised learning is implemented. Supervised learning can involve providing all or a portion of labeled training data to a machine learning module, with the machine learning module determining one or more outputs based on the provided labeled training data, and the outputs are either accepted or corrected depending on the agreement to the actual outcome of the training data. In some examples, supervised learning of machine learning system(s) can be governed by a set of rules and/or a set of labels for the training input, and the set of rules and/or set of labels may be used to correct inferences of a machine learning module.

### Semi-Supervised and Reinforcement Learning

In one example embodiment, semi-supervised learning is implemented. Semi-supervised learning can involve providing all or a portion of training data that is partially labeled to a machine learning module. During semi-supervised learning, supervised learning is used for a portion of labeled training data, and unsupervised learning is used for a portion of unlabeled training data. In an embodiment, reinforcement learning is implemented. Reinforcement learning can involve first providing all or a portion of the training data to a machine learning module and as the machine learning module produces an output, the machine learning module receives a “reward” signal in response to a correct output. Typically, the reward signal is a numerical value and the machine learning module is developed to maximize the numerical value of the reward signal. In addition, reinforcement learning can adopt a value function that provides a numerical value representing an expected total of the numerical values provided by the reward signal over time.

### Transfer Learning

In one example embodiment, transfer learning is implemented. Transfer learning techniques can involve providing all or a portion of a first training data to a machine learning module, then, after training on the first training data, providing all or a portion of a second training data. In an embodiment, a first machine learning module can be pre-trained on data from one or more computing devices. The first trained machine learning module is then provided to a computing device, where the computing device is intended to execute the first trained machine learning model to produce an output. Then, during the second training phase, the first trained machine learning model can be additionally trained using additional training data, where the training data can be derived from kernel and non-kernel data of one or more computing devices. This second training of the machine learning module and/or the first trained machine learning model using the training data can be performed using either supervised, unsupervised, or semi-supervised learning. In addition, it is understood transfer learning techniques can involve one, two, three, or more training attempts. Once the machine learning module has been trained on at least the training data, the training phase can be completed. The resulting trained machine learning model can be utilized as at least one of trained machine learning module.

### Incremental and Curriculum Learning

In one example embodiment, incremental learning is implemented. Incremental learning techniques can involve providing a trained machine learning module with input data that is used to continuously extend the knowledge of the trained machine learning module. Another machine learning training technique is curriculum learning, which can involve training the machine learning module with training data arranged in a particular order, such as providing relatively easy training examples first, then proceeding with progressively more difficult training examples. As the name suggests, difficulty of training data is analogous to a curriculum or course of study at a school.

### Learning to Learn

In one example embodiment, learning to learn is implemented. Learning to learn, or meta-learning, comprises, in general, two levels of learning: quick learning of a single task and slower learning across many tasks. For example, a machine learning module is first trained and comprises of a first set of parameters or weights. During or after operation of the first trained machine learning module, the parameters or weights are adjusted by the machine learning module. This process occurs iteratively on the success of the machine learning module. In another example, an optimizer, or another machine learning module, is used wherein the output of a first trained machine learning module is fed to the optimizer that constantly learns and returns the final results. Other techniques for training the machine learning module and/or trained machine learning module are possible as well.

### Contrastive Learning

In example embodiment, contrastive learning is implemented. Contrastive learning is a self-supervised model of learning in which training data is unlabeled and is considered as a form of learning in-between supervised and unsupervised learning. This method learns by contrastive loss, which separates unrelated (i.e., negative) data pairs and connects related (i.e., positive) data pairs. For example, to create positive and negative data pairs, more than one view of a datapoint, such as rotating an image or using a different time-point of a video, is used as input. Positive and negative pairs are learned by solving dictionary look-up problem. The two views are separated into query and key of a dictionary. A query has a positive match to a key and negative match to all other keys. The machine learning module then learns by connecting queries to their keys and separating queries from their non-keys. A loss function, such as those described herein, is used to minimize the distance between positive data pairs (e.g., a query to its key) while maximizing the distance between negative data points. See e.g., Tian, Yonglong, et al. “What makes for good views for contrastive learning?.” Advances in Neural Information Processing Systems 33 (2020): 6827-6839.

### Methods of Use

In an embodiment as described herein, a method of determining chromatin profiling including any method as described herein, wherein the input data is one or more nucleic acid sequences, and the second output data is one or more chromatin feature.

In an embodiment as described herein, a method of classifying gene regulating regions comprising the method as described herein, wherein the input data is one or more nucleic acid sequences, and the second output data is a determination of one or more gene regulating regions.

In an embodiment as described herein, a method of CRISPR-Cas diagnostics comprising the method as described herein, wherein the input data is one or more guide molecules, and the second output data is activity of the one or more guide molecules.

In an embodiment as described herein, a method of determining protein fitness comprising the method as described herein, wherein the input data is one or more amino acid sequence, and the second output data is stability, binding affinity, or a combination thereof of the one or more amino acid sequence.

In an embodiment as described herein, a method of modeling protein features comprising the method as described herein, wherein the input data is one or more amino acid sequence, and the second output data is remote homology, fluorescence, protein stability, or a combination thereof.

### Example Computing Device

FIG. 4 depicts a block diagram of a computing machine 2000 and a module 2050 in accordance with certain examples. The computing machine 2000 may comprise, but are not limited to, remote devices, work stations, servers, computers, general purpose computers, Internet/web appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and any machine capable of executing the instructions. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The one or more processor 2010 may be configured to execute code or instructions to perform the operations and functionality described herein, manage request flow and address mappings, and to perform calculations and generate commands. Such code or instructions could include, but is not limited to, firmware, resident software, microcode, and the like. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), tensor processing units (TPUs), a graphics processing unit (“GPU”), a field programmable gate array (“FPGA”), a programmable logic device (“PLD”), a radio-frequency integrated circuit (RFIC), a controller, a state machine, gated logic, discrete hardware components, any other processing unit, or any combination or multiplicity thereof. In an embodiment, each processor 2010 can include a reduced instruction set computer (RISC) microprocessor. The processor 2010 may be a single processing unit, multiple processing units, a single processing core, multiple processing cores, special purpose processing cores, co-processors, or any combination thereof. According to certain examples, the processor 2010 along with other components of the computing machine 2000 may be a virtualized computing machine executing within one or more other computing machines. Processors 2010 are coupled to system memory and various other components via a system bus 2020.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random-access memory (“RAM”), static random-access memory (“SRAM”), dynamic random-access memory (“DRAM”), and synchronous dynamic random-access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 is coupled to system bus 2020 and can include a basic input/output system (BIOS), which controls certain basic functions of the processor 2010 and/or operate in conjunction with, a non-volatile storage device such as the storage media 2040.

In an embodiment, the computing device 2000 includes a graphics processing unit (GPU) 2090. Graphics processing unit 2090 is a specialized electronic circuit designed to manipulate and alter memory to accelerate the creation of images in a frame buffer intended for output to a display. In general, a graphics processing unit 2090 is efficient at manipulating computer graphics and image processing and has a highly parallel structure that makes it more effective than general-purpose CPUs for algorithms where processing of large blocks of data is done in parallel.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any electromagnetic storage device, any semiconductor storage device, any physical-based storage device, any removable and non-removable media, any other data storage device, or any combination or multiplicity thereof. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The module 2050 may comprise one or more hardware or software elements, as well as an operating system, configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. Each of the operating system, one or more application programs, other program modules, and program data or some combination thereof, may include an implementation of a networking environment. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for coupling in operation the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including cursor control devices, touch-screens, scanners, electronic digitizers, sensors, receivers, touchpads, trackballs, cameras, microphones, alphanumeric input devices, any other pointing devices, or any combinations thereof. The I/O interface 2060 may couple the computing machine 2000 to various output devices including video displays (The computing device 2000 may further include a graphics display, for example, a plasma display panel (PDP), a light emitting diode (LED) display, a liquid crystal display (LCD), a projector, a cathode ray tube (CRT), or any other display capable of displaying graphics or video), audio generation device, printers, projectors, tactile feedback devices, automation control, robotic components, actuators, motors, fans, solenoids, valves, pumps, transmitters, signal emitters, lights, and so forth. The I/O interface 2060 may couple the computing device 2000 to various devices capable of input and out, such as a storage unit. The devices can be interconnected to the system bus 2020 via a user interface adapter, which can include, for example, a Super I/O chip integrating multiple device adapters into a single integrated circuit.

The computing machine 2000 may operate in a networked environment using logical connections through the network interface 2070 to one or more other systems or computing machines across the network 2080. The network 2080 may include a local area network (“LAN”), a wide area network (“WAN”), an intranet, an Internet, a mobile telephone network, storage area network (“SAN”), personal area network (“PAN”), a metropolitan area network (“MAN”), a wireless network (“WiFi;”), wireless access networks, a wireless local area network (“WLAN”), a virtual private network (“VPN”), a cellular or other mobile communication network, Bluetooth, near field communication (“NFC”), ultra-wideband, wired networks, telephone networks, optical networks, copper transmission cables, or combinations thereof or any other appropriate architecture or system that facilitates the communication of signals and data. The network 2080 may be packet switched, circuit switched, of any topology, and may use any communication protocol. The network 2080 may comprise routers, firewalls, switches, gateway computers and/or edge servers. Communication links within the network 2080 may involve various digital or analog communication media such as fiber optic cables, free-space optics, waveguides, electrical conductors, wireless links, antennas, radio-frequency communications, and so forth.

Information for facilitating reliable communications can be provided, for example, as packet/message sequencing information, encapsulation headers and/or footers, size/time information, and transmission verification information such as cyclic redundancy check (CRC) and/or parity check values. Communications can be made encoded/encrypted, or otherwise made secure, and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure and then decrypt/decode communications.

The processor 2010 may be connected to the other elements of the computing machine 2000 or the various peripherals discussed herein through the system bus 2020. The system bus 2020 represents one or more of any of several types of bus structures, including a memory bus or memory controller, a peripheral bus, an accelerated graphics port, and a processor or local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those ordinarily skilled in the art will appreciate that one or more aspects of examples described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

A “server” may comprise a physical data processing system (for example, the computing device 2000 as shown in FIG. 4) running a server program. A physical server may or may not include a display and keyboard. A physical server may be connected, for example by a network, to other computing devices. Servers connected via a network may operate in the capacity of a server machine or a client machine in a server-client network environment, or as a peer machine in a distributed (e.g., peer-to-peer) network environment. The computing device 2000 can include clients' servers. For example, a client and server can be remote from each other and interact through a network. The relationship of client and server arises by virtue of computer programs in communication with each other, running on the respective computers.

Any two or more devices, two or more software/programs, and any two or more portions of a device or software/program, for simplicity referred to as technology, may be described herein as operably linked. Operably linked may be defined as at least one technology can mediate a function exerted upon at least one other technology such that the two or more technologies function normally. In general, operably linked refers to the ability for at least one technology to communicate with at least one other technology.

### Floating-point Operations Per Second (FLOPS)

FLOPS are a measure of computational speed. The base level for computing is giga-FLOPS, which is 1 billion (10⁹) floating-point operations per second. This would be equivalent to a person with pen and paper or a calculator constantly performing one (1) calculation every one (1) second for approximately thirty-two years (˜32) years. As computing floating-point numbers is necessary in fields such as financial applications, scientific applications, visual rendering, and real-time processing, this unit of measurement may be used to describe the methods, systems, and products described herein. As such and further described herein, the methods, systems, and products are carried out on time scales larger than a couple seconds. Accordingly, these methods, systems, and products are required to be carried out computationally because no person in a life-time could carry out these methods.

To illustrate the vast disparity between human and computer capabilities, consider the simple task of sorting a list of one million numbers. A modern computer can complete this in approximately 100 milliseconds. In contrast, a human attempting this task manually, even under unrealistically optimal conditions, would require about 11.5 days of continuous work. Realistically, accounting for fatigue and necessary breaks, this task could take weeks or months for a human to complete. The method, systems, and products described herein is significantly more complex than this simple sorting example. They require an amount of time that is, for all practical purposes, near infinite for a human to complete manually. The computational complexity and scale of the task place it firmly in the realm of processes that can only be executed by purpose-built computing systems, not by the human mind.

### General Definitions

Unless defined otherwise, technical and scientific terms used herein have the same meaning as commonly understood by one of ordinary skill in the art to which this disclosure pertains. Definitions of common terms and techniques in molecular biology may be found in Molecular Cloning: A Laboratory Manual, 2^{nd} edition (1989) (Sambrook, Fritsch, and Maniatis); Molecular Cloning: A Laboratory Manual, 4^{th} edition (2012) (Green and Sambrook); Current Protocols in Molecular Biology (1987) (F. M. Ausubel et al. eds.); the series Methods in Enzymology (Academic Press, Inc.): PCR 2: A Practical Approach (1995) (M. J. MacPherson, B. D. Hames, and G. R. Taylor eds.): Antibodies, A Laboratory Manual (1988) (Harlow and Lane, eds.): Antibodies A Laboratory Manual, 2^{nd} edition 2013 (E. A. Greenfield ed.); Animal Cell Culture (1987) (R. I. Freshney, ed.); Benjamin Lewin, Genes IX, published by Jones and Bartlet, 2008 (ISBN 0763752223); Kendrew et al. (eds.), The Encyclopedia of Molecular Biology, published by Blackwell Science Ltd., 1994 (ISBN 0632021829); Robert A. Meyers (ed.), Molecular Biology and Biotechnology: a Comprehensive Desk Reference, published by VCH Publishers, Inc., 1995 (ISBN 9780471185710); Singleton et al., Dictionary of Microbiology and Molecular Biology 2nd ed., J. Wiley & Sons (New York, N.Y. 1994), March, Advanced Organic Chemistry Reactions, Mechanisms and Structure 4th ed., John Wiley & Sons (New York, N.Y. 1992); and Marten H. Hofker and Jan van Deursen, Transgenic Mouse Methods and Protocols, 2^{nd} edition (2011).

As used herein, the singular forms “a,” “an,” and “the” include both singular and plural referents unless the context dictates otherwise.

The term “optional” or “optionally” means that the subsequently described event, circumstance, or substituent may or may not occur. The description includes instances where the event or circumstance occurs and instances where it does not.

The recitation of numerical ranges by endpoints includes all numbers and fractions subsumed within the respective ranges and the recited endpoints.

The terms “about” or “approximately,” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is also specifically and preferably disclosed.

As used herein, a “biological sample” may contain whole cells and/or live cells and/or cell debris. The biological sample may contain (or be derived from) a “bodily fluid.” The present invention encompasses embodiments wherein the bodily fluid is selected from amniotic fluid, aqueous humour, vitreous humour, bile, blood serum, breast milk, cerebrospinal fluid, cerumen (earwax), chyle, chyme, endolymph, perilymph, exudates, feces, female ejaculate, gastric acid, gastric juice, lymph, mucus (including nasal drainage and phlegm), pericardial fluid, peritoneal fluid, pleural fluid, pus, rheum, saliva, sebum (skin oil), semen, sputum, synovial fluid, sweat, tears, urine, vaginal secretion, vomit and mixtures of one or more thereof. Biological samples include cell cultures, bodily fluids, and cell cultures from bodily fluids. Bodily fluids may be obtained from a mammal organism, for example, by puncture or other collecting or sampling procedures.

The terms “subject,” “individual,” and “patient” are used interchangeably herein to refer to a vertebrate, preferably a mammal, more preferably a human. Mammals include, but are not limited to, murines, simians, humans, farm animals, sport animals, and pets. Tissues, cells, and the progeny of a biological entity obtained in vivo or cultured in vitro are also encompassed.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment,” “an embodiment,” and “an example embodiment” means that a particular feature, structure, or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment but may. Furthermore, the particular features, structures, or characteristics may be combined in any suitable manner, as would be apparent to a person skilled in the art from this disclosure in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

All publications, published patent documents, and patent applications cited herein are hereby incorporated by reference to the same extent as though each publication, published patent document, or patent application was specifically and individually indicated as being incorporated by reference.

The example systems, methods, and acts described in the examples and described in the figures presented previously are illustrative, not intended to be exhaustive, and not meant to be limiting. In alternative examples, certain acts can be performed in a different order, in parallel with one another, omitted entirely, and/or combined between different examples, and/or certain additional acts can be performed, without departing from the scope and spirit of various examples. Plural instances may implement components, operations, or structures described as a single instance. Structures and functionality that may appear as separate in example embodiments may be implemented as a combined structure or component. Similarly, structures and functionality that may appear as a single component may be implemented as separate components. Accordingly, such alternative examples are included in the scope of the following claims, which are to be accorded the broadest interpretation to encompass such alternate examples. The terminology used herein was chosen to best explain the principles of the embodiments, the practical application or technical improvement over technologies found in the marketplace, or to enable others of ordinary skill in the art to understand the embodiments disclosed herein.

Further embodiments are illustrated in the following Examples which are given for illustrative purposes only and are not intended to limit the scope of the invention.

### EXAMPLES

### Example 1-Janus (aka Lyra): An Efficient and Expressive Sub-quadratic Architecture for Modeling Biological Sequences

### 1. Introduction

Applicants have developed Janus (aka Lyra), a new architecture that combines projected gated convolutions and subsequent S4 layers to address the need of both gating and input-dependent filters. By introducing gating, Applicants enabled the model to modulate the flow of information based on the input, akin to how attention mechanisms in transformers selectively weigh different parts of the input. Subsequently, the input-dependent nature of the convolution filters in S4 allows for a dynamic, data-responsive kernel, echoing the adaptability seen in attention.

Specifically, Applicants extended the data modulation concept introduced by BaseConv (Arora et al., 2023) by adding a learnable linear projection layer followed by root mean square normalization (RMSNorm) (Zhang & Sennrich, 2019) normalization before and after the depth-wise one-dimensional (1D) convolution. The pre-convolution projection layer facilitates learning by embedding the input into an intermediate space while the post-convolution linear layer decodes the gated convolution outputs back to the original hidden state dimension. The convolution between these projection layers efficiently extracts local sequence features. In parallel, Applicants used an additional learnable linear projection to capture global sequence features. Applicants then computed an element-wise product between the local convolution features and global linear features, enabling a comprehensive sequence analysis that accounts for both local and global context. The gated output is then projected and passed into the structured state space sequence model (S4D), which incorporates long-range dependencies.

The result is a model that not only mimics the sub-sequence interaction capabilities of transformers but does so with increased efficiency and scalability. This is particularly vital for biological tasks, where sequences are long and the relationships within the data are complex. By leveraging the input-dependent nature of both gating and convolution filters, the architecture offers a nuanced balance between the expressiveness of attention mechanisms and the efficiency of convolutions, potentially setting a new standard for sequence modeling in computational biology.

Applicants evaluated Janus (aka Lyra) on a broad array of biological tasks, achieving state-of-the-art (SOTA) performance in most tasks while using significantly fewer parameters than competing models. Across chromatin profiling, gene regulation, and clustered regularly interspaced short palindromic repeats (CRISPR)-related tasks, Janus (aka Lyra) outperforms CNN-, BERT-, GPT-, and long convolution-based models while using 4-30× fewer parameters. In protein-related sequence modelling tasks, a 55 thousand parameter Janus (aka Lyra) model outperformed models ESM-1B (Rives et al., 2021) and TAPE-BERT (Rao et al., 2019), which are 650 million and 91 million parameter pretrained models, respectively, using a 55 thousand parameter Janus (aka Lyra) model without pre-training.

Applicants highlight three main contributions of this work.
First, Applicants introduced a new model architecture, Janus (aka Lyra), that is highly expressive, lightweight, and straight forward to implement.
Second, this study demonstrated the broadest application of efficient convolutions and state spaces to biological tasks, including the first application to protein-related tasks.
Third, by outperforming existing state of the art models with significantly smaller Janus (aka Lyra) models, the model established a new promising subfamily of compact and easy to implement sub-quadratic architectures.

### 2. Preliminaries and Related Work

Deep learning applications in biological phenomena revolve around learning underlying representations or motifs in biological sequences. As highlighted above, CNNs and transformers have been used in the last decade with great success. Along with this, new architectures have recently emerged that enable low complexity and long-range sequence modeling, potentially enabling the path to more expressive sub-quadratic models for biological sequence modeling.

### 2.1. CNNs for Sequence Modeling

CNNs have shown robust performance across a wide array of biological sequence modeling tasks, from CRISPR enzyme activity prediction to DNA architecture prediction. These networks excel in capturing local patterns such as DNA-binding sequences (motifs), thanks to their high parallelizability and specialize in local feature extraction (Ghotra et al., 2021; Gu, 2023). Foundation models in biology frequently employ CNNs for tasks such as encoding to a classification head or as a down-sampling and implicit tokenization mechanism, thereby integrating CNNs with transformer blocks. This integration highlights CNN strengths in local feature extraction and positional information preservation, crucial for understanding biological functions (Avsec et al., 2021; Ghotra et al., 2021; Li et al., 2023).

In a 1D CNN, a causal convolution operation is performed on a discrete input sequence u[n] of length N and a kernel k[m] of length M. This process involves sliding the kernel k[m] across the input sequence u[n] and calculating a weighted sum at each position, expressed as (Arora et al., 2023; Poli et al., 2023):

$$( u * k ) [ n ] = {\sum }_{m = 0}^{M} u [ n - m ] \cdot k [ m ] \qquad ( 1 )$$

While this operation typically has a computational complexity of O(N²), the Fast Fourier Transform (FFT) allows for a more efficient computation at O(N log N). By transforming both the input and the kernel into the frequency domain using FFT, performing an element-wise multiplication, and then applying the inverse FFT, the convolution can be computed as (u*k)[n]=F⁻¹ {F{u}·F{k}}, where F represents the Fourier transform and F⁻¹ is its inverse.

A key feature of convolutions is shift equivariance, which enables convolutions to respond to patterns regardless of their position in a sequence; this is critical in biological contexts, where the function of sequences such as protein-binding sites depends on the pattern of elements rather than their absolute positions. However, the inherent limitations of CNNs, particularly their low receptive fields, restrict their effectiveness in modeling long-range sequence interactions, necessitating their combination with attention-based architectures like transformers to model such interactions.

### 2.2. Transformers

One of the most prevalent architectures for biological sequence analysis is the transformer, which uses an internal attention mechanism to compute pairwise interactions at all positions in a given sequence. This attention mechanism is defined using projections of the input u to a query matrix Q, key matrix K, and value matrix V, along with the internal dimension dₖ of the key projections (Vaswani et al., 2017):

$$A = softmax ( \frac{{QK}^{T}}{\sqrt{{d}_{k}}} ) V \qquad ( 2 )$$

This attention mechanism enables a controlled, gated flow of data through the softmax function, enabling a propagation of the most relevant pairwise interactions in a particular sequence. The pairwise nature of attention is suited particularly well for biological tasks, which often consist of pairwise interactions, for example in enhancer-promoter relationships in gene expression or amino-acid interactions in protein folding. While this mechanism has been central to recent innovations such as AlphaFold (Jumper et al., 2021), ESM-Fold (Rives et al., 2021), and Enformer (Avsec et al., 2021), transformers struggle with capturing local motifs and are constrained by a quadratic O(N²) complexity with sequence length N.

### 2.3. Heterogeneous and Hierarchical Architectures

Heterogeneous architectures have been developed in an attempt to leverage the localized strengths of convolutions with global pairwise relationships of transformers. For instance, ProteinBERT (Brandes et al., 2022), a foundation model for protein sequences, employs CNNs for input sequences and linear layers for annotations, with the outputs fed into a global attention layer. This architecture underscores the interdependency between local representations, captured by convolutions, and global representations, captured by transformers. However, the scale of these models can pose significant computational and resource challenges for local deployment, with even the distilled variant of ProteinBERT (Geffen et al., 2022) consisting of 230 million parameters.

Hierarchical architectures are another approach for leveraging both local and global contexts in a given sequence. To capture local features typically extracted by CNNs, hierarchical attention models like Shifting Window Attention (Swin) transformers utilize different types of attention blocks across different context lengths (Li et al., 2023). Specifically, these models utilize multi-head attention blocks for local processing, followed by shifting window attention for cross-window global attention. ProtFlash (Wang et al., 2023) represents another approach, employing mixed chunk attention that combines quadratic attention for local chunks with linear attention for global context. While both of these models have demonstrated excellent performance, they are still limited by a quadratic complexity as window or chunk length approaches the length of the sequence.

2.4. Enabling Long Range Sequence Modeling with Structured State Spaces Models

A new family of sequence models based on state space has recently been introduced to address the limitations of transformers and convolutions (Gu et al., 2021a;b). This family models sequences based on a linear mapping of input sequence u(t)∈R^{M} to output signal y(t)∈R^{M} through a latent representation x(t)∈R^{N}.

$${x}^{′} ( t ) = A ( t ) x ( t ) + B ( t ) u ( t ) \qquad ( 3 )$$

$$y ( t ) = C ( t ) x ( t ) \qquad ( 4 )$$

where A(t)∈R^{N×N}, B(t)∈R^{N×M}, C(t)∈R^{M×N}

Structured state space models, namely S4 and Mamba (Gu et al., 2021a; Gu & Dao, 2023), have been shown to efficiently approximate and memorize long sequences. This efficiency comes from their unique ability to dynamically represent a sequence. In S4, the learning process involves updating the parameters A, B, C to effectively map an input sequence u to an output y (Gu et al., 2021a). This formalizes the earlier notion of input-dependent convolutions where the learnable filter is a result of the dynamics of the state space for a given input. (Arora et al., 2023)

S4D (Gu et al., 2022), a variant of S4, enhances this process through an efficient diagonalization of the state spaces. This diagonalization allows S4D to retain the fundamental properties of S4 but simplifies the computation by focusing on the essential components of state space matrices. The S4D model uses these matrices to compute an implicit convolutional kernel K, which captures the temporal dynamics of the sequence. This kernel is represented as a discretized version of a continuous convolution, typically using a bilinear discretization approach. The linear ordinary differential equations (ODE) representation given by equations 3 and 4 can be constructed as a convolution by (Gu et al., 2021b; Fu et al., 2023):

$$K ( t ) = {Ce}^{tA} B \qquad ( 5 )$$

$$y ( t ) = ( K * u ) ( t )$$

Here, the convolutional kernel K(t) in S4D is a linear combination of basis functions Kₙ(t), each representing a different aspect of the sequence dynamics (Gu, 2023; Gu et al., 2022). The coefficients C control this combination:

$$K ( t ) = {\sum }_{n = 0}^{N - 1} {C}_{n} {K}_{n} ( t ) {K}_{n} ( t ) := {e}_{n}^{T} {e}^{tA} B \qquad ( 6 )$$

This representation shows how S4D captures temporal dependencies in sequences, simplifying the computational process while maintaining the core strengths of the S4 model.

### 2.5. Gating and Data Modulation Strategies for Convolution Models

One of the driving factors that makes attention so expressive is its data modulation of inputs by applying the softmax non-linearity. To achieve comparable data modulation, efficient long convolution models like H3 (Fu et al., 2022) and Hyena (Poli et al., 2023) rely on attention-esque gating of these efficient convolution blocks or on dense activations, respectively. Most recently, a measurement study on associative recall performance of these highly efficient convolution models proposed an efficient gating strategy called BaseConv (Arora et al., 2023), which takes an input sequence u and provides it to both a depth wise convolution and a linear layer. This extends convolutions with input-dependent mixing to evaluate subsequence interactions. The output of the convolution and linear layer are then gated with the whole operation calculated sub quadratically.

### 3. Methods

The Janus (aka Lyra) architecture integrates two distinct stages for enhanced sequence processing: (1) first, a projected gated convolution module, which builds upon the BaseConv (Arora et al., 2023) model of Arora et al. by incorporating linear projections coupled with RMSNorm at the input, gating, and output stages; and (2) next, a second stage diagonalized state space model, S4D, which leverages the mixed input tokens from the first stage. This setup facilitates the learning of both local and global context within sequences, capitalizing on the strengths of the S4D architecture to address complex dependencies in the data.

### 3.1. Projected BaseConv Module

At the first stage of the model, a projected biological sequence represented by u∈R^{N×d}, where N is the sequence length and d is the projected feature dimensionality, undergoes two primary transformations. First, in each layer l the sequence u is linearly projected using a weight matrix W¹ᵢₙ∈R^{d×d}′ and a bias vector b¹ᵢₙ∈R^{N×d}′, where d′ is the internal projection dimension. This linear projection, followed by RMS normalization, transforms the sequence to emphasize its global context. This output u′ₚᵣₒⱼ is then processed through a depth wise 1D convolutional layer, applying a set of d′ learnable filters h¹∈R^{N′} to the sequence, where N′<N, and the addition of another bias vector b¹₂∈R^{N×d′}. This convolution, adept at extracting local features, maintains shift equivariance, ensuring sensitivity to the relative positioning of features within u and capturing local dependencies. In parallel, a linear projection of u′ₚᵣₒⱼ computes global features using a weight matrix W¹∈R^{d′×d′} and a bias vector b¹₁∈R^{N×d′}. The resulting vectors of the convolution and projection of u′ₚᵣₒⱼ are then element-wise multiplied to form u′_{conv}. This is then further mixed via a subsequent projection using weight matrix W¹ₒᵤₜ∈R^{d′×d} and a bias vector b¹ₒᵤₜ∈R^{N×d}, and followed by an RMS normalization step. This process ensures a thorough integration of both local and global features, crucial for effective modeling of biological sequences.

The projected BaseConv Module can be formulated as:

$${u}_{proj}^{′} = RMSNorm ( u \cdot {W}_{in}^{ℓ} + {b}_{in}^{ℓ} ) \qquad ( 7 )$$

$${u}_{conv}^{′} = ( {u}_{proj}^{′} \cdot {W}^{ℓ} + {b}_{1}^{ℓ} ) ⊙ ( {h}^{ℓ} * {u}_{proj}^{′} + {b}_{2}^{ℓ} ) \qquad ( 8 )$$

$${y}^{′} = ( {u}_{conv}^{′} \cdot {W}_{out}^{ℓ} + {b}_{out}^{ℓ} ) \qquad ( 9 )$$

### 3.2. S4D for Long Range Sequence Modeling

A key insight of the work is to use the first stage projected and gated convolution results as an input to a structured state space model with diagonalized state spaces (S4D) (Gu et al., 2022). As such, the combined architecture leverages both local and global context provided by the first stage to enhance its capacity for modeling long-range dependencies. The Janus (aka Lyra) model outputs, enriched by the gating mechanism, are projected back to the hidden state size compatible with S4D. This integration allows S4D to operate on a more expressive latent space informed by the nuanced representations captured by projected BaseConv.

By integrating the outputs from the projected BaseConv into S4D, Janus (aka Lyra) benefits from the first stage's ability to capture both local and global context. This enhanced representation, fed into the S4D model, allows for a more comprehensive understanding of the sequence dynamics. The structural basis functions of S4D effectively process these enriched representations, enabling the model to capture complex, long-range dependencies inherent in sequential data. This integration not only boosts the expressive power of the latent space but also ensures that the model is well-equipped to handle the intricacies of various tasks, be it classification or regression, in the realm of computational biology.

### 3.3. Biological Domain Explorations

To benchmark performance and generalization, Applicants evaluated Janus (aka Lyra) across diverse biological prediction tasks without any pretraining. These encompass major genomic and proteomic challenges including chromatin profiles, gene regulation, CRISPR activity, and protein fitness landscapes. This selection tested intrinsic model capacity to tackle distinct learning objectives pertinent to key areas of computational biology.

### 4. Experiments

Applicants assessed Janus (aka Lyra) on tasks spanning major biological domains without specialized tuning or pretraining. In genomics, Applicants predicted chromatin profiling of DNA sequence (Zhou & Troyanskaya, 2015) and performance in gene regulation on the GenomicBenchmark (Grešová et al., 2023) dataset. Applicants also predicted CRISPR editing efficacy (Metsky et al., 2022; DeWeirdt et al., 2022) and in proteomics, Applicants modeled fitness landscapes (Castro et al., 2022), enzymatic activities, and complex structural properties using the Tasks Assessing Protein Embeddings (TAPE) dataset (Rao et al., 2019). Applicants compared off-the-shelf Janus (aka Lyra) performance to state-of-the-art models to elucidate the tradeoffs between specialized inductive biases and generalization capacity. This comprehensive evaluation probed intrinsic versatility to tackle varied regression and classification objectives with Janus (aka Lyra).

TABLE 1
Model performance on GenomicBenchmark Datasets on Top-1 (%) accuracy

| | MODELS | | | | |
|---|---|---|---|---|---|
| | JANUS | | | | |
| | (aka Lyra) | GPT | HYENADNA | HYENADNA | DNABERT |
| | PRETRAINED | | | | |
| | NO | YES | NO | YES | YES |
| MODEL PARAMETERS | 106K | 529K | 436K | 436K | 110M |
| MOUSE ENHANCERS | 80.9 | 79.3 | 84.7 | 85.1 | 66.9 |
| CODING VS INTERGENOMIC | 94.0 | 91.2 | 90.9 | 91.3 | 92.5 |
| HUMAN VS WORM | 96.6 | 96.6 | 96.4 | 96.6 | 96.5 |
| HUMAN ENHANCERS COHN | 73.4 | 72.9 | 72.9 | 74.2 | 74.0 |
| HUMAN ENHANCERS ENSEMBL | 86.8 | 88.3 | 85.7 | 89.2 | 85.7 |
| HUMAN REGULATORY | 93.3 | 91.8 | 90.4 | 93.8 | 88.1 |
| HUMAN NONTATA PROMOTERS | 96.7 | 90.1 | 93.3 | 96.6 | 85.6 |
| HUMAN OCR ENSEMBLE | 79.9 | 79.9 | 78.8 | 80.9 | 75.1 |

### 4.1. Genomics Tasks

Chromatin profiling: Given the pivotal role of epigenetic regulatory activity in controlling gene expression, Applicants next tested Janus (aka Lyra) in this domain. The DeepSEA dataset (Zhou & Troyanskaya, 2015) is employed for this evaluation, as it extensively profiles human genomic epigenetic regulatory activity using DNase-seq and ChIP-seq assays. This dataset annotates 919 chromatin accessibility and histone modification features at single nucleotide resolution, posing a 919-way multilabel classification challenge essential for evaluating a model's capacity to decode the regulatory DNA language and comprehend long-range chromosomal grammar. In tests involving 1,000 nucleotides long genomics sequences (Table 2), a Janus (aka Lyra) model with 678k parameters achieves an SOTA AUC-ROC of 93.1 on DNase I-hypersensitive sites (DHS). However, Applicants note that while Janus (aka Lyra) performs competitively with competing models with a 1,000 sequence length, there is a persistent 3-4% performance gap for histone mark classification compared to models evaluated on sequences of length 8,000.

TABLE 2
Comparative Analysis on Chromatin Profile 919-way classification:
AUC-ROC for prediction in transcription factor (TF), DNase
I-hypersensitive sites (DHS), and histone markers (HM)

| | | | | AUC-ROC | |
|---|---|---|---|---|---|
| MODEL | PARAMS | LEN | TF | DHS | HM |
| DEEPSEA | 40M | 1K | 95.8 | 92.3 | 85.6 |
| BIGBIRD | 110M | 8K | 96.1 | 92.1 | 88.7 |
| HYENADNA | 7M | 1K | 96.4 | 93.0 | 86.3 |
| HYENADNA | 3.5M | 8K | 95.5 | 91.7 | 89.3 |
| JANUS | 678K | 1K | 95.9 | 93.1 | 86.1 |

GenomicBenchmarks: In a standardized suite of genomics benchmarks, which includes a variety of classification tasks targeting key gene-regulating regions (Table 1), the Janus (aka Lyra) model achieved notably better performance against SOTA baselines, despite being significantly more compact. Janus (aka Lyra) is approximately four times smaller than any other model in this comparison, yet it consistently surpasses larger models. These benchmarks evaluated Janus's (aka Lyra) ability to process sequences ranging from 200 to 4,776 bases. Remarkably, without any pre-training, Janus (aka Lyra) outperformed the pre-trained DNABERT (Ji et al., 2021) in 7 of 8 tasks. It also exceeds the performance of a pre-trained GPT-based DNA model in 6 out of 8 tasks, with equal performance in another task. When compared to the long convolution-based HyenaDNA, Janus (aka Lyra) demonstrated superior results in 7 out of 8 tasks when both models are not pre-trained. Even in scenarios where HyenaDNA is pre-trained and Janus (aka Lyra) is not, Janus (aka Lyra) still outperformed HyenaDNA in 3 out of 8 tasks. This highlights Janus's (aka Lyra) efficiency and robustness, especially notable given its significantly smaller size and ability to handle complex genomic sequences without extensive pre-training.

### 4.2. CRISPR Tasks

In CRISPR technologies, Applicants rigorously evaluated Janus (aka Lyra) models across two applications: viral diagnostics using Cas13 and gene edit targeting with Cas9. CRISPR enzymes can be programmed using a “guide” molecules sequence to find and respond to a specific target sequence, with the strength of response differing with respect to the specific guide-target sequence pair.

Cas13 diagnostics: Applicants found that Janus (aka Lyra) demonstrated SOTA performance in Cas13-related tasks (Table 3) with 31.6× fewer parameters than the CNN-based ADAPT model. Specifically, in classification tasks, Janus (aka Lyra) has an AUC-ROC and AUPR of 0.939 and 0.990, respectively, compared to 0.866 and 0.972 for the ADAPT model. In regression tasks, Janus (aka Lyra) again outperformed the CNN-based model, with Spearman's correlation coefficients of 0.856 and 0.810, compared to 0.774 and 0.686 for the ADAPT models looking at all guide-target pairs and only positive-identified guide-target pairs, respectively. Highlighting the efficiency and expressivity of Janus (aka Lyra), these performance gains were achieved with a model comprising only 3.8k parameters, in contrast to the ADAPT model's 120k parameters.

Cas9 genome editing: Janus (aka Lyra) exhibited similarly promising performance in the Cas9 genome editing domain, beating pre-established models for Cas9 performance in almost all tested datasets. Across all 9 tested datasets (Table 4), Janus (aka Lyra) achieved an average Spearman's correlation of 0.51, compared to 0.45 and 0.36 for CRISPRon (Xiang et al., 2021) and DeepSpCas9 (Kim et al., 2019), both highly-used CNN-based models. Impressively, in the Behan2019 dataset, Janus (aka Lyra) more than doubled the correlation score of CRISPRon (Xiang et al., 2021) and DeepSpCas9 (Kim et al., 2019), with a coefficient of 0.439 compared to 0.219 and 0.198, respectively.

TABLE 3
Comparative Analysis on Cas13a: AUC-ROC, AUPR,
Spearman's Correlations, and Model Parameters

| | | JANUS |
|---|---|---|
| | ADAPT CNN | (aka Lyra) |
| MODEL PARAMETERS | 120K | 3.8K |
| AUC-ROC | 0.866 | 0.939 |
| AUPR | 0.972 | 0.990 |
| ALL GUIDE-TARGETS SPEARMAN'S | 0.774 | 0.856 |
| POSITIVE ONLY SPEARMAN'S | 0.686 | 0.810 |

TABLE 4
Comparative Analysis on Cas9: 5-fold Spearman's
Correlations, and Model Parameters

| | DATASET | | |
|---|---|---|---|
| | JANUS | | |
| | (aka Lyra) | CRISPRON | DEEPSPCAS9 |
| MODEL PARAMETERS | 13.3k | 420k | 320k |
| DOENCH2014_MOUSE | 0.508 | 0.445 | 0.432 |
| DOENCH2014_HUMAN | 0.513 | 0.457 | 0.454 |
| DOENCH2016 | 0.416 | 0.386 | 0.389 |
| WANG2014 | 0.421 | 0.359 | 0.050 |
| MUNOZ2016 | 0.474 | 0.317 | 0.085 |
| BEHAN2019 | 0.439 | 0.219 | 0.198 |
| KIM2019 | 0.747 | 0.896 | 0.773 |
| AGUIRRE216 | 0.562 | 0.538 | 0.525 |

### 4.3. Protein Tasks

Proteins are complex biomolecules whose sequence directly determines structure and function. A key challenge is modeling higher-order epistatic effects, wherein amino acids interact nonlinearly and at varying distances to alter protein properties (Cadet et al., 2022). As such, protein-related tasks serve as ideal tests for the Janus (aka Lyra) architecture, which was specifically designed to evaluate interactions at varying distances.

Protein Fitness: Applicants first tested Janus (aka Lyra) on a group of three protein datasets exhibiting epistasis: the Gifford antibody enrichment dataset, which shows sequence viability over selection rounds; the GB1 dataset, which combines stability and binding affinity to define fitness across a mutational landscape; and the GFP fluorescence dataset, which directly quantifies mutant functionality. Each dataset consists of protein sequences ranging in length from 20 to 237 amino acids as inputs and either log fluorescence or CRD3 enrichment regression targets. Applicants compared this model against the SOTA Regularized Latent Space Optimization (ReLSO) model (Castro et al., 2022) which is comprised of a series of 10 transformer encoder layers and 4 decoding heads that simultaneously predict the protein sequence and assess the fitness of the encoded embeddings derived from the sequence. In these tests (Table 5), Janus (aka Lyra) outperformed three ReLSO variants on all three datasets, and surpassed the other two variants (ReLSO-Interp and ReLSO-α=0.5) in two datasets while matching performance on a third dataset. Notably, Janus (aka Lyra) achieved these SOTA performances with a model size of 55,000 parameters, compared to the 7-8.3 million parameters in the ReLSO decoder blocks alone.

TABLE 5
Spearman correlation scores for different models on protein fitness
datasets for antibody binding (Gifford dataset), antibody fitness
(GB1 dataset), and green fluorescent protein (GFP) brightness

| | GIFFORD | GB1 | |
|---|---|---|---|
| MODEL | (AB BINDING) | (AB FITNESS) | GFP |
| RELSO (INTERP) | 0.48 | 0.43 | 0.86 |
| RELSO (NEG) | 0.47 | 0.42 | 0.77 |
| RELSO α = 0.1 | 0.35 | 0.53 | 0.84 |
| RELSO α = 0.5 | 0.50 | 0.45 | 0.85 |
| RELSO | 0.48 | 0.44 | 0.70 |
| JANUS (OURS) | 0.49 | 0.61 | 0.86 |

TAPE Protein Benchmarks: Applicants next tested Janus (aka Lyra) against a larger family of attention-based protein models across Tasks Assessing Protein Embeddings (TAPE) (Rao et al., 2019), (Table 6) a well-established suite of proteomic benchmarking datasets. Specifically, Applicants evaluated the model on predicting remote homology, fluorescence, and protein stability. Applicants compete against DistilProteinBert (Geffen et al., 2022) (230M parameters), ESM-1b (Rives et al., 2021) (650M parameters), ProtFlash (Wang et al., 2023) (174M parameters)—all models that have been pre-trained on millions of protein sequences from pFam (Mistry et al., 2021) and Uniref90 (Suzek et al., 2015). Janus (aka Lyra) achieved SOTA performance on two out of the three (fluorescence and super-family top-1 remote homology) benchmarks with a 55,000 parameters model without pretraining—reducing parameter count by up to 11,818× while increasing performance. Although Janus (aka Lyra) reached SOTA performance in two out of three tasks, it struggled on the stability regression task. Applicants determined that this was due to overfitting, which was still present in smaller Janus (aka Lyra) models with as few as 4,000 parameters.

### 5. Discussion

Janus (aka Lyra) introduced a new sequence modeling architecture that achieves SOTA performance across diverse biological challenges, including beating established protein models while using 127×-11,818× fewer parameters. The effectiveness of

TABLE 6
Model Performance on TAPE Datasets; including fluorescence
prediction (fluor), protein stability prediction,
and remote homology super-family (RH)

| MODEL | # PARAMS | FLUOR | STABILITY | RH |
|---|---|---|---|---|
| TAPE-BERT | 91M | 0.64 | 0.73 | 0.34 |
| DISTILPROTBERT | 230M | 0.67 | 0.74 | 0.52 |
| ESM-1B | 650M | 0.47 | 0.77 | 0.50 |
| PROTFLASH-BASE | 174M | 0.68 | 0.79 | 0.50 |
| JANUS (OURS) | 55K | 0.62 | 0.43 | 0.59 |

Janus (aka Lyra) stems from two key innovations working in tandem: RMS-normalized projected gated convolutions and a diagonalized state space model, S4D. The projected convolutions, extending BaseConv, enabled efficient mixing of local features without quadratic scaling complexity. By feeding these representations into an S4D layer, Janus (aka Lyra) captured contextualized global interactions critical for modeling complex biochemical phenomena. Together, this combination provides a versatile modeling approach without any pre-training requirements.

By testing Janus (aka Lyra) on a comprehensive set of biological tasks, Applicants found that it excels in generalizability and effectiveness in many aspects of biological sequence modelling. From genomics, to CRISPR, and to proteomics, Applicants found that Janus (aka Lyra) improved upon SOTA results in some tasks in every domain, with sub-quadratic efficiency and significantly smaller model sizes. Applicants noted that the most dramatic improvements in performance versus model size occur in protein modelling tasks. This result is especially significant as proteins are complex chemical structures with both short-distance and long-distance interactions between groups of amino acids. This supports the architectural choices made in Janus's (aka Lyra) design, which was engineered to capture both local and global interactions in sequences.

While Janus (aka Lyra) demonstrated consistent gains over prior specialized models, limitations point to open challenges in some complex prediction tasks. Notably, Janus (aka Lyra) achieved SOTA performance in DNase I hypersensitive site classification, but falls 3-4% short in histone mark classification compared to other models. This parallels empirical findings from Notin et al. in proteomics, where they find that pre-training is required in certain tasks to make meaningful predictions (Notin et al., 2023). Future work is planned to explore these issues via pre-training and further model scaling for chromatin-related tasks, particularly investigating the efficacy of increased hidden size, layer count, and pre-training on a singular, complete human genome.

In this study, Janus (aka Lyra) has shown promising results in generalized sequence modeling, sparking interest in further exploring its capabilities. Building upon these initial findings, Applicants envision exciting future directions, such as evaluating Janus's (aka Lyra) integration as the sequence encoder within generative models like RFDiffusion (Watson et al., 2023) for advanced structure generation and protein design. Exploring Janus's (aka Lyra) scalability as the backbone for both score-based diffusion and broadly autoregressive tasks could position it as a versatile alternative to traditional transformers in computational biology.

### REFERENCES FOR EXAMPLE 1

Arora, S., Eyuboglu, S., Timalsina, A., Johnson, I., Poli, M., Zou, J., Rudra, A., and Ré, C. Zoology: Measuring and improving recall in efficient language models. arXiv preprint arXiv:2312.04927, 2023.
Avsec, Ž., Agarwal, V., Visentin, D., Ledsam, J. R., Grabska-Barwinska, A., Taylor, K. R., Assael, Y., Jumper, J., Kohli, P., and Kelley, D. R. Effective gene expression prediction from sequence by integrating long-range interactions. Nature methods, 18(10):1196-1203, 2021.
Brandes, N., Ofer, D., Peleg, Y., Rappoport, N., and Linial, M. Proteinbert: a universal deep-learning model of protein sequence and function. Bioinformatics, 38(8):2102-2110, 2022.
Cadet, F., Saavedra, E., Syren, P.-O., and Gontero, B. Machine learning, epistasis, and protein engineering: From sequence-structure-function relationships to regulation of metabolic pathways. Frontiers in Molecular Biosciences, 9:1098289, 2022.
Castro, E., Godavarthi, A., Rubinfien, J., Givechian, K., Bhaskar, D., and Krishnaswamy, S. Transformer-based protein generation with regularized latent space optimization. Nature Machine Intelligence, 4(10):840-851, 2022.
DeWeirdt, P. C., McGee, A. V., Zheng, F., Nwolah, I., Hegde, M., and Doench, J. G. Accounting for small variations in the tracrrna sequence improves sgrna activity predictions for crispr screening. Nature Communications, 13(1):5255, 2022.
Fu, D. Y., Dao, T., Saab, K. K., Thomas, A. W., Rudra, A., and Ré, C. Hungry hungry hippos: Towards language modeling with state space models. In The Eleventh International Conference on Learning Representations, 2022.
Fu, D. Y., Epstein, E. L., Nguyen, E., Thomas, A. W., Zhang, M., Dao, T., Rudra, A., and Ré, C. Simple hardware-efficient long convolutions for sequence modeling. arXiv preprint arXiv:2302.06646, 2023.
Geffen, Y., Ofran, Y., and Unger, R. Distilprotbert: a distilled protein language model used to distinguish between real proteins and their randomly shuffled counterparts. Bioinformatics, 38(Supplement 2):ii95-ii98, 2022.
Ghotra, R. S., Lee, N. K., and Koo, P. K. Uncovering motif interactions from convolutional-attention networks for genomics. In NeurIPS 2021 AI for Science Workshop, 2021.
Gresǒvá, K., Martinek, V., Čechák, D., Šimeček, P., and Alexiou, P. Genomic benchmarks: a collection of datasets for genomic sequence classification. BMC Genomic Data, 24(1):25, 2023.
Gu, A. Modeling Sequences with Structured State Spaces. PhD thesis, Stanford University, 2023.
Gu, A. and Dao, T. Mamba: Linear-time sequence modeling with selective state spaces. arXiv preprint arXiv:2312.00752, 2023.
Gu, A., Goel, K., and Ré, C. Efficiently modeling long sequences with structured state spaces. In International Conference on Learning Representations, 2021a.
Gu, A., Johnson, I., Goel, K., Saab, K., Dao, T., Rudra, A., and Ré, C. Combining recurrent, convolutional, and continuous-time models with linear state space layers. Advances in neural information processing systems, 34:572-585, 2021b.
Gu, A., Goel, K., Gupta, A., and Ré, C. On the parameterization and initialization of diagonal state space models. Advances in Neural Information Processing Systems, 35:35971-35983, 2022.
Ji, Y., Zhou, Z., Liu, H., and Davuluri, R. V. Dnabert: pre-trained bidirectional encoder representations from transformers model for dna-language in genome. Bioinformatics, 37(15):2112-2120, 2021.
Jumper, J., Evans, R., Pritzel, A., Green, T., Figurnov, M., Ronneberger, O., Tunyasuvunakool, K., Bates, R., Žídek, A., Potapenko, A., et al. Highly accurate protein structure prediction with alphafold. Nature, 596(7873):583-589, 2021.
Kim, H. K., Kim, Y., Lee, S., Min, S., Bae, J. Y., Choi, J. W., Park, J., Jung, D., Yoon, S., and Kim, H. H. Spcas9 activity prediction by deepspcas9, a deep learning-based model with high generalization performance. Science advances, 5(11):eaax9249, 2019.
Li, Z., Das, A., Beardall, W. A., Zhao, Y., and Stan, G. B. Genomic interpreter: A hierarchical genomic deep neural network with 1d shifted window transformer. arXiv preprint arXiv:2306.05143, 2023.
Metsky, H. C., Welch, N. L., Pillai, P. P., Haradhvala, N. J., Rumker, L., Mantena, S., Zhang, Y. B., Yang, D. K., Ackerman, C. M., Weller, J., et al. Designing sensitive viral diagnostics with machine learning. Nature biotechnology, 40(7):1123-1131, 2022.
Mistry, J., Chuguransky, S., Williams, L., Qureshi, M., Salazar, G. A., Sonnhammer, E. L., Tosatto, S. C., Paladin, L., Raj, S., Richardson, L. J., et al. Pfam: The protein families database in 2021. Nucleic acids research, 49(D1):D412-D419, 2021.
Nguyen, E., Poli, M., Faizi, M., Thomas, A. W., Wornow, M., Birch-Sykes, C., Massaroli, S., Patel, A., Rabideau, C. M., Bengio, Y., et al. Hyenadna: Long-range genomic sequence modeling at single nucleotide resolution. In Thirty-seventh Conference on Neural Information Processing Systems, 2023.
Notin, P., Weitzman, R., Marks, D. S., and Gal, Y. Proteinnpt: Improving protein property prediction and design with non-parametric transformers. bioRxiv, pp. 2023-12, 2023.
Poli, M., Massaroli, S., Nguyen, E., Fu, D. Y., Dao, T., Baccus, S., Bengio, Y., Ermon, S., and Ré, C. Hyena hierarchy: Towards larger convolutional language models. arXiv preprint arXiv:2302.10866, 2023.
Rao, R., Bhattacharya, N., Thomas, N., Duan, Y., Chen, P., Canny, J., Abbeel, P., and Song, Y. Evaluating protein transfer learning with tape. Advances in neural information processing systems, 32, 2019.
Rives, A., Meier, J., Sercu, T., Goyal, S., Lin, Z., Liu, J., Guo, D., Ott, M., Zitnick, C. L., Ma, J., et al. Biological structure and function emerge from scaling unsupervised learning to 250 million protein sequences. Proceedings of the National Academy of Sciences, 118(15):e2016239118, 2021.
Suzek, B. E., Wang, Y., Huang, H., McGarvey, P. B., Wu, C. H., and Consortium, U. Uniref clusters: a comprehensive and scalable alternative for improving sequence similarity searches. Bioinformatics, 31(6):926-932, 2015.
Vaswani, A., Shazeer, N., Parmar, N., Uszkoreit, J., Jones, L., Gomez, A. N., Kaiser, Ł., and Polosukhin, I. Attention is all you need. Advances in neural information processing systems, 30, 2017.
Wang, L., Zhang, H., Xu, W., Xue, Z., and Wang, Y. Deciphering the protein landscape with protflash, a lightweight language model. Cell Reports Physical Science, 4(10), 2023.
Watson, J. L., Juergens, D., Bennett, N. R., Trippe, B. L., Yim, J., Eisenach, H. E., Ahern, W., Borst, A. J., Ragotte, R. J., Milles, L. F., et al. De novo design of protein structure and function with rfdiffusion. Nature, 620(7976): 1089-1100, 2023.
Xiang, X., Corsi, G. I., Anthon, C., Qu, K., Pan, X., Liang, X., Han, P., Dong, Z., Liu, L., Zhong, J., et al. Enhancing crispr-cas9 grna efficiency prediction by data integration and deep learning. Nature communications, 12(1):3238, 2021.
Zhang, B. and Sennrich, R. Root mean square layer normalization. Advances in Neural Information Processing Systems, 32, 2019.
Zhou, J. and Troyanskaya, O. G. Predicting effects of noncoding variants with deep learning-based sequence model. Nature methods, 12(10):931-934, 2015.

### A. Experimental Details

In the following section, Applicants provide details the Janus (aka Lyra) model instantiation and training procedures for all tasks. All tasks were evaluated on Nvidia GPUs either an A100-40 GB or H100-80 GB.

### A.1. Genomic Tasks

### A.1.1. Chromatin Profiling

TABLE 7
Janus (aka Lyra) Model Configuration for Chromatin Profiling

| PARAMETER | 678,183 |
|---|---|
| D_MODEL | 256 |
| N_LAYERS | 2 |
| DROPOUT | 0.2 |
| D_INPUT | 4 |
| D_OUTPUT | 919 |
| PRENORM | TRUE |
| PGC BLOCK 1 | 16 HIDDEN DIM, |
| | 0.2 DROPOUT |
| PGC BLOCK 2 | 128 HIDDEN DIM, |
| | 0.2 DROPOUT |

Experiment Details: The DeepSEA dataset (Zhou & Troyanskaya, 2015) aggregated 919 attributes including 690 transcription factor (TF) binding profiles spanning 160 distinct TFs, alongside 125 DNase I hypersensitive sites (DHS) and 104 histone modification (HM) profiles. The dataset is constructed from 1,000 base pair sequences extracted from the hg19 human reference genome, with each sequence linked to a 919-dimensional target vector indicating the presence or absence of a chromatin feature peak within the central 200 bp. The adjacent 400 bp regions provide extended context, crucial for accurate feature prediction. Strict non-overlapping training and testing sets are partitioned by chromosome, featuring 2.2 million training samples and 227. Each of these sequences was one-hot-encoded and trained using binary cross entropy loss with the AdamW optimizer with 0.001 learning rate and 0.01 weight decay. Janus (aka Lyra) was trained over 200 epochs, aligning with the methodology delineated in HyenaDNA (Nguyen et al., 2023) and evaluated the median AUC-ROC, for each of the 919 classes within the subset of DHS, TF, and HM profiles.

A.1.2. GenomicsBenchmark

TABLE 8
Janus (aka Lyra) Model Configuration for GenomicBenchmark

| PARAMETER | 106,434 |
|---|---|
| D_MODEL | 128 |
| N_LAYERS | 1 |
| DROPOUT | 0.2 |
| D_INPUT | 4 |
| D_OUTPUT | 2 |
| PRENORM | TRUE |
| PGC BLOCK 1 | 16 HIDDEN DIM, |
| | 0.2 DROPOUT |
| PGC BLOCK 2 | 128 HIDDEN DIM, |
| | 0.2 DROPOUT |

Experimental Details: In the investigation utilizing the GenomicsBenchmark (Grešová et al., 2023) suite, Applicants focused on eight binary classification tasks related to regulatory genomic elements. The datasets within this suite presented a diverse range of sequence lengths, varying from 200 to approximately 4800 base pairs. To standardize the input, Applicants employed one-hot encoding for the sequences, padding them to the maximum length specific to each dataset. In cases of absent sequences, padding was implemented using the ‘N’ token, represented by [0,0,0,0]. The training protocol involved a consistent 500 epochs for each dataset, optimizing the model with AdamW, a learning rate of 0.001, and a weight decay of 0.01, under the guidance of cross-entropy loss. Applicants evaluated each dataset on top-1% accuracy metric for each dataset.

### A.2. CRISPR Tasks

### A.2.1. Adapt Cas13

TABLE 9
Janus (aka Lyra) Model Configuration for Cas13a
classification and regression tasks

| PARAMETER | 3,793-3,810 |
|---|---|
| D_MODEL | 16 |
| N_LAYERS | 1 |
| DROPOUT | 0.2 |
| D_INPUT | 8 |
| D_OUTPUT | 1, 2 |
| PRENORM | TRUE |
| PGC BLOCK 1 | 16 HIDDEN DIM, |
| | 0.2 DROPOUT |

Experiment Details: For the CRISPR Cas13 dataset (Metsky et al., 2022), Applicants encoded guide-target pairs using a one-hot encoding scheme with a dimensionality of 4 for each guide and target. These were then concatenated to form a stacked representation with an 8-dimensional one-hot-encoded vector for sequences of 48 base pairs. The log fluorescence threshold to distinguish active from non-active pairs was set at a value of −4.00. The model underwent 5-fold cross-validation across three distinct tasks. In the first task, binary classification of guide-target pairs was performed, assessing the model's performance through AUC-ROC and AUPR metrics, with each fold being trained for 75 epochs. The following two tasks involved regression analyses: the first was a positive-only regression targeting values above the activity threshold, and the second encompassed a comprehensive regression across all guide-target pairs, both positive and negative. Both regression tasks were evaluated using Spearman's coefficient, following the same 75-epoch, 5-fold cross-validation structure.

### A.2.2. Cas9

TABLE 10
Janus (aka Lyra) Model Configuration for
Cas9 classification and regression tasks

| PARAMETER | 13,361 |
|---|---|
| D_MODEL | 48 |
| N_LAYERS | 1 |
| DROPOUT | 0.2 |
| D_INPUT | 4 |
| D_OUTPUT | 1 |
| PRENORM | TRUE |
| PGC BLOCK 1 | 16 HIDDEN DIM, |
| | 0.2 DROPOUT |

Experimental Details: Applicants utilized a composite of seven CRISPR Cas9 datasets—Kim2019 train, Doench2014 mouse, Doench2014 human, Doench2016, Wang2014, Xiang2021, and Munoz2016—comprising 46,526 unique context sequences. These sequences were characterized by a 20-nucleotide spacer sequence flanked by four nucleotides upstream and a PAM sequence plus three nucleotide contexts downstream, with 45% of sequences incorporating the Chen tracrRNA variant. Each sequence was one-hot encoded to capture the nucleotide arrangement intricately. For the purposes of model training and validation, Applicants adhered to a 5-fold cross-validation procedure, meticulously applied to both training and test sets. Each fold was trained for 150 epochs of training and evaluated using Spearman's correlation for regression enzymatic activity based on a sequence.

### A.3. Protein Tasks Model Configuration: Applicants Use the Same Architecture for Both the Protein Fitness Datasets as Well as the TAPE Evaluations.

### A.3.1. Protein Fitness Prediction Tasks

Experiment Details: For the protein fitness prediction tasks, the Janus (aka Lyra) was trained across three fitness prediction datasets GB1, Gifford, and GFP. Each dataset contained amino acid sequences of the same length which were one-hot-encoded, input dimension of 20, with the stability and affinity, enrichment, or fluorescence respectively values serving as regression labels. The training was performed for 500 epochs, utilizing the AdamW optimizer with a learning rate of 0.001 and a weight decay of 0.01. The evaluation metric was Spearman's rank correlation coefficient on the validation set, and Mean Squared Error Loss (MSELoss) was used as the loss function.

TABLE 11
Janus (aka Lyra) Model Configuration for all protein tasks

| PARAMETER | 55,169 |
|---|---|
| D_MODEL | 64 |
| N_LAYERS | 1 |
| DROPOUT | 0.2 |
| D_INPUT | 20 |
| D_OUTPUT | 1 |
| PRENORM | TRUE |
| PGC BLOCK 1 | 16 HIDDEN DIM, |
| | 0.2 DROPOUT |
| PGC BLOCK 2 | 128 HIDDEN DIM, |
| | 0.2 DROPOUT |

### A.3.2. Tape Evaluations

Experimental Details: The evaluation of Janus (aka Lyra) on TAPE spanned three distinct datasets, addressing fluorescence prediction based on sequence mutations, top-1 accuracy for remote homology detection within super-families, and predictions of structural stability. Applicants adhered to a one-hot encoding scheme for all sequences. For the fluorescence and structural stability tasks, models were trained and subsequently evaluated based on their Spearman regression performance against the training set. Both regression tasks utilized Mean Squared Error (MSE) as the loss criterion, with the AdamW optimizer set to a learning rate of 0.001 and a weight decay of 0.01. The remote homology task, classified as a 7-way classification challenge, followed the same training regimen of 500 epochs evaluated by top-1 accuracy on the test set. Here, cross entropy loss was employed, factoring in class sample distributions to inform the loss function, and the same AdamW optimizer settings were maintained.

### B. Ablation Studies

Applicants present a preliminary investigation of model substitutions in proteomic tasks and intend on extending this investigation to genomic tasks.

### B.1. Investigation of Hyena Vs BaseConv on ReLSO Tasks

In order to discern the impact of the projected gated convolution (PGC) backbone within the model, Applicants conducted a series of ablation studies on the Protein fitness landscape tasks, adhering to the training regimen delineated in Appendix A. These studies were designed to evaluate the effect of substituting the PGC with a Hyena layer and to assess the implications of omitting the backbone entirely to test the S4D component in isolation. The findings revealed that while replacing the PGC with a Hyena layer did result in a decline in performance, the removal of the backbone to evaluate the S4D alone demonstrated a more pronounced drop across all tasks. This suggests the critical role of the PGC backbone in the model's architecture for maintaining superior performance in protein fitness landscape tasks.

TABLE 12
Spearman correlation scores for different models on protein fitness
datasets for antibody binding (Gifford dataset), antibody fitness
(GB1 dataset), and green fluorescent protein (GFP) brightness

| | GIFFORD | GB1 | |
|---|---|---|---|
| Model | (AB Binding) | (AB Fitness) | GFP |
| JANUS (aka Lyra) | 0.50 | 0.61 | 0.86 |
| HYENA + S4D | 0.48 | 0.60 | 0.85 |
| S4D | 0.48 | 0.57 | 0.85 |

### Example 2

### Abstract

Deep learning architectures such as convolutional neural networks and Transformers have revolutionized biological sequence modeling, with recent advances driven by scaling up foundation and task-specific models. The computational resources and large datasets required, however, limits their applicability in biological contexts. Applicants introduce Lyra, a sub-quadratic architecture for sequence modeling, grounded in the biological framework of epistasis for understanding sequence-to-function relationships. Mathematically, Applicants demonstrate that state space models (SSMs) efficiently capture global epistatic interactions and combine them with projected gated convolutions for modeling local relationships. Applicants demonstrate that Lyra is performant across over 100 wide-ranging biological tasks, achieving state-of-the-art performance in many key areas, including protein fitness landscape prediction, biophysical property prediction (e.g., disordered protein region functions) peptide engineering applications (e.g. antibody binding, cell-penetrating peptide prediction), RNA structure analysis, RNA function prediction, and CRISPR guide design. It does so alongside orders-of-magnitude improvements in inference speed and reduction (up to 127,272×) in parameters compared to recent biology foundation models. Lyra democratizes access to biological sequence modeling at SOTA performance, with potential applications to many fields.

### INTRODUCTION

The interpretation and modeling of biological sequences are central challenges in computational biology, with profound implications for understanding molecular function and evolution. At their core, biological sequences—whether DNA, RNA, or proteins—encode explicit instructions that determine molecular properties, binding affinities, and structural configurations. Machine learning (ML) approaches seek to uncover these sequence-to-function relationships by modeling how primary sequence determines structural stability, fitness landscapes, and molecular activities[1-6]. Deep learning approaches have attempted to decode this inherent “grammar” by capturing both local patterns and long-range dependencies in biological data[6-10]. This insight can predict how sequence variations affect biological function across scales, from protein folding to cellular regulation[1,11-14].

Deep learning models such as convolutional neural networks (CNNs) and Transformers have become powerful tools for biological sequence modeling, each excelling in different domains[1,2,15-17]. CNNs excel at identifying local patterns and maintain efficient sub-quadratic O(N*K) scaling with sequence length N and kernel size K[18-20]. Transformers excel at capturing long-range dependencies through self-attention mechanisms, enabling pairwise comparisons between distant residues, but require quadratic O(N²) scaling with sequence length[21-23]. Transformer-based models, such as AlphaFold2 [1], have demonstrated remarkable success in tasks like protein structure prediction by leveraging the evolutionary insight that sequence homology implies structural conservation[1,24]. However, Transformers often struggle with modeling local motifs, and their quadratic computational complexity limits their scalability. Hybrid architectures, such as Enformers[2,25], have been developed to combine CNNs for local context modeling with Transformers for global interactions, although they remain constrained by Transformer scaling limitations[26].

Achieving high performance in either Transformer-only or hybrid models frequently requires immense scale—often exceeding billions of parameters—as demonstrated by models like ESM3[27]. This reliance on scaling to capture task-specific patterns often falls short in biological systems due to a mismatch between the limited data available in many biological tasks and the scale required to learn the nuanced sequence-function relationships[9,28]. This highlights the need for continued innovations in model efficiency and scalability[29-31]. To address these challenges, Applicants sought to identify intrinsic biological phenomena with well-defined mathematical structures that could provide a tractable foundation for modeling biological sequences.

Epistasis—the influence of mutations on each other within a sequence—is one such phenomenon[32-35]. While empirically complex and not fully understood, epistatic interactions can be framed as combinations of individual and joint mutation effects. These effects map to polynomial functions, where each term captures specific interactions, providing a principled framework for navigating the combinatorially vast space of sequence-to-function relationships.

Building on this polynomial interpretation, Applicants identify state space models (SSMs) as a natural fit for sequence-to-function modeling[31,36-39], as they are grounded in ordinary differential equations (ODEs) well-suited for representing polynomials. Their reliance on structured matrices aligns seamlessly with polynomial approximation theory, enabling efficient modeling of epistatic interactions. Additionally, SSMs offer significant computational advantages (including O(N log N) scaling with sequence length), while gated convolutions complement these models by providing efficient mechanisms for integrating local context.

SSMs provide a theoretical bridge between classical function approximation theory and modern neural networks. By representing sequences as linear dynamical systems, SSMs offer a structured approach to sequence modeling with sub-quadratic computational complexity. The key insight lies in recognizing that the basis of polynomials that parameterize SSMs naturally aligns with the requirements for approximating higher-order polynomial functions. This alignment enables efficient representation of the complex interaction hierarchies present in biological sequences, providing a principled framework for capturing epistatic effects.

Lyra integrates gated convolutions with SSMs, creating a hybrid approach that efficiently captures both local and global relationships. This design achieves sub-quadratic computational complexity while maintaining the ability to model complex biological sequence-to-function relationships. Through careful analysis of the model's parameterization, Applicants demonstrate how Lyra decomposes complex epistatic interactions into interpretable components, providing insights into both the model's function and the underlying biological mechanisms it captures.

Applicants evaluated Lyra through an extensive set of biological sequence modeling tasks that span multiple scales of complexity. At the protein level, Applicants assess performance on fundamental biophysical properties (such as disorder regions), viral protein identification, and challenging protein engineering applications (including antibody binding, Green Fluorescent Protein [GFP] fluorescence, and cell-penetrating peptides). At the nucleic acid level, Applicants examine RNA function prediction (including splice sites, alternative polyadenylation, and ribosome loading), promoter activity prediction, and Clustered Regularly Interspaced Short Palindromic Repeats (CRISPR) genome editing efficiency (for both Cas9 and Cas13 systems). Beyond benchmarking performance, Applicants perform detailed ablation studies to investigate the contributions of the architectural components in Lyra.

### Results

### Polynomial Expressivity Enables Efficient Mapping of Biological Sequences to Functions

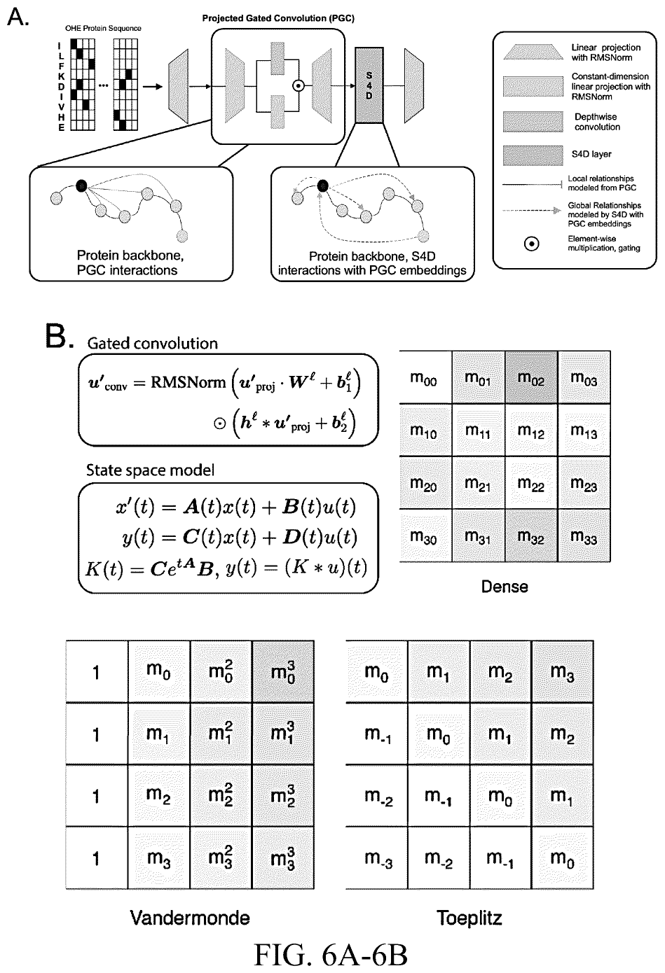

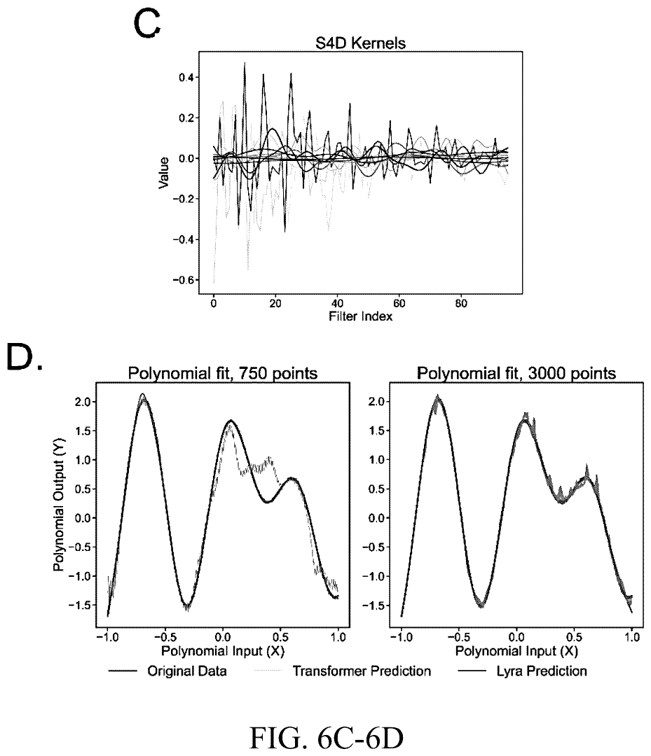

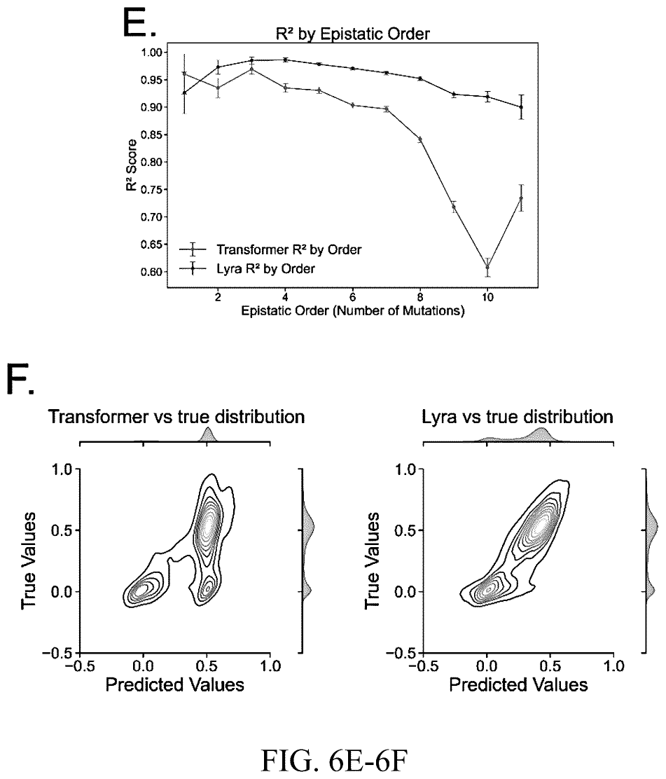

Lyra is a novel sequence modeling architecture designed to align with the mathematical structure of intra-molecular epistatic interactions in biological sequences. Its design integrates Projected Gated Convolutions (PGCs) for efficient local modeling and S4D (Diagonalized SSMs)[37] to implement a circular (non-casual) convolution for capturing long-range dependencies (FIG. 6A-B). By combining these components, Lyra bridges local and global sequence features, all while maintaining computational efficiency, enabling a principled approach to modeling the inherent syntactic and functional structure of biological sequences.

Epistasis arises whenever the contribution of sequence element uⱼ depends on other positions uⱼ [32-35]. An epistatic landscape of a sequence u₁ . . . u_{N} with epistatic order K can be written as

$$f ( u ) = {\sum }_{k = 1}^{K} {\sum }_{1 \leq {i}_{1} < {i}_{2} < ⋯ < {i}_{k} \leq N} {c}_{{i}_{1} {i}_{2} … {i}_{k}} {u}_{{i}_{1}} {u}_{{i}_{2}} … {u}_{{i}_{k}} ,$$

where the learned coefficients c_{i1, . . . , iN} capture higher-order interactions. Directly solving for all possible epistatic interactions is infeasible for higher orders k l and large sequence lengths, motivating an architecture that implicitly approximates these polynomial interactions. Lyra achieves this by combining two core components: (i) a projected gated convolution (PGC) layer for local feature gating, and (ii) a Diagonalized State Space Model (S4D) layer for efficiently modeling long-range, global dependencies.

Lyra first addresses local epistatic effects through a projected gated convolution (PGC). First Applicants transform through a projection that makes the features richer. The transformed sequence is then processed through two parallel pathways: one applies a depth-wise 1D convolution to extract local dependencies, while the other uses a linear projection to model global relationships. This gating of two layers explicitly encodes second-order interactions. By stacking such layers, Lyra can capture even higher-order dependencies without explicitly enumerating them. Further derivations, including a detailed expansion of these multiplicative terms, can be found in the Appendix. Building on the PGC's local processing, Lyra captures longer-range dependencies using State Space Models (SSMs), which Applicants demonstrate theoretically and validate empirically to be efficient polynomial approximators. Originally developed to model dynamical systems, an SSM in discrete time evolves a hidden state xₜ under a linear difference equation (FIG. 6B):

$${x}_{t + 1} = A {x}_{t} + B {u}_{i} , {y}_{t} = C {x}_{t} ,$$

where u_t is the input and y_t the output. The A matrix can be formulated in numerous ways; a diagonalized construction of this matrix is known to expose a Vandermonde matrix structure (FIG. 6B).

Lyra adopts a diagonalized variant of the state space matrices (S4D), which Applicants show is particularly advantageous in modelling polynomial functions such as those in biological epistasis. Crucially, S4D utilizes a well-conditioned Vandermonde matrix (FIG. 6B), which has a structure that imposes constraints that align with the polynomial interpretation of epistasis, ensuring that long-range dependencies are captured without the intractable cost of enumerating high-order cross-terms. The Appendix provides further mathematical details on the Vandermonde construction, FFT convolution, and how SSMs integrate with Lyra. By combining local PGC layers with a global S4D module, Lyra consistently models short-range motifs and global sequence interactions within a unified, polynomial-inspired framework.

Through these capabilities, Lyra captures the multi-scale dependencies inherent in biological epistasis, outperforming Transformer-based approaches, particularly for higher-order interactions. This alignment of architecture with biological principles enables Lyra to uncover complex relationships in fitness landscapes, providing a principled and efficient framework for sequence-based modeling tasks. When tested on synthetic polynomial functions (FIG. 6D), Lyra demonstrates superior approximation capabilities using less data compared to Transformer of equivalent size (FIG. 6D) Transformers.

These theoretical advantages translate directly to modeling epistasis in biological applications. When tested on green fluorescent protein sequences with known epistatic effects, Lyra maintains high performance even for higher-order epistatic interactions where Transformer performance degrades significantly (FIG. 6E). The model accurately captures interactions across different epistatic orders, successfully identifying the bimodal distribution of protein fitness that Transformer-based approaches fail to resolve (FIG. 6F). This improved capture of the fitness landscape demonstrates how Lyra's architectural innovations enable more efficient modeling of complex biological sequence relationships.

### Efficient Protein Function Modeling Across Diverse Functional Landscapes

Understanding how protein sequences encode biological function remains a central challenge in molecular biology. This relationship is inherently complex due to epistasis—where the effect of one amino acid depends on the presence of other amino acids throughout the protein sequence [35,53]. These higher-order dependencies create intricate fitness landscapes that have traditionally required either highly specialized architectures for specific tasks or massive pretrained models capturing broad sequence patterns [1,7,8,16,54,55]. While specialized models can achieve high accuracy on individual tasks and large models can generalize across functions, both approaches face significant computational limitations, especially when analyzing longer sequences or larger datasets[28,36,56].

Applicants benchmarked Lyra's architectural innovations against current state-of-the-art (SOTA) protein function prediction methods across diverse tasks, comparing both performance and computational requirements. To ensure robust and fair evaluation of model performance, Applicants adhered to predefined train/test splits where available, as documented in the original datasets. For datasets without predefined splits, Applicants applied prescribed partitioning methods or, where unavailable, used random splits that maintained the original data distribution. This consistent approach ensures comparability across tasks and avoids potential biases in data handling. Further details, including sequence lengths, dataset sizes, and training parameters, are provided in the Methods section.

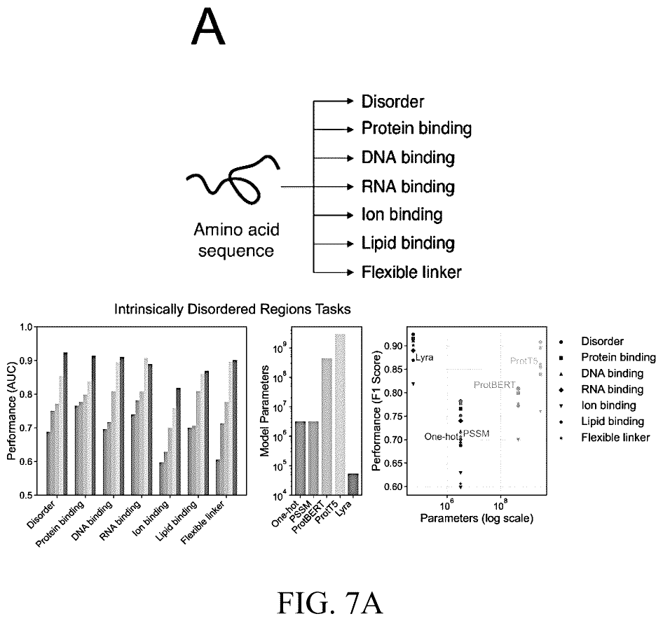

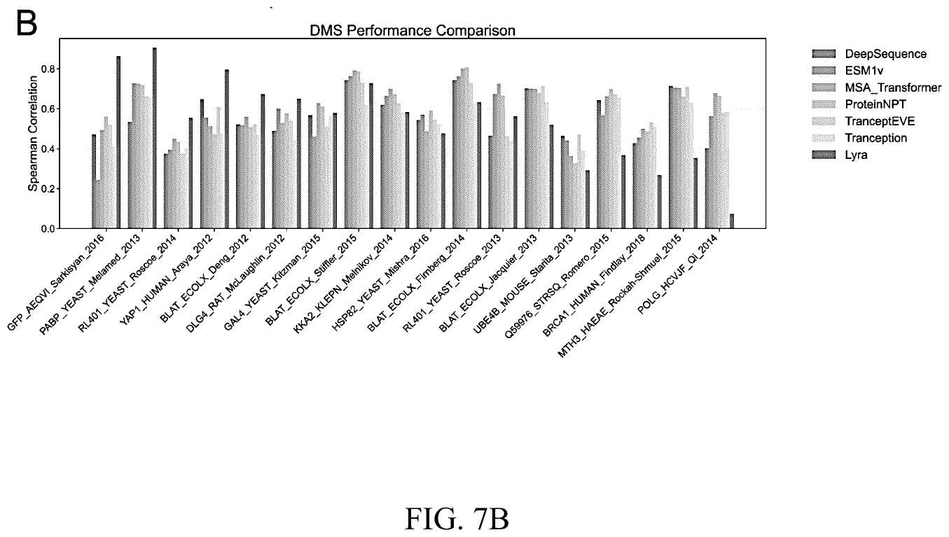

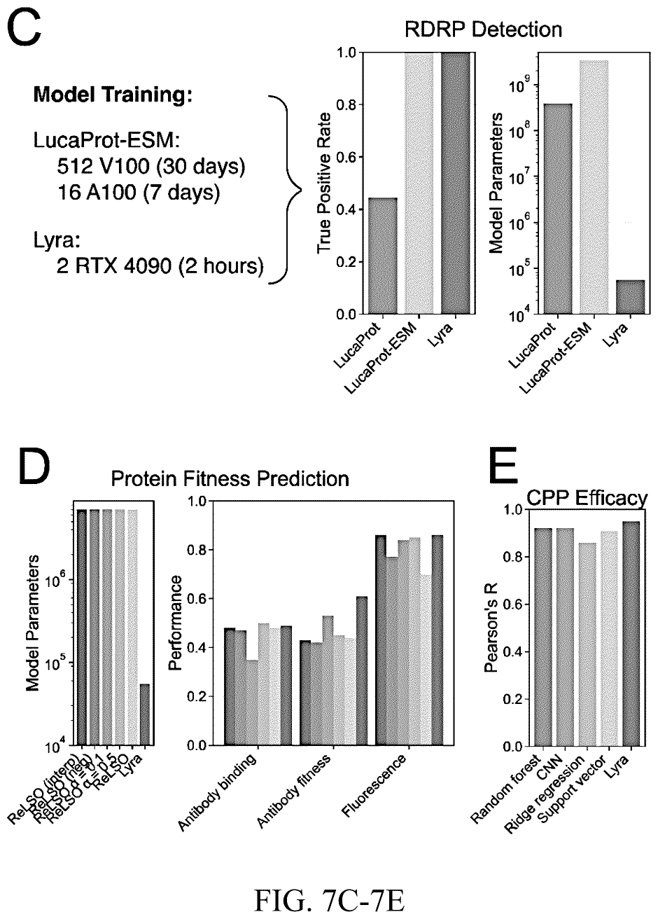

Lyra enables SOTA prediction of intrinsically disordered protein regions, which represent a crucial aspect of protein function[57,58]. These regions, which lack stable 3D structure, play essential roles in cellular signaling and are implicated in neurodegenerative diseases. Notably, the Alzheimer's-associated Amyloid-β and Parkinson's-associated α-synuclein proteins are intrinsically disordered[57,59,60]. In terms of performance, Lyra achieves SOTA accuracy in six out of seven tasks, including accuracies of 0.931, 0.925, and 0.935 for disorder, protein binding, and DNA binding predictions respectively, compared to ProtT5's 0.855, 0.839, and 0.896 for the same tasks[42]. The model achieves this with remarkable efficiency. While ProtT5 required pre-training on 14 billion amino acids using 5,616 GPUs, Lyra is trained solely on the task-specific dataset of 300,000 amino acids using two GPUs in 10 minutes, using only 55,618 parameters compared to ProtT5's approximately 3,000,000,000 parameters—a 53,939-fold reduction in parameter count (FIG. 7A).

Lyra achieves SOTA performance on more deep mutational scanning (DMS) tasks in the evaluation than any other tested model, ranking first in 6 out of 18 datasets (FIG. 7B). DMS provides a systematic framework for measuring how mutations affect protein function, making it a crucial benchmark for assessing sequence-function models. While ProteinNPT[47] led in overall average R² (0.608 vs. 0.549 for Lyra), Lyra exhibited the largest performance margins in the tasks where it was SOTA. On its six SOTA datasets, Lyra outperformed the next-best model by an average margin of 0.150, far exceeding the gaps seen for MSA Transformer (0.023 margin across five SOTA datasets)[24], ProteinNPT[47] (0.017 margin across three SOTA datasets), and TranceptEVE (0.014 across margin across two datasets)[48]. This suggests that Lyra is uniquely suited to certain mutational landscapes, excelling in cases where other models achieve only incremental gains. Notably, Lyra achieved SOTA on datasets spanning enzyme activity (BLAT_ECOLX), RNA-binding proteins (PABP_YEAST), and fluorescent proteins (GFP_AEQVI), highlighting its ability to make predictions across diverse protein functions. These predictions are achieved with a 55,169-parameter Lyra model, whereas all comparison models are larger than 80M parameters, more than a 1,500× reduction in parameter count.

Lyra enables SOTA detection of RNA-dependent RNA polymerases (RDRPs), highly conserved viral proteins crucial for identifying novel pathogens and advancing the understanding of viral biology and evolution[61-64]. Using sequence information alone, Lyra achieves a 0.998 true positive rate in detection tasks, equaling LucaProt-ESM's performance while incorporating structure-aware ESMfold embeddings, and more than doubling LucaProt's structure-free variant (0.445 true positive rate)[50]. This performance was achieved by training Lyra from scratch within 2 hours on two R TX 4090 GPUs, compared to LucaProt-ESM's compute requirements: 512 V100 GPUs for 30 days to train the ESMfold foundation model[16], followed by 7 days of task-specific training on 16 A100 GPUs (FIG. 7C). Notably, Lyra does this with the same 55,618 parameter model architecture as in the intrinsically disordered protein task, compared to 3.39 billion parameters in LucaProt-ESM, a 60,951-fold reduction in parameter count.

Lyra enables SOTA prediction of mutation impacts on protein function, demonstrated through antibody performance and fluorescent protein brightness prediction tasks (FIG. 7D). Predicting how sequence changes affect protein function is essential for protein engineering[11,65-67], with antibodies serving as sophisticated test cases due to their complex sequence-function relationships[68-70] and GFP providing a well-characterized system for validating epistatic effects[71-73]. While ReLSO, a Transformer-based model designed for protein fitness landscape prediction [51], applies latent space optimization to refine sequence-function relationships, Lyra achieves comparable or superior performance across multiple tasks, performing competitively in antibody binding (0.49 vs. 0.50), matching it on GFP brightness (0.86 vs. 0.86), and surpassing RELSO variants in stability prediction (0.61 vs. 0.53). Notably, while there are five RELSO variants, none achieves top-2 performance in more than one task, whereas Lyra ranks first or second across all three tasks. These predictions are achieved using a 55,169 parameter Lyra model, compared to RELSO's 7,000,000 parameters (FIG. 7D)—a 127× reduction in parameters.

Lyra delivers state-of-the-art (SOTA) performance in predicting cell-penetrating peptides (CPPs), which are essential for transporting therapeutic cargo across cellular membranes and play a crucial role in drug delivery (FIG. 7E). Using CPP data from Pentelute et al.[52], Lyra achieves a Pearson's correlation of 0.95 in a regression task, outperforming the previous SOTA of 0.92 set by a nonparametric random forest model. The model maintains the same efficient 55,617-parameter architecture used in other tasks, enabling rapid prediction of CPP effectiveness.

### Efficient Nucleic Acid Modeling Spans Regulatory, Structural, and Engineering Tasks

Understanding RNA and DNA sequence function remains a fundamental challenge in molecular biology, requiring models that can capture both local motifs and long-range dependencies that define regulatory elements[2,12,74-76]. These sequences control gene expression through diverse mechanisms including promoter activity, splice site selection, and translation regulation[75-78]. Additionally, the growing field of gene editing relies on precise protein-RNA-DNA interactions, where RNA guides must accurately target specific DNA sequences[19,79]. Traditional architectures have struggled to simultaneously capture these varied functional elements while maintaining computational efficiency[2,80,81].

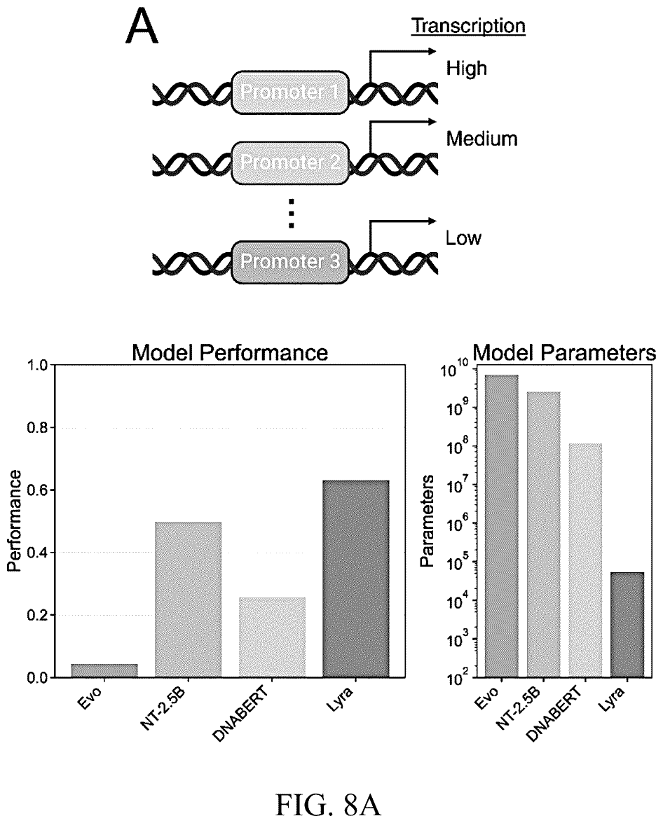

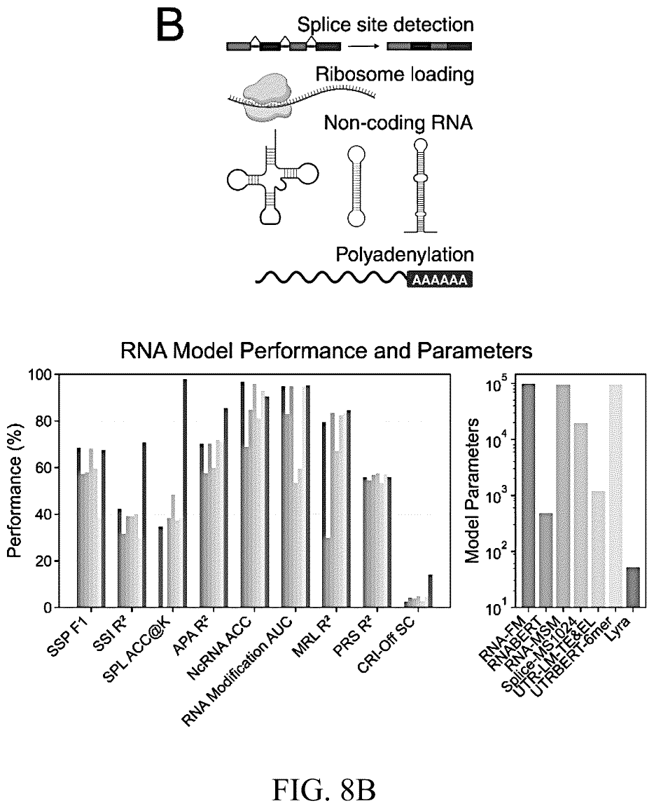

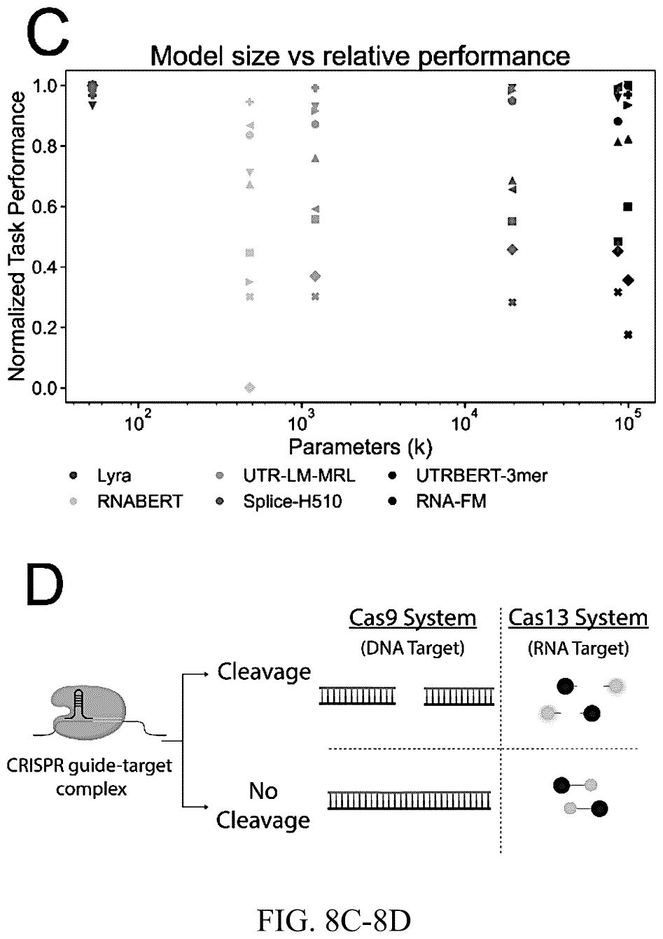

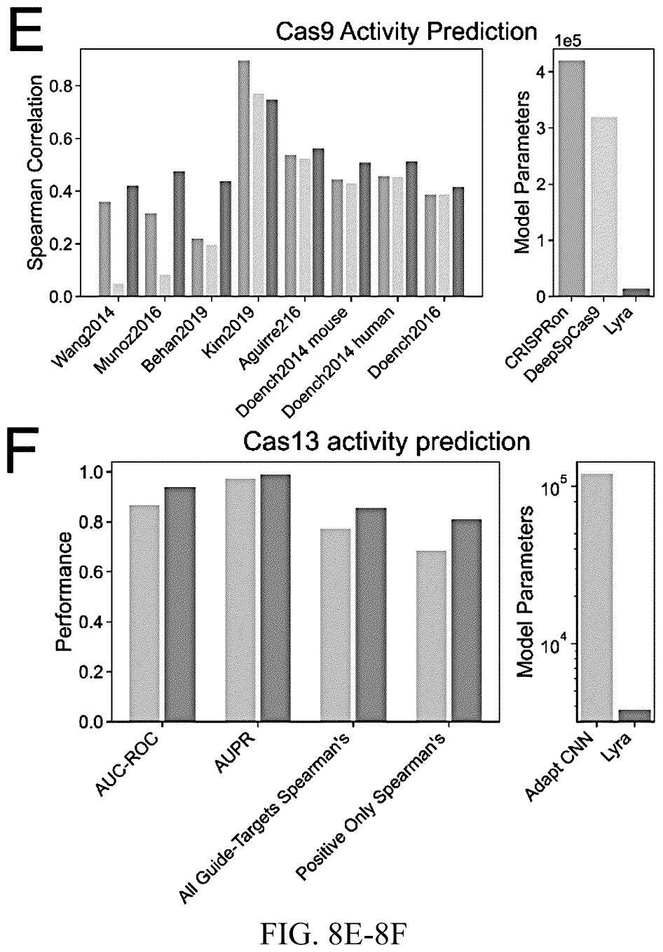

Lyra sets SOTA performance in predicting promoter activity levels. Promoter sequences serve as critical control switches for gene expression, determining where and how strongly genes are activated in cells, with accurate prediction being essential for understanding gene regulation and designing synthetic genetic circuits[13,75,82]. In performance testing across prokaryotic promoters, Lyra achieves a Spearman correlation of 0.63, substantially outperforming modern foundation models (Nucleotide Transformer-2.5B[23]: 0.50, DNABERT[83]: 0.26, Evo[8]: 0.04) and baseline approaches. Remarkably, a Lyra model accomplishes this with only 54,145 parameters, contrasting sharply with larger models like Evo (7 billion parameters), NT-2.5B (2.5 billion parameters), and DNABER T (117 million parameters), representing more than a 125,000-fold reduction in parameters while improving performance (FIG. 8A).

Lyra achieves SOTA performance on the BEACON RNA benchmarking suite[78] (FIG. 8B). This comprehensive benchmark evaluates RNA sequence analysis across nine distinct tasks critical for understanding gene regulation, from splice site recognition to ribosome loading prediction. In performance testing, Lyra sets new SOTA in five out of nine tasks, with particularly dramatic improvements in structural score imputation (r² of 0.7305 versus previous best RNA-FM's 0.4236 [84]) and splice site prediction (98.89% accuracy versus previous best Splice-MS510's[85] 50.55%, a relative improvement of 95.63%). Lyra is performant across all tasks; in the two tasks where it does not set SOTA, its relative performance is within 7% of the best result (FIG. 8C). In contrast, the next best model, UTRBERT-3mer, is on average 23.17% below SOTA across tasks and is 66.81% below Lyra's performance in its worst task. These improvements are achieved using just 54,000 parameters, compared to 86.1 million parameters for UTRBERT-3mer[14] and up to 99.5 million parameters for RNA-FM (FIG. 8B), up to a 1,809-fold reduction in parameters.

Finally, Applicants examine Lyra's performance and computational efficiency for studying CRISPR guide RNA activity prediction (FIG. 8D). Accurate guide prediction is crucial for both diagnostic and therapeutic applications, where guide-target recognition efficiency can vary by orders of magnitude (FIG. 8F)[79,86,87]. These applications span from Cas9-mediated genome editing needing efficient DNA targeting to Cas13-based viral diagnostics requiring precise RNA detection (FIG. 8C).

Lyra sets SOTA performance in Cas9 genome editing prediction accuracy. Precise genome editing requires guides that efficiently and specifically direct Cas9 to target DNA sequences, with guide selection directly impacting therapeutic outcomes[86,87]. Evaluated across eight independent datasets spanning different experimental conditions and cell types[86,88-93], Lyra achieves an average Spearman correlation of 0.51 compared to 0.45 and 0.36 for CRISPRon[19] and DeepSpCas9[91], improving performance in seven out of eight datasets. Notably, Lyra more than doubles prediction accuracy on the challenging Behan2019 dataset[89] with a correlation of 0.439 versus 0.219 and 0.198 for CRISPRon and DeepSpCas9. These advances are achieved using just 13,300 parameters compared to CRISPRon's 420,000 and DeepSpCas9's 320,000 parameters (FIG. 8D).

Lyra demonstrates SOTA performance in Cas13-based diagnostic applications. These systems require highly specific guide-target recognition for reliable viral detection and pathogen surveillance [79,94,95]. In classifying between active and non-active guide-target pairs, Lyra achieves an AUC-ROC of 0.939 and AUPR of 0.990, outperforming the previous SOTA ADAPT model (0.866 and 0.972). For quantitative activity prediction, Lyra achieves Spearman correlations of 0.856 and 0.810 for all guide-target pairs and positive-identified pairs respectively, compared to ADAPT's 0.774 and 0.686. These improvements are achieved with just 3,800 parameters, a 31.6-fold reduction from ADAPT's 120,000 parameters (FIG. 8E).

### Improved Inference Speed and Memory Requirements Lowers Barriers in Biological Modeling

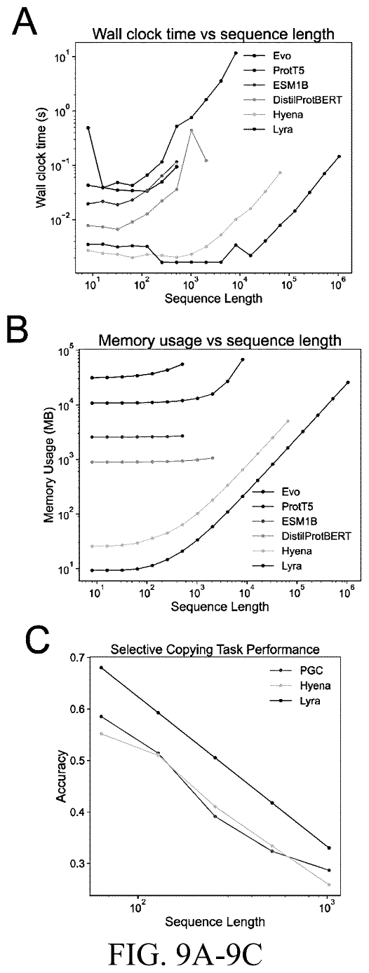

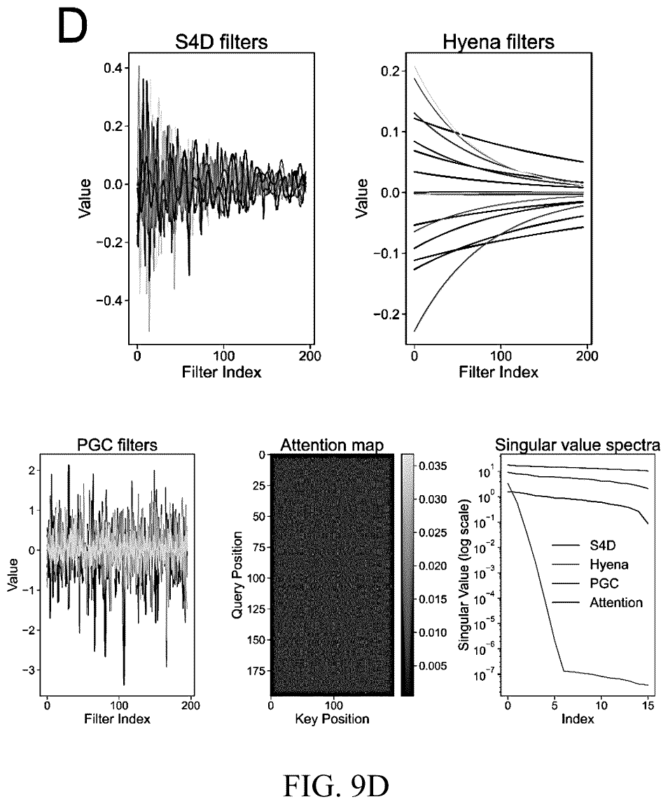

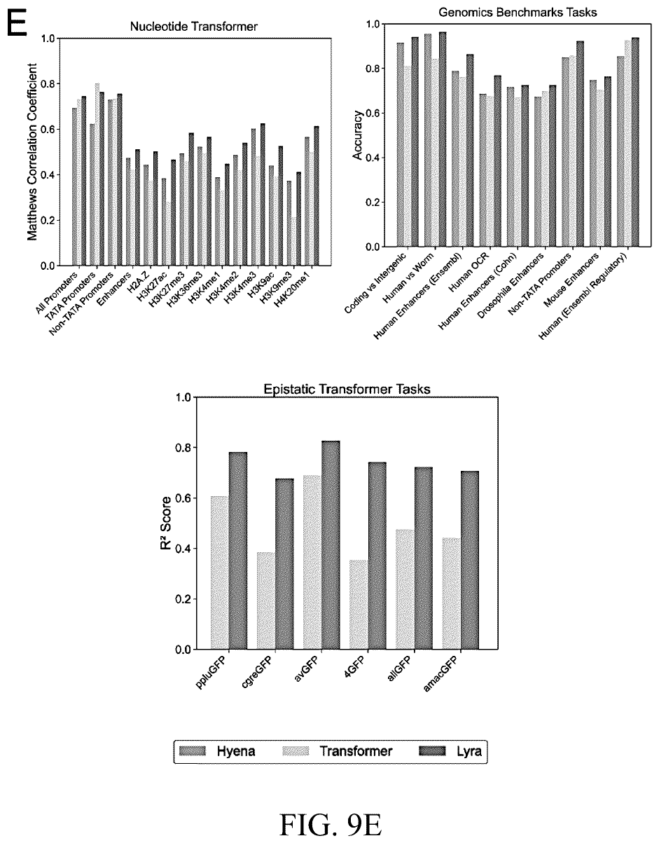

Beyond setting new SOTA benchmarks across diverse tasks, Lyra reduces computational requirements, enabling more widespread adoption. With O(N log N) computational scaling relative to sequence length—compared to the quadratic complexity of attention mechanisms[21]—Lyra achieves substantial speedups across various sequence lengths and batch sizes (FIG. 9A). For sequence length 512, Lyra is 28.4×, 69.71×, and 239.2× faster than ESM-1b[9] for batch sizes 1, 2, and 8, respectively, and 9.4× and 21.1× faster than DistilProtBert[96] for batch sizes 1 and 2. Batch size 8 did not run for DistilProtBert due to memory constraints, and ESM-1b ran out of memory for sequence length 1,024 at batch size 1 on an Nvidia A100.

Lyra's sub-quadratic scaling also enables the processing of substantially longer sequences than Transformer-based foundation models. Due to the quadratic scaling of computation and memory, Transformer-based models become computationally infeasible in the experimental setup beyond sequence lengths of 4,096. In contrast, Lyra efficiently processes sequences up to 65,536 in length, enabling significantly longer-range modeling due to its sub-quadratic complexity. On an Nvidia A100, Lyra achieves this in just 7.9 ms at batch size 2, making it 8.3× faster than HyenaDNA (FIG. 9A).

In addition to its speed, Lyra dramatically reduces memory requirements. Most tasks were computed with a Lyra model of 55,000 parameters, which performed favorably compared to models such as ESM-1B and DistilProtBert, with 650 million[9] and 230 million parameters[96], respectively—a reduction of 11,818-fold in parameter count. This significant reduction translates directly to lower memory usage, enabling training and deployment on consumer-grade hardware. For example, at sequence length 512 and batch sizes 1, 2, and 8, Lyra uses 125.8×, 127.9×, and 138.1× less memory than ESM-1b and 43.0× and 43.8× less memory than DistilProtBert for batch sizes 1 and 2, respectively (FIG. 9B). Due to these low memory requirements, Applicants were able to train and run every task in this study on two or fewer GPUs in under two hours, a stark contrast to prior approaches requiring clusters of specialized GPUs running for days or weeks.

Ablation studies were further carried out.

To assess Lyra's effectiveness as a general-purpose architecture, Applicants compared it to similarly-sized Hyena-based and Transformer++-based models across genomics and protein function tasks. Hyena employs depth-wise convolutions and gated long convolutions, while Transformer++ is an optimized Transformer recipe that integrates rotary position embeddings (RoPE), RMSNorm pre-normalization, and SwiGLU for feature extraction. Additionally, Applicants directly compared Lyra to Transformer++ on epistatic modeling tasks to evaluate its ability to capture complex mutation interactions.

Lyra consistently improved performance across tasks, outperforming Hyena and Transformer++ on 9 out of 9 Genomics Benchmark tasks and 17 out of 18 Nucleotide Transformer tasks. In epistatic modeling, Applicants tested only Lyra and Transformer++, with Lyra achieving higher R² scores across all 8 tasks, demonstrating improved modeling of mutation interactions. For nucleotide sequence classification, Lyra outperformed Hyena and Transformer++ on regulatory sequence tasks, including promoter, enhancer, and histone modification prediction. Similarly, in genomic classification, Lyra showed superior accuracy in functional annotation tasks such as coding vs. intergenic regions, enhancer detection, and regulatory element classification. These results establish Lyra as a highly generalizable architecture that improves over both convolutional and transformer-based approaches, demonstrating strong performance across a broad range of biological sequence modeling tasks. Its ability to model diverse molecular properties with minimal task-specific tuning suggests that Lyra could serve as a foundation for future advances in sequence-to-function tasks.

### DISCUSSION

The ability of SSMs to efficiently approximate polynomial functions provides a powerful new mathematical framework for modeling biological sequences. This fundamental insight enables Lyra to capture complex epistatic interactions—where the effect of one mutation depends on other mutations-more effectively than previous approaches. By combining this mathematical foundation with projected gated convolutions for extracting both local and global sequence features, Lyra achieves SOTA performance across diverse biological challenges while using significantly fewer parameters than established models. Lyra achieves comparable or superior performance on most tasks, training from scratch with just one or two GPUs and completing both training and task execution in minutes to hours, a stark contrast to current models that require massive computational infrastructure and weeks of training time [8,16,28].

The success of a simple, mathematically-principled architecture in outperforming both large foundation models and structure-aware approaches (like LucaProt-ESM with ESMfold embeddings) challenges current trends in computational biology[9,27,28,97]. While large language models trained on billions of sequences have demonstrated remarkable capabilities, Lyra shows that architectural innovations informed by the underlying mathematics of biological phenomena can achieve superior results with orders of magnitude less computation. This suggests that understanding and encoding domain-specific mathematical structures may be more valuable than increasing model scale.

Lyra's performance and efficiency across diverse tasks, from protein fitness landscapes to RNA splicing, demonstrates the broad applicability of polynomial approximation in biological sequence analysis. The architecture excels particularly in capturing non-linear interactions in protein fitness landscapes, predicting complex CRISPR guide-target interactions, and modeling RNA structural features. These capabilities point to immediate applications in therapeutic development and pathogen surveillance. Specifically, the model's efficiency in capturing sequence-to-function relationships could accelerate the design of cell-penetrating peptides for drug delivery, optimize viral vehicles for targeted gene therapy, predict solubility of biologic drug candidates, and enable rapid detection of viral threats through efficient viral protein identification. Beyond therapeutics and surveillance, Lyra could enhance biomanufacturing through improved discovery and optimization of catalytic enzymes. The model's computational efficiency makes rapid iteration on these applications feasible even with limited computational resources, potentially accelerating the development pipeline from sequence design to experimental validation.

Lyra challenges the prevailing trend towards increasingly larger models in biological sequence analysis, achieving SOTA performance while democratizing access to researchers without requiring specialized computing infrastructure. By understanding and encoding the mathematical principles underlying biological phenomena—in this case, the polynomial nature of epistatic interactions—Applicants achieve dramatically more efficient solutions. Looking forward, the connection between SSMs and polynomial approximations, as demonstrated in Lyra, may have far-reaching implications beyond biological sequences, offering a promising approach for domains where complex interactions follow polynomial-like behavior.

### Methods and Materials

### Lyra Architecture

Lyra comprises two core components: the Projected Gated Convolution (PGC) block[40], followed by a state-space layer with depth-wise convolution (S4D). In the standard implementation, which consists of approximately 55,000 parameters, Lyra includes two PGC blocks. The first PGC block operates with a hidden dimension of 16, while the second uses a hidden dimension of 128. These are followed by an S4D layer[37], which has a hidden dimension of 64 and is equipped with a residual connection and sequence pre-normalization using Root Mean Square Layer Normalization (RMSNorm). The PGC blocks are designed to capture contextualized local dependencies in the input sequence, while the S4D layer parameterizes a long convolution to model long-range dependencies.

### Projected Gated Convolution (PGC)

The PGC is the first stage of the model, designed to process biological sequences and extract both local and global features. Each layer begins by linearly projecting the input sequence, reducing or expanding its feature dimensionality to an intermediate size. This projection is followed by Root Mean Square Layer Normalization (RMSNorm[98]), which enhances the representation by emphasizing global context. The transformed sequence is then processed through two parallel pathways: one applies a depth-wise 1D convolution to extract local dependencies, while the other uses a linear projection to model global relationships. These two outputs are combined using element-wise multiplication, enabling the integration of local and global information. Finally, the combined features are projected back to the original feature dimensionality and normalized again with RMSNorm. This process allows the module to capture complex patterns and dependencies in the input sequence, making it well-suited for modeling biological data.

### S4D

The S4D model leverages diagonal state space models (SSMs) to parameterize and compute convolution kernels for sequence modeling. The kernel, which captures dependencies across the sequence, is parameterized through three core matrices: A, B, and C. The matrix A governs the dynamics of the system, encoding exponential decay and oscillatory behavior, while B maps the input into the state space, and C projects the state back into the output space. The convolution kernel is computed efficiently using the Vandermonde matrix[99], which organizes the contributions of A, B, and C into a structure that allows for efficient evaluation of the kernel as a sum of weighted exponential terms. Importantly, the state matrix A is initialized to reflect the Legendre polynomials, which provide an orthogonal basis for approximating polynomials up to the degree of the state size. This initialization enables the SSM to decompose input signals into well-conditioned and expressive basis functions, capturing long-range dependencies.

### Biological Datasets

### Intrinsically Disordered Protein Tasks

For predicting intrinsically disordered regions (IDRs), Applicants utilized the comprehensive dataset from [41], which contains 925 protein sequences with experimentally validated disorder annotations. The dataset was split by Peng et al into training (589 sequences), validation (148 sequences), and test (188 sequences) sets using CD-HIT clustering[100] with 25% sequence similarity threshold. The input sequences were one-hot encoded and the model was trained to predict six different types of disorder functions: protein-binding, DNA-binding, RNA-binding, ion-binding, lipid-binding, and flexible linker regions. Training was conducted for 30 epochs using AdamW optimizer with a learning rate of 0.001 and weight decay of 0.01. Performance was evaluated using multiple metrics including AUC-ROC, Matthews correlation coefficient (MCC), and balanced accuracy (BACC).

### DMS Tasks

Lyra was evaluated on deep mutational scanning (DMS) tasks using datasets from ProteinGym[49], originally curated in [45]. The datasets cover diverse mutational landscapes, including enzyme activity, RNA-binding, and fluorescent protein function. Applicants retained ProteinGym's train-test splits. Lyra was trained for 100 epochs using AdamW (learning rate 0.001, weight decay 0.01) and evaluated using Spearman's rank correlation to compare predicted and experimental fitness scores. Results were benchmarked against ProteinGym baselines.

### RDRP Tasks

The RNA-dependent RNA polymerase (RDRP) detection task utilized the dataset from [50], focusing on identifying RDRP sequences from amino acid inputs. This binary classification task involved classifying whether a particular input amino acid sequence represents an RDRP. The dataset was used as split by [50] intro training/validation/test splits, with 5,979 total positive viral RDRP sequences and 150,000 sequences sampling from negative samples. Training was performed for 100 epochs using the AdamW optimizer with a learning rate of 0.001 and weight decay of 0.01. Model performance was evaluated primarily using the true positive rate metric to enable direct comparison with the LucaProt baseline, alongside standard binary classification metrics including accuracy and AUC-ROC.

### ReLSO Tasks

For the protein fitness prediction tasks, Lyra was trained across three fitness prediction datasets GB1[101], Gifford[102], and GFP[103]. Each dataset contained amino acid sequences of the same length which were one-hot-encoded, input dimension of 20, with the stability and affinity, enrichment, or fluorescence values serving as regression labels. The train/test split was as given from the source datafiles in the ReLSO github repository. The training was performed for 100 epochs, utilizing the AdamW optimizer with a learning rate of 0.001 and a weight decay of 0.01. The evaluation metric was Spearman's rank correlation coefficient on the validation set, and Mean Squared Error Loss (MSELoss) was used as the loss function.

### Cell-Penetrating Peptides Efficacy

Applicants evaluated performance on cell-penetrating peptide (CPP) efficacy prediction using the dataset from [52], which contains 640 sequences with experimentally validated cell penetration abilities. The models were trained for 100 epochs with a random 80/20 train/test split as conducted by the source paper, and utilizing AdamW optimization with a learning rate of 0.001 and weight decay of 0.01. CPP efficacy was assessed using regression metrics including Spearman's correlation coefficient and MSE loss.

### RNA Tasks (BEACON)

For standard benchmarking in RNA tasks, Applicants utilized datasets provided in the BEACON dataset by [78]. For all tasks, Applicants used the same metric (F1 score, R², accuracy, ACC, AUC, or Spearman's) as in the BEACON manuscript to compare Lyra performance with the models tested in BEACON.

### Secondary Structure Prediction

For secondary structure prediction, Applicants utilized the bpRNA dataset[104], which provides detailed annotations of 13,419 RNA structures. Each RNA sequence is associated with a target string y∈RL, indicating nucleotide pair information as part of the secondary structure. The data was split into train, validation, and test set using the provided split from the BEACON repository. The Lyra internal model dimension was 72, with two consecutive PGC layers with dimensions 18 and 144, respectively. The training protocol involved 100 epochs using the AdamW[105] optimizer with a learning rate of 0.001 and weight decay of 0.01. The task was evaluated in the RNA Beacon using the F1 score.

### Structural Score Imputation

The icSHAPE HEK293 dataset[106] was used for structural score imputation, containing experimentally derived RNA structural scores. The dataset consists of 14,049 training, 1,756 validation, and 3,095 test fragments. The Lyra internal model dimension was 64, with two consecutive PGC layers with dimensions 16 and 128, respectively. The training protocol involved 100 epochs using the AdamW optimizer with a learning rate of 0.001 and weight decay of 0.01. The task was evaluated in the RNA Beacon paper using the R² metric, quantifying the accuracy of imputed scores.

### Splice Site Prediction

For splice site classification, Applicants employed the SpliceAI dataset[107] containing 144,628 training, 18,078 validation, and 16,505 test sequences. Each nucleotide was labeled as an acceptor (a), donor (d), or neither (n), with predictions evaluated using T op-k accuracy. The Lyra internal model dimension was 72, with two consecutive PGC layers with dimensions 18 and 144, respectively. The training protocol involved 100 epochs using the AdamW optimizer with a learning rate of 0.001 and weight decay of 0.01. The task was evaluated in the RNA Beacon paper using the F1 score.

### APA Isoform Prediction

For APA isoform prediction, Applicants employed the APARENT dataset[108] containing 145,463 training, 33,170 validation, and 49,755 test sequences. Each sequence was labeled with the usage ratio of the proximal polyadenylation site (PAS) in the 3′ untranslated region (3′ UTR), recorded as y∈R. The Lyra internal model dimension was 64, with two consecutive PGC layers with dimensions 16 and 128, respectively. The training protocol involved 100 epochs using the AdamW optimizer with a learning rate of 0.001 and weight decay of 0.01. The task was evaluated in the RNA BEACON paper using the R² metric.

### Noncoding RNA Classification

For noncoding RNA classification, Applicants employed the Noorul's dataset[109] containing 5,679 training, 650 validation, and 2,400 test sequences. Each sequence was categorized into one of thirteen labels, including microRNAs (miRNAs), long noncoding RNAs (lncRNAs), and small interfering RNAs (siRNAs), with labels y∈{0, 1, . . . , 12}. The Lyra internal model dimension was 72, with two consecutive PGC layers with dimensions 18 and 144, respectively. The training protocol involved 100 epochs using the AdamW optimizer with a learning rate of 0.001 and weight decay of 0.01. The task was evaluated in the RNA BEACON paper using the accuracy metric.

### RNA Modification Prediction

For RNA modification prediction, Applicants employed the MultiRM dataset[110] containing 304,661 training, 3,599 validation, and 1,200 test sequences. Each nucleotide was labeled with one of 12 different modification types, with labels y∈{0, 1, . . . , 11}. The Lyra internal model dimension was 72, with two consecutive PGC layers with dimensions 18 and 144, respectively. The training protocol involved 100 epochs using the AdamW optimizer with a learning rate of 0.001 and weight decay of 0.01. The task was evaluated in the RNA BEACON paper using the AUC metric.

### Mean Ribosome Loading Prediction

For mean ribosome loading prediction, Applicants employed the Optimus dataset[111] containing 76,319 training, 7,600 validation, and 7,600 test sequences. Each sequence was labeled with an MRL value y∈R, representing the level of mRNA translation activity into proteins. The internal model dimension was 64, with two consecutive PGC layers with dimensions 16 and 128, respectively. The training protocol involved 100 epochs using the AdamW optimizer with a learning rate of 0.001 and weight decay of 0.01. The task was evaluated in the RNA BEACON paper using the R² metric.

### Programmable RNA Switch Prediction

For programmable RNA switch prediction, Applicants employed the Angenent-Mari dataset[112] containing 73,227 training, 9,153 validation, and 9,154 test sequences. Each sequence was labeled with ON, OFF, and ON/OFF activity states, recorded as y∈R³. The internal model dimension was 72, with two consecutive PGC layers with dimensions 18 and 144, respectively. The training protocol involved 100 epochs using the AdamW optimizer with a learning rate of 0.001 and weight decay of 0.01. The task was evaluated in the RNA BEACON paper using the R² metric.

### CRISPR Off-Target Rate Prediction

For CRISPR off-target prediction, Applicants employed the DeepCRISPR dataset[113] containing 14,223 training, 2,032 validation, and 4,064 test sequences. Each sequence was labeled with an off-target frequency score y∈R, quantifying CRISPR-induced mutations at unintended genomic locations. The internal model dimension was 62, with two consecutive PGC layers with dimensions 16 and 128, respectively. The training protocol involved 100 epochs using the AdamW optimizer with a learning rate of 0.001 and weight decay of 0.01. The task was evaluated in the RNA BEACON paper using the weighted Spearman correlation.

### CRISPR Cas13a (ADAPT)

For the CRISPR Cas13 dataset[79], Applicants encoded guide-target pairs using a one-hot 25encoding scheme with a dimensionality of 4 for each guide and target. These were then concatenated to form a stacked representation with an 8-dimensional one-hot-encoded vector for sequences of 48 base pairs. The log fluorescence threshold to distinguish active from non-active pairs was set at a value of −4.00 in the original ADAPT paper. The model underwent 5-fold cross-validation across three distinct tasks. In the first task, binary classification of guide-target pairs was performed, assessing the model's performance through AUC-ROC and AUPR metrics, with each fold being trained for 75 epochs. The following two tasks involved regression analyses: the first was a positive-only regression targeting values above the activity threshold, and the second encompassed a comprehensive regression across all guide-target pairs, both positive and negative. Both regression tasks were evaluated using Spearman's coefficient, following the same 75-epoch, 5-fold cross-validation structure.

### CRISPR Cas9

Applicants utilized eight CRISPR Cas9 datasets—Kim2019[91], Doench2014 mouse[92], Doench2014 human[92], Doench2016[86], Wang2014[88], and Munoz2016[90], Aguierre2016[93], and Behan2019[89]—comprising guide-target activity information. Each sequence was one-hot encoded to capture the nucleotide arrangement intricately. For the purposes of model training and validation, Applicants adhered to a 5-fold cross-validation procedure, meticulously applied to both training and test sets. Each fold was trained for 150 epochs of training, and evaluated using Spearman's correlation for regression enzymatic activity based on a sequence.

### Promoter Tasks

The promoter strength prediction task utilized the dataset from[114], which consists of 3,665 synthetic modifications of the Ptrc promoter, engineered and characterized through iterative mutation-construction-screening cycles. This regression task aimed to predict promoter strength based on sequence inputs, with fluorescence/OD600 measurements serving as the target variable. The dataset was randomly split into a training set (90%) and a test set (10%). A small Lyra model was used, with internal model dimension 64 and PGC layers with dimension 16, and 64, totaling 54,145 parameters. Training was conducted for 100 epochs using AdamW optimizer with a learning rate of 0.001 and weight decay of 0.01. Performance was evaluated using multiple metrics including AUC-ROC, Matthews correlation coefficient (MCC), and balanced accuracy (BACC).

### Architecture Comparison Studies

To evaluate Lyra's performance against similarly-sized, non-task-specialized architectures—including long convolutional and Transformer models—Applicants conducted direct comparisons with Hyena-based [39] and Transformer++-based [31] models in side-by-side studies.

### Hyena

The Hyena architecture combines short depth-wise convolutions and linear projections, which are gated together with a long convolution. Unlike S4D, which uses state space models (SSMs) to parameterize input-dependent long convolution kernels, Hyena[39] employs a multi-layer perceptron (MLP[115]) with positional encoding.

### Transformer

The baseline is an optimized transformer recipe called Transformer++ [31], which is a Transformer model configured with rotary position embeddings (RoPE)[116], pre-normalization using root mean square layer normalization (RMSNorm), and SwiGLU[117] for dimensional mixing. In this setup, the hidden dimension of SwiGLU is four times the model width, providing the necessary capacity for feature extraction.

### Epistatic Transformer GFP Tasks

In this study, Applicants conducted a head-to-head comparison of similarly sized transformer models and Lyra to evaluate their capacity for modeling epistatic interactions. Applicants focused on six GFP tasks[72] identified by [73] as being highly influenced by epistatic interactions. The datasets included different GFP variants and varied in size, sequence length, and median Hamming distance, and included preset train/test splits. Transformer and Lyra models were trained for 50 epochs, utilizing the AdamW optimizer with a learning rate of 0.001 and a weight decay of 0.01. The primary evaluation metric was R², computed for each dataset.

### Nucleotide Transformer Tasks

Applicants evaluated the model across 14 genomic prediction tasks from [23], selected to assess its ability to generalize across key regulatory and chromatin-related functions. These tasks included promoter prediction (promoter_all, promoter_tata, promoter_no_tata), enhancer prediction (enhancers), and histone modification state classification across multiple chromatin marks (H2AFZ, H3K27ac, H3K27me3, H3K36me3, H3K4me1, H3K4me2, H3K4me3, H3K9ac, H3K9me3, H4K20me1). Hyena, Transformer++, and Lyra models were trained for 50 epochs across all tasks, ensuring robust evaluation on the nucleotide transformer downstream tasks benchmark. The dataset's diversity in sequence lengths, ranging from 300 bp to 1,000 bp.

### Genomics Benchmarks

Applicants evaluated the model using the Genomics Benchmark dataset, a curated collection of publicly available genomic classification tasks designed for benchmarking deep learning models. Applicants selected nine tasks spanning key functional genomics challenges, including sequence classification (Coding vs Intergenic, Human vs Worm), enhancer and promoter prediction (Human Enhancers (Ensembl), Human OCR, Human Enhancers (Cohn), Drosophila Enhancers, Non-TATA Promoters, Mouse Enhancers), and regulatory element classification (Human (Ensembl Regulatory)). Hyena, Transformer++, and Lyra models were trained for 50 epochs for each dataset, optimizing the model with AdamW, a learning rate of 0.001, and a weight decay of 0.01, under the guidance of cross-entropy loss. Applicants evaluated each dataset on top-1% accuracy metric for each dataset.

### Synthetic Tasks

### Selective Copying

The Selective Copying task, a variation of the Copying task, is designed to evaluate content-aware reasoning[31]. In this task, models are required to memorize specific tokens while ignoring irrelevant ones. Applicants adapt it with a biologically inspired focus: the tokens to be predicted are amino acids mutated in Green Fluorescent Protein (GFP) sequences, featuring between 1 and 14 mutations with hamming distances between 1 and 28. The task was evaluated on sequences of lengths ranging from 64 to 1024. All models—Lyra, PGC-only, and Hyena—were tested using a hidden state size of 64 and trained for 400,000 steps at each sequence length.

### APPENDIX—MATHEMATICAL DERIVATIONS

### 1 Formalizing Biological Sequence Modeling

Biological macromolecules can be viewed as discrete sequences over a finite alphabet. In the case of proteins, this alphabet typically consists of 20 symbols, each representing an amino acid. Concretely, given a protein sequence, can that sequence “scores” on a specific trait be predicted? Formally, let Σ be an alphabet with |Σ|=20. Consider sequences

$$x = ( {x}_{1} , {x}_{2} , … , {x}_{d} ) where {x}_{i} ∈ \sum for i = 1 , 2 , … d .$$

Then define a real-valued function

$$f : {\sum }^{d} \to ℝ ,$$

which, for a given protein sequence x, returns some measured or predicted property such as fluorescence, solubility, or fitness. The essential problem is to learn or approximate ƒ efficiently from a set of experimentally measured sequence-property pairs, despite the potentially large combinatorial space of possible amino acid configurations. A further practical challenge in this learning task is that biological datasets are often comparatively small, limiting the applicability of standard large-scale language-modeling approaches. Instead, more specialized, data-efficient methods are needed to capture the relevant sequence-function relationships when only a limited number of labeled variants are available.

A central complication in modeling these sequence-to-function relationships arises from the fact that real proteins often exhibit dependencies that cannot be captured by simple additive models. Specifically, a mutation at one position may have a different effect depending on the amino acids present at other positions. This phenomenon, known as epistasis, implies that the contribution of a particular mutation depends on context, which significantly increases the complexity of learning ƒ. An effective way to formalize and analyze such context-dependent effects is to represent ƒ as a multivariate polynomial in encoded variables u=(u₁, u₂, . . . , u_{N}), where each uᵢ encodes the state of residue i. Then write

$$f ( u ) = {\sum }_{k = 1}^{K} {\sum }_{1 \leq {i}_{1} < {i}_{2} < ⋯ < {i}_{k} \leq N} {c}_{{i}_{1} {i}_{2} ⋯ {i}_{k}} {u}_{{i}_{1}} , {u}_{{i}_{2}} ⋯ {u}_{{i}_{k}} ,$$

with coefficients cᵢ_{₁}ᵢ_{₂}_{, . . . ik} _{_{R}}∈ [symbol] capturing how each subset of residues jointly influences the functional property. When k=1, the polynomial accounts for single-position effects; when k=2, pairwise epistasis enters; and so on. Higher-order terms appear whenever three or more positions collectively modulate function in a way that cannot be reduced to lower-order combinations. From the biological perspective, these polynomial expansions provide a powerful lens for characterizing the underlying fitness landscape—be it protein fluorescence, RNA structure, or CRISPR enzymatic activity—by explicitly capturing the combinatorial interplay among residues.

Because the number of possible interaction terms can grow rapidly with sequence length, an essential aspect of this framework is discovering and approximating these polynomial coefficients in a manner that balances expressiveness with data efficiency. Enumerating all possible subsets of positions becomes infeasible for larger proteins, yet overlooking important interactions degrades predictive accuracy. The practical objective is therefore to uncover the subset of polynomial terms that meaningfully contribute to function without requiring exhaustive measurements of every possible variant. Achieving this objective allows modelling of highly nonlinear, context-dependent relationships while remaining tractable in data-constrained regimes. In so doing, the polynomial perspective provides a principled way to think about how multiple amino acids coordinate to yield a given functional outcome, illuminating why purely additive approaches often fail to capture the richness of biological epistasis and highlighting the need for models that can handle sparse, high-dimensional data effectively.

By casting protein sequence-function prediction as the problem of inferring the coefficients in a (potentially high-order) polynomial expansion, a mathematically transparent representation of how individual residues and their interactions contribute to a measured trait is obtained. This representation encodes the combinatorial complexity of biological macromolecules, offering insight into which residues are critical for function and how they cooperate or interfere with each other in shaping a protein's properties. Crucially, it also accommodates the reality of limited experimental data by providing a guidance toward strategies designed to uncover the most relevant epistatic interactions without demanding prohibitively large datasets.

### 2—Modeling Polynomials Via SSMS

Having established the importance of polynomial-like representations for capturing higher-order epistatic interactions in biological sequences, Applicants now turn to how modem sequence architectures can implement these ideas efficiently. One compelling strategy is to leverage State Space Models (SSMs). SSMs originate in dynamical systems theory and signal processing, where they represent how a hidden state evolves over time in response to an input sequence. Crucially, SSMs yield a convolutional mapping from inputs to outputs, and this property implements polynomial interactions in sub-quadratic time by harnessing the Fast Fourier Transform (FFT).

Concretely, a standard discrete-time SSM can be written as

$${x}_{t + 1} = A {x}_{t} + B {u}_{i} , {y}_{t} = C {x}_{t} ,$$

where xₜ∈ [symbol] ^{N} is a hidden state at time t, uₜ∈ [symbol] is the input, and yₜ is the output. The matrix A governs the recurrence for the hidden state, B mixes the input into the state, and C projects the state into the output space. By unrolling this recurrence, one sees that the output y depends on the input u via a convolution kernel whose l-th element is CA^{l}B. Consequently, the mapping from u to y is given by:

$${y}_{t} {\sum }_{ℓ = 0}^{t} C {A}^{t - ℓ} B {u}_{ℓ} ,$$

which precisely defines a discrete convolution of the sequence {uₗ} with the kernel {CA^{l}B}. In practice, this convolution can be computed efficiently by FFT-based methods, exploiting the well-known fact that multiplying in the frequency domain corresponds to convolving in the time domain.

To see how SSMs capture the polynomial perspective more intuitively, it helps to examine the simplest one-dimensional case in continuous time. Suppose

$$\frac{d}{dt} x ( t ) = a x ( t ) + b u ( t ) ,$$

where x(t), a, and bare scalars. Multiplying both sides bye—at (an integrating factor):

$$\frac{d}{dt} ( {e}^{- a t} x ( t ) ) = {e}^{- a t} b u ( t ) ,$$

and integrating from O to t yields

$${e}^{- a t} x ( t ) = {\int }_{0}^{t} {e}^{- a s} b u ( s ) ds .$$

$$Thus ,$$

$$x ( t ) = {\int }_{0}^{t} {e}^{a ( t - s )} b u ( s ) ds ,$$

demonstrating that x(t) is the convolution of u with an exponential kernel. If an output y(t)=cx(t) is introduced, then y(t) is precisely c times that same exponential convolution. This simple derivation shows the direct link between an SSM and convolutional filtering. Moving to discrete time or higher dimensional states follows the same principles; each dimension (or eigen component) of A adds another exponential-like basis function to the overall convolution kernel.

### S4D: Diagonalizing the State Matrix for Efficiency.

A key insight in recent work on SSM-based architectures (such as S4) is that further diagonalizing the matrix A confers substantial computational savings. Suppose A can be written as a diagonal matrix Ã=diag(Ã₀, . . . , Ā_{N-1}) by an appropriate change of basis, so that

$${\overline{A}}^{ℓ} = diag ( {( {\overline{A}}_{0} )}^{ℓ} , … , {( {\overline{A}}_{N - 1} )}^{ℓ} ) .$$

Then the l-th element of the kernel becomes

$${\overline{K}}_{ℓ} = C {\overline{A}}^{ℓ} \overline{B} = {\sum }_{n = 0}^{N - 1} {{C}_{n} ( {\overline{A}}_{n} )}^{ℓ} {B}_{n} .$$

Stacking Kₗ for l=0, . . . , L−1 exposes a Vandermonde structure. Specifically,

$$\overline{K} = [ {C}_{0} {B}_{0} , … , {C}_{N - 1} {B}_{N - 1} ] \times [ \begin{matrix}1 & {\overline{A}}_{0} & {\overline{A}}_{0}^{2} & … & {\overline{A}}_{0}^{L - 1} \\ 1 & {\overline{A}}_{1} & {\overline{A}}_{1}^{2} & … & {\overline{A}}_{1}^{L - 1} \\ ⋮ & ⋮ & ⋮ & ⋱ & ⋮ \\ 1 & {\overline{A}}_{N - 1} & {\overline{A}}_{N - 1}^{2} & … & {\overline{A}}_{N - 1}^{L - 1}\end{matrix} ] .$$

Vandermonde matrices are intimately tied to polynomials, since each row corresponds to evaluating the monomials {1, z, z², . . . , z^{L-1}} at the point z=Ān. There are well-studied algorithms for multiplying by a Vandermonde matrix in nearly linear time Õ(N+L) rather than Õ(NL). Thus, diagonalizing A reduces the complexity of forming and applying the kernel and paves the way for fast FFT convolution—the actual operation on the input sequence {uₗ} then becomes a frequency-domain multiplication, ensuring a sub-quadratic runtime.

From a polynomial perspective, this process can be viewed as learning a set of basis polynomials—each diagonal element Āₙ corresponds to a complex exponential (or exponential modulated by frequency), and the convolution kernel is a linear combination of these basis functions. Multiplying in the frequency domain is equivalent to convolving the time-domain sequence with that linear com-bination, which naturally encodes higher-order interactions in a compact form. This resonates with the earlier discussion that convolving polynomials is equivalent to multiplying them; here, the SSM implements exactly this principle with efficient FFf-based methods.

By diagonalizing A, a framework (S4D) is obtained that is both expressive enough to capture the intricate, polynomial-like interactions in biological sequences and computationally efficient enough to handle longer sequence lengths. Each diagonal component can be trained to focus on a particular “frequency” or decay mode, and the sum of these modes captures complex epistatic relationships without incurring high memory or time costs. In this way, diagonal state space models provide a principled approach to learning the mapping from protein sequences to real-valued functions (fitness, stability, enzymatic rates, and so on) under the polynomial lens, but executed at scale through FFf convolution and Vandermonde-based kernel construction.

### 3—Projected Gated Convolutions

Having established how S4D handles long-range dependencies through fast state space kernels, a complementary mechanism is introduced for local gating: depth-wise JD convolutions combined with an element-wise (Hadamard) product. While S4D specializes in capturing global structure, many architectures rely on gating to modulate signal flow at a more granular level. Specifically, before the S4D layers, a local convolutional block that gates or filters features is placed through a simple multiplication in each channel.

Depth-wise convolution operates on an input u∈ [symbol] R^{l×d}, where l denotes the sequence length and d is the number of channels. For a kernel size k=3 (with padding 1), the depth-wise convolution applies a separate filter to each channel c. Denoting the convolution weights by W_{conv}∈ [symbol] ^{k×d}, the output at position i and channel c is given by

$${u}_{conv} [ i , c ] = {\sum }_{j = - 1}^{1} {W}_{conv} [ j + 1 , c ] u [ i + j , c ] .$$

Because each channel c has its own slice of W_{conv}, this operation captures local patterns (e.g., 3-mer motifs in proteins) in a channel-specific manner, with no mixing between different channels at this stage. As a result, depth-wise convolution focuses on extracting local features in each dimension while remaining parameter-efficient compared to a full convolution.

To incorporate global channel interactions at each position, a position-wise linear layer Wₗᵢₙ∈ [symbol] ^{R×d} and bias bₗᵢₙ∈ [symbol] ^{d} is applied. For each position i and channel c,

$${u}_{lin} [ i , c ] = {\sum }_{{c}^{′} = 1}^{d} {W}_{lin} [ c , {c}^{′} ] u [ i , {c}^{′} ] + {b}_{lin} [ c ] .$$

Unlike the convolution step, which aggregates nearby positions within the same channel, this linear transformation does not look at neighboring indices i±1; instead, it mixes features across all channels c′ at the same position i. In a biological context, this step can learn how different channel encodings (e.g., properties of amino acids, or hidden representation dimensions) should be combined or reweighted based on the broader embedding at that position.

Combining these two outputs through a Hadamard product (elementwise multiplication) yields a gating mechanism. Concretely, the final output is defined by

$${u}_{out} [ i , c ] = {u}_{conv} [ i , c ] \cdot {u}_{lin} [ i , c ] .$$

Substituting the definitions of u_{conv} and uₗᵢₙ into this product exposes how second-order interactions arise. Specifically,

$${u}_{out} [ i , c ] = ( {\sum }_{j = - 1}^{1} {W}_{conv} [ j + 1 , c ] u [ i + j , c ] ) \times ( {\sum }_{{c}^{′} = 1}^{d} {W}_{lin} [ c , {c}^{′} ] u [ i , {c}^{′} ] + {b}_{lin} [ c ] ) .$$

Expanding this product shows that local features u[i+j, c] (extracted by depth-wise convolution) multiply with channel-mixed features u[i, c′] (from the linear layer) at the same position i. The cross-terms,

$${\sum }_{j = - 1}^{1} {\sum }_{{c}^{′} = 1}^{d} {W}_{conv} [ j + 1 , c ] {W}_{lin} [ c , {c}^{′} ] u [ i + j , c ] u [ i , {c}^{′} ] ,$$

are an explicit second-order interaction between u[i+j, c] and u[i, c′]. In epistatic terms, a residue (or embedding feature) at position i+j interacts multiplicatively with features at the same position i but different channel c′. This captures context-dependent local patterns: whether a motif at position i+j influences the output depends on how the channels at position i are activated, and vice versa. Stacking multiple such layers in sequence enables even richer, higher-order interactions because each subsequent layer's input can include products of features formed at earlier layers. Hence, by combining a depth-wise convolution for local context, a linear transformation for channel mixing, and a Hadamard product for gating, a module is constructed that models second-order epistatic effects in a compact, parameter-efficient manner and allows for further compositional complexity in deeper architectures.

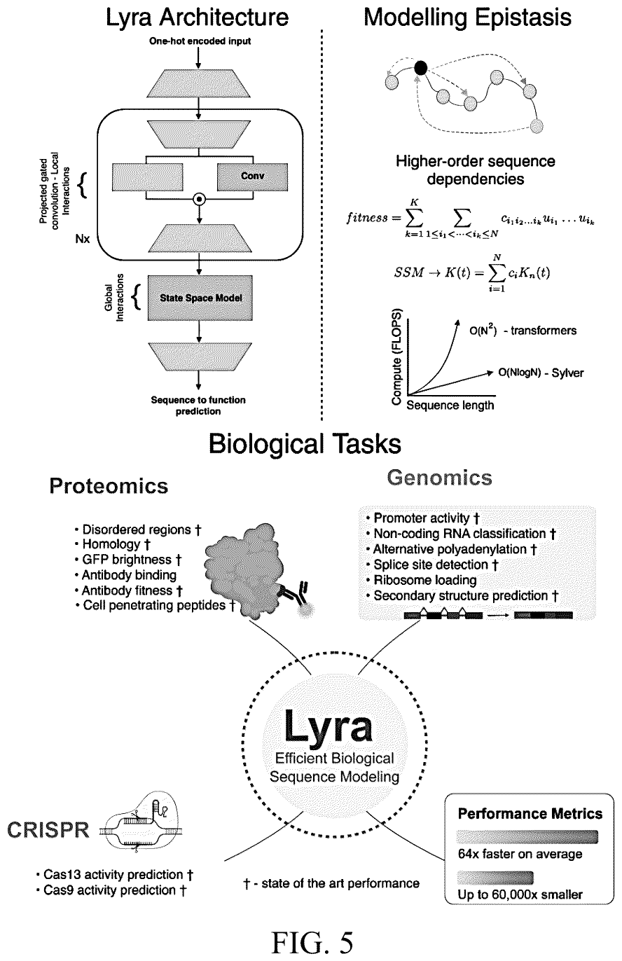

### REFERENCES FOR EXAMPLE 2 AND FIGS. 5-9

1. Jumper J, Evans R, Pritzel A, Green T, Figurnov M, Ronneberger O, et al. Highly accurate protein structure prediction with AlphaFold. Nature. 2021; 596:583-589.
2. Avsec Ž, Agarwal V, Visentin D, Ledsam J R, Grabska-Barwinska A, Taylor K R, et al. Effective gene expression prediction from sequence by integrating long-range interactions. Nat Methods. 2021; 18:1196-1203.
3. Valeri J A, Collins K M, Ramesh P, Alcantar M A, Lepe B A, Lu T K, et al. Sequence-to-function deep learning frameworks for engineered riboregulators. Nat Commun. 2020; 11:5058.
4. Pancotti C, Benevenuta S, Repetto V, Birolo G, Capriotti E, Sanavia T, et al. A deep-learning sequence-based method to predict protein stability changes upon genetic variations. Genes (Basel). 2021; 12:911.
5. Sasse A, Chikina M, Mostafavi S. Unlocking gene regulation with sequence-to-function models. Nat Methods. 2024; 21:1374-1377.
6 Freschlin C R, Fahlberg S A, Heinzelman P, Romero P A. Neural network extrapolation to distant regions of the protein fitness landscape. Nat Commun. 2024; 15:6405.
7. Alley E C, Khimulya G, Biswas S, AlQuraishi M, Church G M. Unified rational protein engineering with sequence-based deep representation learning. Nat Methods. 2019; 16:1315-1322.
8. Nguyen E, Poli M, Durrant M G, Kang B, Katrekar D, Li D B, et al. Sequence modeling and design from molecular to genome scale with Evo. Science. 2024; 386. doi:10.1126/science.ado9336
9. Rives A, Meier J, Sercu T, Goyal S, Lin Z, Liu J, et al. Biological structure and function emerge from scaling unsupervised learning to 250 million protein sequences. Proc Natl Acad Sci USA. 2021; 118: e2016239118.
10. Wang X, Li F, Zhang Y, Imoto S, Shen H-H, Li S, et al. Deep learning approaches for non-coding genetic variant effect prediction: current progress and future prospects. Brief Bioinform. 2024; 25. doi: 10.1093/bib/bbae446
11. Hussain A, Brooks C L Iii. Guiding discovery of protein sequence-structure-function modeling. Bioinformatics. 2024; 40. doi: 10.1093/bioinformatics/btae002
12. He Y, Shen Z, Zhang Q, Wang S, Huang D-S. A survey on deep learning in DNA/RNA motif mining. Brief Bioinform. 2021; 22. doi: 10.1093/bib/bbaa229
13. LaFleur T L, Hossain A, Salis H M. Automated model-predictive design of synthetic promoters to control transcriptional profiles in bacteria. Nat Commun. 2022; 13:5159.
14. Yang Y, Li G, Pang K, Cao W, Li X, Zhang Z. Deciphering 3′ UTR mediated gene regulation using interpretable deep representation learning. bioRxiv. 2023. doi: 10.1101/2023.09.08.556883
15. Senior A W, Evans R, Jumper J, Kirkpatrick J, Sifre L, Green T, et al. Improved protein structure prediction using potentials from deep learning. Nature. 2020; 577:706-710.
16. Lin Z, Akin H, Rao R, Hie B, Zhu Z, Lu W, et al. Evolutionary-scale prediction of atomic-level protein structure with a language model. Science. 2023; 379:1123-1130.
17. Javed N, Weingarten T, Sehanobish A, Roberts A, Dubey A, Choromanski K, et al. A multi-modal transformer for cell type-agnostic regulatory predictions. Cell Genom. 2025; 3018. 19. 20. 21. 22. 23. 24. 25. 26. 27. 28. 29. 30. 100762.
18. Kiranyaz S, Avci O, Abdeljaber O, Ince T, Gabbouj M, Inman D J. 1D convolutional neural networks and applications: A survey. Mech Syst Signal Process. 2021; 151:107398.
19. Xiang X, Corsi G I, Anthon C, Qu K, Pan X, Liang X, et al. Enhancing CRISPR-Cas9 gRNA efficiency prediction by data integration and deep learning. Nat Commun. 2021; 12:3238.
20. Zhou J, Troyanskaya O G. Predicting effects of noncoding variants with deep learning-based sequence model. Nat Methods. 2015; 12:931-934.
21. Vaswani A, Shazeer N M, Parmar N, Uszkoreit J, Jones L, Gomez A N, et al. Attention is All you Need. Adv Neural Inf Process Syst. 2017; 5998-6008.
22. Li Z, Das A, Beardall W A V, Zhao Y, Stan G-B. Genomic Interpreter: A hierarchical genomic deep neural network with 1D shifted window Transformer. arXiv [cs.LG]. 2023. Available: arxiv.org/abs/2306.05143
23. Dalla-Torre H, Gonzalez L, Mendoza-Revilla J, Lopez Carranza N, Grzywaczewski A H, Oteri F, et al. Nucleotide Transformer: building and evaluating robust foundation models for human genomics. Nat Methods. 2025; 22:287-297.
24. Rao R^{M}, Liu J, Verkuil R, Meier J, Canny J, Abbeel P, et al. MSA Transformer. In: Meila M, Zhang T, editors. Proceedings of the 38th International Conference on Machine Learning. PMLR; 18-24 Jul. 2021. pp. 8844-8856.
25. Almotairi S, Badr E, Abdelbaky I, Elhakeem M, Abdul Salam M. Hybrid transformer-CNN model for accurate prediction of peptide hemolytic potential. Sci Rep. 2024; 14:14263.
26. Peng B, Narayanan S, Papadimitriou C. On Limitations of the Transformer Architecture. arXiv [stat.ML]. 2024. Available: arxiv.org/abs/2402.08164
27. Hayes T, Rao R, Akin H, Sofroniew N J, Oktay D, Lin Z, et al. Simulating 500 million years of evolution with a language model. Science. 2025; eads0018.
28. John P S, Lin D, Binder P, Greaves M, Shah V, John J S, et al. BioNeMo Framework: a modular, high-performance library for AI model development in drug discovery. arXiv [cs.LG]. 2024. Available: arxiv.org/abs/2411.10548
29. Choromanski K, Likhosherstov V, Dohan D, Song X, Gane A, Sarlos T, et al. Masked language modeling for proteins via linearly scalable long-context Transformers. arXiv [cs.LG]. 2020. Available: arxiv.org/abs/2006.03555
30. Yao Z, Yao M, Wang C, Li K, Guo J, Xiao Y, et al. GEFormer: A genomic prediction method of genotype-environment interaction in maize by integrating gating mechanism MLP and linear attention mechanism. Mol Plant. 2025. doi: 10.1016/j.molp.2025.01.020
31. Gu A, Dao T. Mamba: Linear-Time Sequence Modeling with Selective State Spaces. arXiv [cs.LG]. 2023. Available: arxiv.org/abs/2312.00752
32. Poelwijk F J, Socolich M, Ranganathan R. Learning the pattern of epistasis linking genotype and phenotype in a protein. Nat Commun. 2019; 10:4213.
33. Faure A J, Lehner B, Miró Pina V, Serrano Colome C, Weghorn D. An extension of the Walsh-Hadamard transform to calculate and model epistasis in genetic landscapes of arbitrary shape and complexity. PLoS Comput Biol. 2024; 20: e1012132.
34. Brookes D H, Aghazadeh A, Listgarten J. On the sparsity of fitness functions and implications for learning. Proc Natl Acad Sci USA. 2022; 119: e2109649118.
35. Zhou J, McCandlish D M. Minimum epistasis interpolation for sequence-function relationships. Nat Commun. 2020; 11:1782.
36. Gu A, Goel K, Re C. Efficiently Modeling Long Sequences with Structured State Spaces. arXiv [cs.LG]. 2021. Available: arxiv.org/abs/2111.00396
37. Gu A, Gupta A, Goel K, Ré C. On the parameterization and initialization of diagonal state space models. Adv Neural Inf Process Syst. 2022; abs/2206.11893. doi: 10.48550/arXiv.2206.11893
38. Parnichkun R N, Massaroli S, Moro A, Smith J T H, Hasani R, Lechner M, et al. State-free inference of state-space models: The transfer function approach. arXiv [cs.LG]. 2024. Available: arxiv.org/abs/2405.06147
39. Poli M, Massaroli S, Nguyen E, Fu D Y, Dao T, Baccus S, et al. Hyena hierarchy: Towards larger convolutional language models. arXiv [cs.LG]. 2023. Available: arxiv.org/abs/2302.10866
40. Arora S, Eyuboglu S, Timalsina A, Johnson I, Poli M, Zou J, et al. Zoology: Measuring and improving recall in efficient language models. arXiv [cs.CL]. 2023. Available: arxiv.org/abs/2312.04927
41. Pang Y, Liu B. DisoFLAG: accurate prediction of protein intrinsic disorder and its functions using graph-based interaction protein language model. BMC Biol. 2024; 22:3.
42. Elnaggar A, Heinzinger M, Dallago C, Rihawi G, Wang Y, Jones L, et al. ProtT rans: Towards cracking the language of life's code through self-supervised deep learning and high performance computing. arXiv [cs.LG]. 2020. Available: arxiv.org/abs/2007.06225
43. Brandes N, Ofer D, Peleg Y, Rappoport N, Linial M. ProteinBERT: a universal deep-learning 3244. 45. 46. 47. 48. 49. 50. 51. 52. 53. 54. model of protein sequence and function. Bioinformatics. 2022; 38:2102-2110.
44. Notin P, Kollasch A W, Ritter D, van Niekerk L, Paul S, Spinner H, et al. ProteinGym: Large-scale benchmarks for protein design and fitness prediction. bioRxivorg. 2023. doi: 10.1101/2023.12.07.570727
45. Hsu C, Nisonoff H, Fannjiang C, Listgarten J. Learning protein fitness models from evolutionary and assay-labeled data. Nat Biotechnol. 2022; 40:1114-1122.
46. Meier J, Rao R, Verkuil R, Liu J, Sercu T, Rives A. Language models enable zero-shot prediction of the effects of mutations on protein function. In: Ranzato M, Beygelzimer A, Dauphin Y, Liang P S, Vaughan J W, editors. Advances in Neural Information Processing Systems. Curran Associates, Inc.; 2021. pp. 29287-29303.
47. Notin P, Weitzman R, Marks D, Gal Y. ProteinNPT: Improving Protein Property Prediction and Design with Non-Parametric Transformers. In: Oh A, Naumann T, Globerson A, Saenko K, Hardt M, Levine S, editors. Advances in Neural Information Processing Systems. Curran Associates, Inc.; 2023. pp. 33529-33563.
48. Notin P, Van Niekerk L, Kollasch A W, Ritter D, Gal Y, Marks D S. TranceptEVE: Combining family-specific and family-agnostic models of protein sequences for improved fitness prediction. bioRxiv. 2022. doi: 10.1101/2022.12.07.519495
49. Notin P, Dias M, Frazer J, Marchena-Hurtado J, Gomez A N, Marks D, et al. Tranception: Protein Fitness Prediction with Autoregressive Transformers and Inference-time Retrieval. In: Chaudhuri K, Jegelka S, Song L, Szepesvari C, Niu G, Sabato S, editors. Proceedings of the 39th International Conference on Machine Learning. PMLR; 17-23 Jul. 2022. pp. 16990-17017.
50. Hou X, He Y, Fang P, Mei S-Q, Xu Z, Wu W-C, et al. Using artificial intelligence to document the hidden RNA virosphere. Cell. 2024; 187:6929-6942.e16.
51. Castro E, Godavarthi A, Rubinfien J, Givechian K, Bhaskar D, Krishnaswamy S. Transformer-based protein generation with regularized latent space optimization. Nat Mach Intell. 2022; 4:840-851.
52. Schissel C K, Mohapatra S, Wolfe J M, Fadzen C M, Bellovoda K, Wu C-L, et al. Deep learning to design nuclear-targeting abiotic miniproteins. Nat Chem. 2021; 13:992-1000.
53. Aghazadeh A, Nisonoff H, Ocal O, Brookes D H, Huang Y, Koyluoglu O O, et al. Epistatic Net allows the sparse spectral regularization of deep neural networks for inferring fitness functions. Nat Commun. 2021; 12:5225.
54. Hopf T A, Ingraham J B, Poelwijk F J, Schärfe CPI, Springer M, Sander C, et al. Mutation effects predicted from sequence co-variation. Nat Biotechnol. 2017; 35:128-135.
55. Olsen T H, Moal I H, Deane C M. AbLang: an antibody language model for completing antibody sequences. Bioinform Adv. 2022; 2: vbac046.
56. Peng B, Quesnelle J, Fan H, Shippole E. YaRN: Efficient context window extension of large language models. arXiv [cs.CL]. 2023. Available: arxiv.org/abs/2309.00071
57. Trivedi R, Nagarajaram H A. Intrinsically disordered proteins: An overview. Int J Mol Sci. 2022; 23:14050.
58. Holehouse A S, Kragelund B B. The molecular basis for cellular function of intrinsically disordered protein regions. Nat Rev Mol Cell Biol. 2024; 25:187-211.
59. Coskuner-Weber O, Uversky V N. Insights into the molecular mechanisms of Alzheimer's and Parkinson's diseases with molecular simulations: Understanding the roles of artificial and pathological missense mutations in intrinsically disordered proteins related to pathology. Int J Mol Sci. 2018; 19:336.
60. Coskuner O, Uversky V N. Intrinsically disordered proteins in various hypotheses on the pathogenesis of Alzheimer's and Parkinson's diseases. Prog Mol Biol Transl Sci. 2019; 166:145-223.
61. Charon J, Buchmann J P, Sadiq S, Holmes E C. RdRp-scan: A bioinformatic resource to identify and annotate divergent RNA viruses in metagenomic sequence data. Virus Evol. 2022; 8: veac082.
62. Venkataraman S, Prasad B V L S, Selvarajan R. RNA dependent RNA polymerases: Insights from structure, function and evolution. Viruses. 2018; 10. doi: 10.3390/v10020076
63. de Farias S T, Dos Santos Junior A P, Rêgo T G, José M V. Origin and evolution of RNA-dependent RNA polymerase. Front Genet. 2017; 8:125.
64. Wolf Y I, Kazlauskas D, Iranzo J, Lucía-Sanz A, Kuhn J H, Krupovic M, et al. Origins and evolution of the global RNA virome. MBio. 2018; 9. doi: 10.1128/mBio.02329-18
65. Cheng P, Mao C, T ang J, Yang S, Cheng Y, Wang W, et al. Zero-shot prediction of mutation effects with multimodal deep representation learning guides protein engineering. Cell Res. 2024; 34:630-647.
66. Yang K K, Wu Z, Arnold F H. Machine-learning-guided directed evolution for protein engineering. Nat Methods. 2019; 16:687-694.
67. Li M, Kang L, Xiong Y, Wang Y G, Fan G, Tan P, et al. SESNet: sequence-structure feature-integrated deep learning method for data-efficient protein engineering. J Cheminform.
68. Joubbi S, Micheli A, Milazzo P, Maccari G, Ciano G, Cardamone D, et al. Antibody design using deep learning: from sequence and structure design to affinity maturation. Brief Bioinform. 2024; 25. doi: 10.1093/bib/bbae307
69. Hie B L, Shanker V R, Xu D, Bruun T U J, Weidenbacher P A, T ang S, et al. Efficient evolution of human antibodies from general protein language models. Nat Biotechnol. 2024; 42:275-283.
70. Bisarad P, Kelbauskas L, Singh A, Taguchi A T, Trenchevska O, Woodbury N W. Predicting monoclonal antibody binding sequences from a sparse sampling of all possible sequences. Commun Biol. 2024; 7:979.
71. Weinstein J Y, Martí-Gómez C, Lipsh-Sokolik R, Hoch S Y, Liebermann D, Nevo R, et al. Designed active-site library reveals thousands of functional GFP variants. Nat Commun. 2023; 14:2890.
72. Gonzalez Somermeyer L, Fleiss A, Mishin A S, Bozhanova N G, Igolkina A A, Meiler J, et al. Heterogeneity of the GFP fitness landscape and data-driven protein design. Elife. 2022; 11. doi: 10.7554/eLife.75842
73. Sethi P, Zhou J. Importance of higher-order epistasis in large protein sequence-function relationships. Genetics. bioRxiv; 2024. Available: www.biorxiv.org/content/10.1101/2024.09.22.614318v1.full.pdf
74. Gosai S J, Castro R I, Fuentes N, Butts J C, Mouri K, Alasoadura M, et al. Machine-guided design of cell-type-targeting cis-regulatory elements. Nature. 2024; 634:1211-1220.
75. Schoenfelder S, Fraser P. Long-range enhancer-promoter contacts in gene expression control. Nat Rev Genet. 2019; 20:437-455.
76. Hu Y, Horlbeck M A, Zhang R, Ma S, Shrestha R, Kartha V K, et al. Multiscale footprints reveal the organization of cis-regulatory elements. Nature. 2025. doi: 10.1038/s41586-024-08443-4
77. Linder J, Srivastava D, Yuan H, Agarwal V, Kelley D R. Predicting RNA-seq coverage from DNA sequence as a unifying model of gene regulation. Nat Genet. 2025. doi: 10.1038/s41588-024-02053-6
78. Ren Y, Chen Z, Qiao L, Jing H, Cai Y, Xu S, et al. BEACON: Benchmark for comprehensive RNA tasks and Language Models. arXiv [q-bio.QM]. 2024. Available: arxiv.org/abs/2406.10391
79. Metsky H C, Welch N L, Pillai P P, Haradhvala N J, Rumker L, Mantena S, et al. Designing sensitive viral diagnostics with machine learning. Nat Biotechnol. 2022; 40:1123-1131.
80. Pataskar A, Tiwari V K. Computational challenges in modeling gene regulatory events. Transcription. 2016; 7:188-195.
81. Challenge Problems in Bioinformatics and Computational Biology from Other Reports. Challenge Problems in Bioinformatics and Computational Biology from Other Reports.
82. Cox R S 3rd, Surette M G, Elowitz M B. Programming gene expression with combinatorial promoters. Mol Syst Biol. 2007; 3:145.
83. Ji Y, Zhou Z, Liu H, Davuluri R V. DNABER T: pre-trained Bidirectional Encoder Representations from Transformers model for DNA-language in genome. Bioinformatics. 2021; 37:2112-2120.
84. Chen J, Hu Z, Sun S, Tan Q, Wang Y, Yu Q, et al. Interpretable RNA foundation model from unannotated data for highly accurate RNA structure and function predictions. arXiv [q-bio.QM]. 2022. doi: 10.1101/2022.08.06.503062
85. Chen K, Zhou Y, Ding M, Wang Y, Ren Z, Yang Y. Self-supervised learning on millions of pre-mRNA sequences improves sequence-based RNA splicing prediction. bioRxiv. 2023. doi: 10.1101/2023.01.31.526427
86. Doench J G, Fusi N, Sullender M, Hegde M, Vaimberg E W, Donovan K F, et al. Optimized sgRNA design to maximize activity and minimize off-target effects of CRISPR-Cas9. Nat Biotechnol. 2016; 34:184-191.
87. Höijer I, Emmanouilidou A, Östlund R, van Schendel R, Bozorgpana S, Tijsterman M, et al. CRISPR-Cas9 induces large structural variants at on-target and off-target sites in vivo that segregate across generations. Nat Commun. 2022; 13:627.
88. Wang T, Wei J J, Sabatini D M, Lander E S. Genetic screens in human cells using the CRISPR-Cas9 system. Science. 2014; 343:80-84.
89. Behan F M, Iorio F, Picco G, Gonçalves E, Beaver C M, Migliardi G, et al. Prioritization of cancer therapeutic targets using CRISPR-Cas9 screens. Nature. 2019; 568:511-516.
90. Munoz D M, Cassiani P J, Li L, Billy E, Korn J M, Jones M D, et al. CRISPR screens provide a comprehensive assessment of cancer vulnerabilities but generate false-positive hits for highly amplified genomic regions. Cancer Discov. 2016; 6:900-913.
91. Kim H K, Kim Y, Lee S, Min S, Bae J Y, Choi J W, et al. SpCas9 activity prediction by DeepSpCas9, a deep learning-based model with high generalization performance. Sci Adv. 2019; 5: eaax9249.
92. Doench J G, Hartenian E, Graham D B, Tothova Z, Hegde M, Smith I, et al. Rational design of 36highly active sgRNAs for CRISPR-Cas9-mediated gene inactivation. Nat Biotechnol. 2014; 32:1262-1267.
93. Aguirre A J, Meyers R M, Weir B A, Vazquez F, Zhang C-Z, Ben-David U, et al. Genomic copy number dictates a gene-independent cell response to CRISPR/Cas9 targeting. Cancer Discov. 2016; 6:914-929.
94. Botti-Lodovico Y, Nair P, Nosamiefan D, Stremlau M, Schaffner S, Agignoae S V, et al. The Origins and Future of Sentinel: An Early-Warning System for Pandemic Preemption and Response. Viruses. 2021; 13. doi: 10.3390/v13081605
95. Xue Y, Chen Z, Zhang W, Zhang J. Engineering CRISPR/Cas13 system against RNA viruses: From diagnostics to therapeutics. Bioengineering (Basel). 2022; 9:291.
96. Geffen Y, Ofran Y, Unger R. DistilProtBert: a distilled protein language model used to distinguish between real proteins and their randomly shuffled counterparts. Bioinformatics. 2022; 38: ii95-ii98.
97. Cui H, Wang C, Maan H, Pang K, Luo F, Duan N, et al. scGPT: toward building a foundation model for single-cell multi-omics using generative AI. Nat Methods. 2024; 21:1470-1480.
98. Zhang B, Sennrich R. Root mean square layer normalization. arXiv [cs.LG]. 2019. Available: arxiv.org/abs/1910.07467
99. Pan V Y. Structured matrices and polynomials: Unified superfast algorithms. 2001st ed. Cambridge, MA: Birkhäuser; 2012. doi: 10.1007/978-1-4612-0129-8
100. Fu L, Niu B, Zhu Z, Wu S, Li W. CD-HIT: accelerated for clustering the next-generation sequencing data. Bioinformatics. 2012; 28:3150-3152.
101. Wu N C, Dai L, Olson C A, Lloyd-Smith J O, Sun R. Adaptation in protein fitness landscapes is facilitated by indirect paths. Elife. 2016; 5. doi: 10.7554/eLife. 16965
102. Liu G, Zeng H, Mueller J, Carter B, Wang Z, Schilz J, et al. Antibody complementarity determining region design using high-capacity machine learning. Bioinformatics. 2020; 36:2126-2133.
103. Sarkisyan K S, Bolotin D A, Meer M V, Usmanova D R, Mishin A S, Sharonov G V, et al. Local fitness landscape of the green fluorescent protein. Nature. 2016; 533:397-401.
104. Danaee P, Rouches M, Wiley M, Deng D, Huang L, Hendrix D. bpRNA: large-scale automated annotation and analysis of RNA secondary structure. Nucleic Acids Res. 2018; 46:5381-5394.
105. Loshchilov I, Hutter F. Decoupled weight decay regularization. arXiv [cs.LG]. 2017. Available: 37arxiv.org/abs/1711.05101
106. Gong J, Xu K, Ma Z, Lu Z J, Zhang Q C. A deep learning method for recovering missing signals in transcriptome-wide RNA structure profiles from probing experiments. Nat Mach Intell. 2021; 3:995-1006.
107. Jaganathan K, Kyriazopoulou Panagiotopoulou S, McRae J F, Darbandi S F, Knowles D, Li Y I, et al. Predicting splicing from primary sequence with deep learning. Cell. 2019; 176:535-548.e24.
108. Bogard N, Linder J, Rosenberg A B, Seelig G. A deep neural network for predicting and engineering alternative polyadenylation. Cell. 2019; 178:91-106.e23.
109. Amin N, McGrath A, Chen Y-P P. Evaluation of deep learning in non-coding RNA classification. Nat Mach Intell. 2019; 1:246-256.
110. Song Z, Huang D, Song B, Chen K, Song Y, Liu G, et al. Attention-based multi-label neural networks for integrated prediction and interpretation of twelve widely occurring RNA modifications. Nat Commun. 2021; 12:4011.
111. Sample P J, Wang B, Reid D W, Presnyak V, McFadyen I J, Morris D R, et al. Human 5′ UTR design and variant effect prediction from a massively parallel translation assay. Nat Biotechnol. 2019; 37:803-809.
112. Angenent-Mari N M, Garruss A S, Soenksen L R, Church G, Collins J J. A deep learning approach to programmable RNA switches. Nat Commun. 2020; 11:5057.
113. Chuai G, Ma H, Yan J, Chen M, Hong N, Xue D, et al. DeepCRISPR: optimized CRISPR guide RNA design by deep learning. Genome Biol. 2018; 19:80.
114. Zhao M, Yuan Z, Wu L, Zhou S, Deng Y. Precise prediction of promoter strength based on a DE Novo synthetic promoter library coupled with machine learning. ACS Synth Biol. 2022; 11:92-102.
115. Rosenblatt F. The perceptron: a probabilistic model for information storage and organization in the brain. Psychol Rev. 1958; 65:386-408.
116. Su J, Lu Y, Pan S, Murtadha A, Wen B, Liu Y. RoFormer: Enhanced transformer with Rotary Position Embedding. arXiv [cs.CL]. 2021. Available: arxiv.org/abs/2104.09864
117. Shazeer N. GLU Variants Improve Transformer. arXiv [cs.LG]. 2020. Available: arxiv.org/abs/2002.05202

### Polynomial Expressivity: Framework and Theory

### 1—Epistasis as a Polynomial Expressivity Problem

Epistasis refers to the phenomenon where the effect of one amino acid on a trait, such as fitness, depends on the presence of other amino acids in the same protein. In the context of proteins, the fitness landscape—how different mutations combine to affect overall fitness—can be viewed as the result of complex interactions between amino acids. These interactions are not simply additive but reflect higher-order dependencies between amino acids, known as epistatic effects Poelwijk et al. (2019); Phillips (2008).

Formally, epistasis can be described as a polynomial expressivity problem, where the fitness landscape is modeled by a multivariate polynomial Sethi & Zhou (2024); Aghazadeh et al. (2021). Each term in the polynomial represents interactions between different residues, capturing both lower-order (single residue) and higher-order (epistatic) interactions. The coefficients of these polynomials determine the contribution of each interaction to the overall fitness Faure et al. (2024).

Let u∈ [symbol] ^{N} denote the sequence of amino acids, where each uᵢ represents the state of the i-th residue. The fitness landscape ƒ: R^{N}→R can be expressed as

$$f ( u ) = {\sum }_{k = 1}^{K} {\sum }_{1 \leq {i}_{1} < {i}_{2} < … < {i}_{k} \leq N} {c}_{{i}_{1} {i}_{2} … {i}_{k}} {u}_{{i}_{1}} {u}_{{i}_{2}} … {u}_{{i}_{k}} ,$$

where K is the maximum interaction order, and the cᵢc_{i . . . ik}∈R are coefficients that capture interactions for the collection of residues i₁, i₂, . . . , iₖ. Higher-order terms (k>1) represent epistatic interactions beyond additive effects, modeling the combinatorial complexity of genetic interactions Zhou et al. (2022); Sethi & Zhou (2024).

Following prior work by (Aghazadeh et al., 2021; Faure et al., 2024), learning the fitness landscape can be understood as determining the coefficients of a multivariate polynomial that governs these interactions. Therefore, modeling epistasis can be viewed as fitting a polynomial to the protein fitness landscape. This approach aligns with methodologies used in studies such as Kondrashov & Kondrashov (2015); Poelwijk et al. (2019), where higher-order interactions are essential for accurately capturing the complexity of protein sequence-function relationships.

High-throughput methods such as deep mutational scanning (DMS) experiments have enabled the characterization of thousands to millions of protein variants in a massively parallel manner (Somer-meyer et al., 2022; Bank et al., 2016). A major challenge in utilizing this data to understand protein sequence-function relationships and build accurate predictive models is the presence of epistasis, which causes the effect of a mutation to depend on the states of amino acids at other positions (Castro et al., 2022). Epistasis, in particular, challenges the practicality of simple additive models, where the phenotype could be predicted by merely summing the independent effects of all mutations (Fisher, 1919). Instead, it necessitates more extensive experimental measurements and the application of more complex models.

### 2—How Transformers Learn Fitness Landscapes

To address the challenge of learning higher-order sequence-function relationships in biology, Applicants first turned to transformers. As a foundational model architecture, transformers have become indispensable in biological sequence modeling, forming the backbone of many state-of-the-art approaches in protein structure and function prediction. Their attention mechanism, which computes pairwise dependencies between sequence elements, has proven especially valuable in capturing complex interactions between residues. The literature has extensively documented the effectiveness of this pair-wise comparison in enabling transformers to learn intricate sequence dependencies, making them a natural choice for modeling the combinatorial complexity inherent in biological data.

In transformers, each residue in a sequence is represented as a high-dimensional embedding, mapping the discrete amino acid uᵢ to a continuous vector eᵢ∈R^{d}, where d is the embedding dimension. These embeddings allow the model to operate in a continuous feature space, which facilitates learning nuanced relationships across sequence positions. The attention mechanism then calculates scores between each pair of residues, capturing the dependencies that inform their combined effect on function. Formally, for residues i and j, the attention score αᵢⱼ is computed based on a scaled dot product of their query and key vectors, with a softmax applied to normalize the scores across all residues. This score, given by

$${α}_{ij} = \frac{exp ( \frac{{q}_{i} \cdot {k}_{j}}{\sqrt{d}} )}{{\sum }_{j = 1}^{N} exp ( \frac{{q}_{i} \cdot {k}_{j}}{\sqrt{d}} )} ,$$

acts as a contextual weight that governs the importance of residue j's contribution to the representation of residue i Vaswani (2017). This contextual weighting process allows the model to dynamically adjust “interaction coefficients” in response to sequence context, akin to selectively adjusting terms in a polynomial function based on each residue's impact on fitness.

The output of the attention layer for a residue uᵢ is then computed as a weighted sum of value vectors from all other residues, given by

$${output}_{i} = {\sum }_{j = 1}^{N} {α}_{ij} {v}_{j}$$

where vⱼ represents the value vector associated with uⱼ. Since αᵢⱼ varies depending on sequence context, this weighted sum acts as a flexible interaction function, capturing both additive and higher-order dependencies (epistatic interactions) between residues. By stacking multiple layers, the transformer progressively builds representations of increasing complexity, recursively modeling higher-order dependencies Deng et al. (2024); Sethi & Zhou (2024). In each layer, hidden representations are updated in a manner akin to applying polynomial terms, with interactions governed by layer-specific attention scores α⁽¹⁾ᵢⱼ and transformation matrices W^{(l)}:

$${h}_{i}^{( l + 1 )} = {\sum }_{j = 1}^{N} {α}_{ij}^{( l )} {W}^{( l )} {h}_{j}^{( l )} .$$

This recursive formulation enables transformers to capture dependencies up to the maximum interaction order K, progressively building a polynomial-like function over sequence positions and modeling epistatic effects by adjusting coefficients layer by layer (Sethi & Zhou, 2024).

Large-scale transformer models such as AlphaFold (Jumper et al., 2021), ESM3 (Hayes et al., 2024), and ProtT5 have set new benchmarks in protein structure prediction and function annotation; however, these models require significant computational resources, with parameter counts often ranging from 650 million to 98 billion and data demands approaching a trillion tokens (amino acids) for training. This sheer scale is both compute-intensive and costly, making it challenging to apply transformers effectively, particularly when dataset sizes are limited. Additionally, the quadratic complexity of the attention mechanism, which scales with sequence length N, places high computational demands for the use of these models, further complicating their use in real-world biological applications.

This motivates an important question: can architectures be developed that inherently respect the polynomial expressivity required by epistasis? Given the structure of epistatic interactions, where complex fitness landscapes can be expressed through polynomial dependencies among residues, it is natural to explore architectures that explicitly align with this mathematical structure. By moving beyond transformers and seeking models that respect the inherent polynomial expressivity of the problem, the aim is to capture these higher-order interactions more efficiently and effectively—especially in cases where compute resources or data availability are limited.

### 3—Polynomial Expressivity of State-Space Models (SSMs)

State-Space Models (SSMs) provide a structured and efficient approach to sequence modeling by parameterizing the dynamics of a hidden state xₜ that evolves over time. In the discrete-time formulation, an SSM is defined as:

$${x}_{t + 1} = {Ax}_{t} + {Bu}_{t} , {y}_{t} = {Cx}_{t} + {Du}_{t} ,$$

where xₜ∈R^{N} represents the hidden state, uₜ∈R is the input sequence, and yₜ∈R is the output. The matrices A∈R^{N×N}, B∈R^{N}, C∈R^{1×N}, and scalar D are learnable parameters. This formulation provides a compact way to model sequences, where the state xₜ encapsulates the input history and evolves through the dynamics encoded by A, B, and C.

A critical aspect of SSMs is their ability to efficiently approximate polynomials, a capability rooted in the design of the state matrix A. In models like S4D, A is constructed using the HiPPO framework, which generates a diagonal matrix designed to encode polynomial bases. The eigenvalues of A, denoted aₙ (n=0, 1, . . . , N−1), are chosen such that their real parts decay exponentially ( [symbol] (aₙ)=−½) to ensure stability, while their imaginary parts oscillate at increasing frequencies (ℑ(aₙ)=⁽²ⁿ⁺¹)π/2). This construction aligns A with the Legendre polynomial basis, enabling the system to capture a wide range of polynomial interactions, including higher-order dependencies.

To understand the polynomial expressivity of SSMs, consider the Vandermonde matrix, which encodes the polynomial basis. The kernel K of the SSM can be expressed as:

$${K}_{ℓ} = {\sum }_{n = 0}^{N - 1} {C}_{n} ( {a}_{n}^{ℓ} ) {B}_{n} ,$$

where [symbol] =0, 1, . . . , L−1 represents the time steps, and aₙ, Bₙ, Cₙ are the eigenvalues and components of the matrices A, B, and C, respectively. The Vandermonde matrix V, defined as [symbol] =(aₙ) [symbol] , ensures that the kernel K aligns with the polynomial structure. This construction dynamically adjusts the polynomial coefficients based on the input sequence, capturing both additive and higher-order interactions.

The equivalence between the recurrent formulation and its convolutional representation provides a dual perspective that combines expressive modeling with efficient computation. Instead of sequentially propagating the state xₜ, the convolutional kernel K can be precomputed for arbitrary sequence lengths. This precomputation enables parallelized training and inference, making SSMs highly efficient for modeling long sequences.

The Fast Fourier Transform (FFT) further enhances this process by decomposing the kernel and input sequence into their frequency components. Each frequency corresponds to a specific polynomial term, allowing the model to selectively weight interactions in the frequency domain. In the frequency domain, the convolution operation simplifies to an elementwise multiplication:

$$\hat{y} ( ω ) = \hat{K} ( ω ) \cdot \hat{u} ( ω ) ,$$

where K\hat{ }(ω) and u\hat{ }(ω) denote the Fourier transforms of the kernel K and the input sequence u, respectively. The result is then transformed back into the time domain using the inverse FFT, enabling efficient computation with time complexity O(L log L), where L is the sequence length.

After performing sequence mixing via convolution, where kernels operate independently across dimensions, channel mixing is applied to enable feature interactions across the hidden dimensions. This is achieved using gated linear units, such as SwiGLU, which introduce a gating mechanism to enhance representational capacity. The combination of sequence and channel mixing ensures that the model captures both temporal dependencies and cross-channel interactions effectively, providing a comprehensive framework for sequence modeling.

### 4—Experimental Details

### 4.1 RNA Tasks

TABLE 13
Janus Model Configuration for GenomicBenchmark

| PARAMETER | 48K |
|---|---|
| D_MODEL | 64 |
| N_LAYERS | 1 |
| DROPOUT | 0.2 |
| D_INPUT | 4, 5 |
| D_OUTPUT | 2, 3 |
| PRENORM | TRUE |
| PGC BLOCK 1 | 16 HIDDEN DIM, |
| | 0.2 DROPOUT |
| PGC BLOCK 2 | 128 HIDDEN DIM, |
| | 0.2 DROPOUT |

### 4.2 CRISPR Cas13

TABLE 14
Janus Model Configuration for Cas13a
classification and regression tasks

| PARAMETER | 3,793-3,810 |
|---|---|
| D_MODEL | 16 |
| N_LAYERS | 1 |
| DROPOUT | 0.2 |
| D_INPUT | 8 |
| D_OUTPUT | 1, 2 |
| PRENORM | TRUE |
| PGC BLOCK 1 | 16 HIDDEN DIM, |
| | 0.2 DROPOUT |

Experiment Details: For the CRISPR Cas13 dataset, guide-target pairs were encoded using a one-hot encoding scheme with a dimensionality of 4 for each guide and target. These were then concatenated to form a stacked representation with an 8-dimensional one-hot-encoded vector for sequences of 48 base pairs. The log fluorescence threshold to distinguish active from non-active pairs was set at a value of −4.00. The model underwent 5-fold cross-validation across three distinct tasks. In the first task, binary classification of guide-target pairs was performed, assessing the model's performance through AUC-ROC and AUPR metrics, with each fold being trained for 75 epochs. The following two tasks involved regression analyses: the first was a positive-only regression targeting values above the activity threshold, and the second encompassed a comprehensive regression across all guide-target pairs, both positive and negative. Both regression tasks were evaluated using Spearman's coefficient, following the same 75-epoch, 5-fold cross-validation structure.

### 4.2.1 CRISPR Cas9

Experimental Details: A composite of seven CRISPR Cas9 datasets were used—Kim2019 train, Doench2014 mouse, Doench2014 human, Doench2016, Wang2014, Xiang2021, and Munoz2016—comprising 46,526 unique context sequences. These sequences were characterized by a 20-nucleotide spacer sequence flanked by four nucleotides upstream and a PAM sequence plus three nucleotide contexts downstream, with 45% of sequences incorporating the Chen tracrRNA variant. Each sequence was one-hot encoded to capture the nucleotide arrangement intricately. For the purposes of model training and validation, a 5-fold cross-validation procedure was used, meticulously applied to both training and test sets. Each fold was trained for 150 epochs of training, and evaluated using Spearman's correlation for regression enzymatic activity based on a sequence.

TABLE 15
Janus Model Configuration for Cas9
classification and regression tasks

| PARAMETER | 13,361 |
|---|---|
| D_MODEL | 48 |
| N_LAYERS | 1 |
| DROPOUT | 0.2 |
| D_INPUT | 4 |
| D_OUTPUT | 1 |
| PRENORM | TRUE |
| PGC BLOCK 1 | 16 HIDDEN DIM, |
| | 0.2 DROPOUT |

### 4.3 ReLSO Protein Fitness Tasks

Experiment Details: For the protein fitness prediction tasks, the Janus was trained across three fitness prediction datasets GB1, Gifford, and GFP. Each dataset contained amino acid sequences of the same length which were one-hot-encoded, input dimension of 20, with the stability and affinity, enrichment, or fluorescence respectively values serving as regression labels. The training was performed for 100 epochs, utilizing the AdamW optimizer with a learning rate of 0.001 and a weight decay of 0.01. The evaluation metric was Spearman's rank correlation coefficient on the validation set, and Mean Squared Error Loss (MSELoss) was used as the loss function. Model Configuration: The same architecture for both the protein fitness datasets were used.

TABLE 16
Janus Model Configuration for all protein tasks

| PARAMETER | 55,169 |
|---|---|
| D_MODEL | 64 |
| N_LAYERS | 1 |
| DROPOUT | 0.2 |
| D_INPUT | 20 |
| D_OUTPUT | 1 |
| PRENORM | TRUE |
| PGC BLOCK 1 | 16 HIDDEN DIM, |
| | 0.2 DROPOUT |
| PGC BLOCK 2 | 128 HIDDEN DIM, |
| | 0.2 DROPOUT |

### 4.4 Epistatic Transformer GFP Tasks

Experimental Details: In this study, a head-to-head comparison of similarly sized transformer models and Janus was conducted to evaluate their capacity for modeling epistatic interactions. Applicants focused on six GFP tasks, employing a 70-30 train-test split. Both models were trained for 50 epochs, with performance assessed based on the lowest test loss achieved during training. The primary evaluation metric was R², computed for each dataset.

The GFP datasets varied in size, sequence length, and median Hamming distance. The datasets included amacGFP, allGFP, 4GFP, avGFP, and cgreGFP, ranging from 26,165 to 147,950 samples, with sequence lengths between 235 and 247 base pairs. Notably, most datasets had a median Hamming distance of 3, except for avGFP, which exhibited a median Hamming distance of 4.

### 4.5 Protein Solubility and Localization

TABLE 17
Statistics of GFP Datasets

| | | | MEDIAN |
|---|---|---|---|
| | NUMBER | LENGTH | HAMMING |
| DATASET | OF SAMPLES | (AA) | DISTANCE |
| AMACGFP | 35,500 | 238.0 | 3.0 |
| ALLGFP | 93,925 | 246.0 | 3.0 |
| 4GFP | 147,950 | 247.0 | 3.0 |
| AVGFP | 54,025 | 238.0 | 4.0 |
| CGREGFP | 26,165 | 235.0 | 3.0 |

TABLE 18
Janus Model Configuration for GenomicBenchmark

| PARAMETER | 48K |
|---|---|
| D_MODEL | 64 |
| N_LAYERS | 1 |
| DROPOUT | 0.2 |
| D_INPUT | 4 |
| D_OUTPUT | 2, 3 |
| PRENORM | TRUE |
| PGC BLOCK 1 | 16 HIDDEN DIM, |
| | 0.2 DROPOUT |
| PGC BLOCK 2 | 128 HIDDEN DIM, |
| | 0.2 DROPOUT |

### 4.6 Nucleotide Transformer Tasks

TABLE 19
Janus Model, Transformer Encoder, and Hyena Configuration
for Nucleotide transformer Tasks

| | JANUS | TRANSFORMER | |
|---|---|---|---|
| PARAMETER | MODEL | ENCODER | HYENA |
| D_MODEL | 48 | 48 | 48 |
| N_LAYERS | 1 | 1 | 1 |
| DROPOUT | 0.2 | 0.2 | 0.2 |
| D_INPUT | 4 | 4 | 4 |
| D_OUTPUT | 2, 3 | 2, 3 | 2, 3 |
| NUM_HEADS | — | 8 | — |
| FF_DIM | — | 192 | — |
| EMBEDDING | — | ROPE | — |
| PGC BLOCK 1 | 16 HIDDEN DIM, | — | — |
| | 0.2 DROPOUT | | |
| PGC BLOCK 2 | 128 HIDDEN DIM, | — | — |
| | 0.2 DROPOUT | | |

The nucleotide transformer downstream tasks dataset comprises 18 genomics tasks designed for binary and multi-class classification. This benchmark dataset, updated following peer review, provides high-quality human genomic data across diverse tasks and ensures consistency in evaluation by replacing synthetic negative samples with real genomic sequences and incorporating chromosome-held-out test sets. The tasks span several sources: histone ChIP-seq data for 10 histone marks (H2AFZ, H3K27ac, H3K27me3, H3K36me3, H3K4me1, H3K4me2, H3K4me3, H3K9ac, H3K9me3, and H4K20me1) sourced from ENCODE, enhancer elements from ENCODE's SCREEN database, promoter regions from the Eukaryotic Promoter Database, and splice sites from GENCODE V44.

The benchmark includes diverse tasks such as promoter classification (e.g., promoter all, promoter tata, and promoter no tata) with 300 bp sequences; enhancer classification (e.g., enhancers and enhancers types) with 400 bp sequences; splice site prediction (splice sites all, splice sites acceptor, and

Splice sites donor) using 600 bp sequences; and histone modifications tasks with 1,000 bp sequences for each mark. The number of train and test sequences varies across tasks, with the promoter all task containing 30,000 training sequences and 1,584 test sequences, while smaller subsets such as promoter tata involve 5,062 training and 212 test sequences. For histone marks, tasks such as H3K27ac feature 30,000 training sequences and 1,616 test sequences, while H3K9ac has slightly fewer, with 23,274 training sequences and 1,004 test sequences.

Each model was trained for 100 epochs across all tasks, ensuring robust evaluation on the nucleotide transformer downstream tasks benchmark. The dataset's diversity in sequence lengths, ranging from 300 bp to 1,000 bp.

### 4.7 Genomics Benchmark

TABLE 20
Janus Model, Transformer Encoder, and Hyena Configuration
for Nucleotide transformer Tasks

| | JANUS | TRANSFORMER | |
|---|---|---|---|
| PARAMETER | MODEL | ENCODER | HYENA |
| D_MODEL | 48 | 48 | 48 |
| N_LAYERS | 1 | 1 | 1 |
| DROPOUT | 0.2 | 0.2 | 0.2 |
| D_INPUT | 4 | 4 | 4 |
| D_OUTPUT | 2, 3 | 2, 3 | 2, 3 |
| NUM_HEADS | — | 8 | — |
| SWI_GLU_DIM | — | 192 | — |
| EMBEDDING | — | ROPE | — |
| PGC BLOCK 1 | 16 HIDDEN DIM, | — | — |
| | 0.2 DROPOUT | | |
| PGC BLOCK 2 | 128 HIDDEN DIM, | — | — |
| | 0.2 DROPOUT | | |

Experimental Details: In the investigation utilizing the GenomicsBenchmark suite, Applicants focused on eight binary classification tasks related to regulatory genomic elements. The datasets within this suite presented a diverse range of sequence lengths, varying from 200 to approximately 4800 base pairs. To standardize the input, one-hot encoding for the sequences was employed, padding them to the maximum length specific to each dataset. In cases of absent sequences, padding was implemented using the ‘N’ token, represented by [0,0,0,0]. The training protocol involved a consistent 50 epochs for each dataset, optimizing the model with AdamW, a learning rate of 0.001, and a weight decay of 0.01, under the guidance of cross-entropy loss. Each dataset on top-1% accuracy metric was evaluated.

### REFERENCES FOR EXAMPLE 2—EXPERIMENTAL DETAILS

Amirali Aghazadeh, Hunter Nisonoff, Orhan Ocal, David H Brookes, Yijie Huang, O Ozan Koyluoglu, Jennifer Listgarten, and Kannan Ramchandran. Epistatic net allows the sparse spectral regularization of deep neural networks for inferring fitness functions. Nature communications, 12 (1):5225, 2021.
Claudia Bank, Sebastian Matuszewski, Ryan T Hietpas, and Jeffrey D Jensen. On the (un) predictability of a large intragenic fitness landscape. Proceedings of the National Academy of Sciences, 113(49):14085-14090, 2016.
Egbert Castro, Abhinav Godavarthi, Julian Rubinfien, Kevin Givechian, Dhananjay Bhaskar, and Smita Krishnaswamy. Transformer-based protein generation with regularized latent space optimization. Nature Machine Intelligence, 4(10):840-851, 2022.
Chenhui Deng, Zichao Yue, and Zhiru Zhang. Polynormer: Polynomial-expressive graph transformer in linear time. arXiv preprint arXiv:2403.01232, 2024.
Andre J Faure, Ben Lehner, Verónica Miró Pina, Claudia Serrano Colome, and Donate Weghorn. An extension of the walsh-hadamard transform to calculate and model epistasis in genetic landscapes of arbitrary shape and complexity. PLOS Computational Biology, 20(5):e1012132, 2024.
Ronald A Fisher. Xv.—the correlation between relatives on the supposition of mendelian inheritance. Earth and Environmental Science Transactions of the Royal Society of Edinburgh, 52(2):399-433, 1919.
Tomas Hayes, Roshan Rao, Halil Akin, Nicholas J Sofroniew, Deniz Oktay, Zeming Lin, Robert Verkuil, Vincent Q Tran, Jonathan Deaton, Marius Wiggert, et al. Simulating 500 million years of evolution with a language model. bioRxiv, pp. 2024-07, 2024.
John Jumper, Richard Evans, Alexander Pritzel, Tim Green, Michael Figurnov, Olaf Ronneberger, Kathryn Tunyasuvunakool, Russ Bates, Augustin Žídek, Anna Potapenko, et al. Highly accurate protein structure prediction with alphafold. nature, 596(7873):583-589, 2021.
Dmitry A Kondrashov and Fyodor A Kondrashov. Topological features of rugged fitness landscapes in sequence space. Trends in Genetics, 31(1):24-33, 2015.
Patrick C Phillips. Epistasis—the essential role of gene interactions in the structure and evolution of genetic systems. Nature Reviews Genetics, 9(11):855-867, 2008.
Frank J Poelwijk, Michael Socolich, and Rama Ranganathan. Learning the pattern of epistasis linking genotype and phenotype in a protein. Nature communications, 10 (1):4213, 2019.
Palash Sethi and Juannan Zhou. Importance of higher-order epistasis in large protein sequence-function relationships. bioRxiv, 2024. doi: 10.1101/2024.09.22.614318. URL www.biorxiv.org/content/early/2024/09/24/2024.09.22.614318.
Louisa Gonzalez Somermeyer, Aubin Fleiss, Alexander S Mishin, Nina G Bozhanova, Anna A Igolkina, Jens Meiler, Maria-Elisenda Alaball Pujol, Ekaterina V Putintseva, Karen S Sarkisyan, and FyodoA Kondrashov. Heterogeneity of the gfp fitness landscape and data-driven protein design. Elife, 11:e75842, 2022.
A Vaswani. Attention is all you need. Advances in Neural Information Processing Systems, 2017. Juannan Zhou, Mandy S Wong, Wei-Chia Chen, Adrian R Krainer, Justin B Kinney, and David M.
McCandlish. Higher-order epistasis and phenotypic prediction. Proceedings of the National Academy of Sciences, 119(39): e2204233119, 2022.

Various modifications and variations of the described methods, pharmaceutical compositions, and kits of the invention will be apparent to those skilled in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and may be applied to the essential features herein before set forth.

1. A machine learning computer-implemented method, comprising:
a) receiving, by one or more computing devices, input data;
b) processing the input data with a projected gate convolution module and generating, by the projected gate convolution module, a first output data; and
c) processing the first output data with a state space module and generating, by the state space module, a second output data,
optionally further comprising transmitting, by the one or more computing devices, the second output data to a user device associated with a user.

2. (canceled)

3. The method of claim 1, wherein the input data is first processed by one or more linear projections module, one or more root mean square (RMS) normalizations modules, or a combination thereof;
optionally wherein the projected gate convolution module comprises one or more linear projections module, one or more root mean square (RMS) normalizations modules, or a combination thereof;
optionally wherein the one or more linear projections module comprises one or more weight matrix modules, one or more bias vector modules, one or more learnable filters module, or a combination thereof;
optionally wherein the one or more weight matrix modules, the one or more bias vector modules, or a combination thereof independently comprise a probability distribution or random assignment of matrix or vector components, optionally wherein the probability distribution is a gaussian distribution;
optionally wherein the one or more linear projections module, one or more root mean square (RMS) normalizations modules, or combination thereof are carried out in parallel; and
optionally wherein the method further comprises:
processing the second output data by the one or more linear projections module, one or more root mean square (RMS) normalizations modules, or a combination thereof;
generating, by the one or more linear projections module, one or more root mean square (RMS) normalizations modules, or a combination thereof, a third output data; and
transmitting, by the one or more computing devices, the third output data to a user device associated with a user.

4-7. (canceled)

8. The method of claim 1, wherein the projected gate convolution module is not pre-trained.

9-10. (canceled)

11. The method of claim 1, wherein the projected gate convolution module comprises one or more convolutional layer;
optionally wherein the one or more convolution layer comprises a one dimensional (1D) convolutional layer;
optionally wherein the projected gate convolution module comprises Fast Fourier Transform (FFT);
optionally wherein the 1D convolutional layer comprises FFT.

12-14. (canceled)

15. The method of claim 1, wherein the first output data comprises local features of the input data, global features of the input data, or a combination thereof, optionally wherein the local and global features are processes and generated in parallel.

16-17. (canceled)

18. The method of claim 1, wherein the projected gate convolution module comprises embedding.

19. The method of claim 1, wherein the state space module is a structured state space module;
optionally wherein there the structured state space module is a diagonalized structured state space module;
optionally wherein the state space module comprises a linear ordinary differential model or a convolutional model;
optionally wherein the state space module comprises a linear ordinary differential model or a convolutional model;
optionally wherein the linear ordinary differential model or a convolutional model comprises a learning parameter module;
optionally wherein the state space module comprises one or more convolutional kernels;
optionally wherein the one or more convolutional kernels parallelizes training and generating an output; and
optionally wherein the one or more convolutional kernels perform the computations independently.

20-25. (canceled)

26. The method of claim 1, wherein the input data comprises one or more strings of characters;
optionally wherein the one or more strings of characters comprises one or more amino acid sequence, one or more nucleic acid sequence, or a combination thereof;
optionally wherein the input data further comprises feature data of the one or more amino acid sequence, one or more nucleic acid sequence, or a combination thereof;
optionally wherein the one or more strings comprises one or more text; and
optionally wherein the one or more text comprises health records.

27-30. (canceled)

31. The method of claim 1, wherein the method comprises regression or classification, optionally wherein the second output data comprise one or more correlation or classification of one or more feature of the input data.

32. (canceled)

33. The method of claim 3, wherein the projected gate convolution module comprises generating local and global features in parallel, the method of the projected gate convolution module comprising of:
a. processing the input data by embedding the input data into a data structure comprising one or more features of the input data;
b. transforming the embedded data with one or more transformation layers;
c. projecting the transformed data with two or more weight matrix modules and two or more bias vector modules;
d. normalizing the projected data with two or more RMS normalizations modules, thereby generating preliminary local data and global data;
e. processing the preliminary local data with one or more 1D convolutional layers, the one or more 1D convolutional layers comprise one or more learnable filters and the one or more bias vector modules, thereby generating local data structure;
f. combining the local data and the global data, thereby generating universal data;
g. projecting the universal data with the one or more weight matrix modules and the one or more bias vector modules; and
h. normalizing the universal data with the one or more RMS normalizations modules, thereby generating the first output data comprising of the universal data.

34. The method of claim 1, further comprising training the projected gate convolution module, state space module, or a combination thereof with training data;
optionally wherein the training data comprises biological data, chemical data, or a combination thereof;
optionally wherein the biological data, chemical data, or a combination thereof comprises genomic data, proteomic data, epidemiological data, pharmacological data, epistatic data, or a combination thereof;
optionally wherein the training data comprises health record data and/or diagnostic data; and
optionally wherein the projected gate convolution module, state space module, or a combination thereof is trained using a method selected independently from the group consisting of unsupervised learning, supervised learning, semi-supervised learning, reinforcement learning, transfer learning, incremental learning, curriculum learning, learning to learn, and contrastive learning.

35-39. (canceled)

40. The method of claim 1, wherein the state space module comprises no less than 3,000 parameters, no more than 5,000 parameters, no more than 10,000 parameters, no more than 50,000 parameters, no more than 100,000 parameters, no more than 250,000 parameters, no more than 500,000 parameters, no more than 750,000 parameters, or no more than one million parameters.

41. (canceled)

42. The method of claim 1, wherein the state space module comprises one or more state space module data structures;
optionally wherein the one or more state space module data structures includes at least three matrix data structures; and
optionally wherein the at least three matrix data structure comprises a dynamic matrix data structure, a map matrix data structure, and a projection matrix data structure.

43-44. (canceled)

45. The method of claim 1, wherein the projected gate convolution module, state space module, or both comprises one or more hidden dimensions, optionally wherein the one or more hidden dimensions are independently selected from 2, 4, 8, 16, 32, 64, 128, 256, or 512 dimensions.

46. (canceled)

47. A method of:
a) determining chromatin profiling, wherein the input data is one or more nucleic acid sequences, and the second output data is one or more chromatin feature;
b) classifying gene regulating regions, wherein the input data is one or more nucleic acid sequences, and the second output data is a determination of one or more gene regulating regions;
c) generating guide molecules for programmable nucleases, wherein the input data is one or more guide-target pairs, and the second output data is activity of the one or more guide-target pairs;
d) determining protein fitness, wherein the input data is one or more amino acid sequence, and the second output data is stability, binding affinity, or a combination thereof of the one or more amino acid sequence; or
e) modeling protein features, wherein the input data is one or more amino acid sequence, and the second output data is remote homology, fluorescence, protein stability, or a combination thereof, and
wherein the method comprises the method of claim 1.

48-51. (canceled)

52. A system to carry out a machine learning method, comprising:
a storage device; and
a processor communicatively coupled to the storage device, wherein the processor executes application code instructions that are stored in the storage device to cause the system to:
a) receive, by one or more computing devices, input data;
b) process the input data with a projected gate convolution module and generating, by the projected gate convolution module, a first output data; and
c) process the first output data with a state space module and generating, by the state space module, a second output data,
optionally further comprising transmitting, by the one or more computing devices, the second output data to a user device associated with a user

53. (canceled)

54. The system of claim 52, wherein the input data is first processed by one or more linear projections module, one or more root mean square (RMS) normalizations modules, or a combination thereof;
optionally wherein the projected gate convolution module comprises one or more linear projections module, one or more root mean square (RMS) normalizations modules, or a combination thereof;
optionally wherein the one or more linear projections module comprises one or more weight matrix modules, one or more bias vector modules, one or more learnable filters module, or a combination thereof;
optionally wherein the one or more weight matrix modules, the one or more bias vector modules, or a combination thereof independently comprise a probability distribution or random assignment of matrix or vector components, optionally wherein the probability distribution is a gaussian distribution;
optionally wherein the one or more linear projections module, one or more root mean square (RMS) normalizations modules, or combination thereof are carried out in parallel; and
optionally wherein the method further comprises:
processing the second output data by the one or more linear projections module, one or more root mean square (RMS) normalizations modules, or a combination thereof;
generating, by the one or more linear projections module, one or more root mean square (RMS) normalizations modules, or a combination thereof, a third output data; and
transmitting, by the one or more computing devices, the third output data to a user device associated with a user.

55-58. (canceled)

59. The system of claim 52, wherein the projected gate convolution module is not pre-trained.

60-61. (canceled)

62. The system of claim 52, wherein the projected gate convolution module comprises one or more convolutional layer;
optionally wherein the one or more convolution layer comprises a one dimensional (1D) convolutional layer;
optionally wherein the projected gate convolution module comprises Fast Fourier Transform (FFT);
optionally wherein the 1D convolutional layer comprises FFT.

63-65. (canceled)

66. The system of claim 52, wherein the first output data comprises local features of the input data, global features of the input data, or a combination thereof, optionally wherein the local and global features are processes and generated in parallel.

67-68. (canceled)

69. The system of claim 52, wherein the projected gate convolution module comprises embedding.

70. The system of claim 52, wherein the state space module is a structured state space module;
optionally wherein there the structured state space module is a diagonalized structured state space module;
optionally wherein the state space module comprises a linear ordinary differential model or a convolutional model;
optionally wherein the state space module comprises a linear ordinary differential model or a convolutional model;
optionally wherein the linear ordinary differential model or a convolutional model comprises a learning parameter module;
optionally wherein the state space module comprises one or more convolutional kernels;
optionally wherein the one or more convolutional kernels parallelizes training and generating an output; and
optionally wherein the one or more convolutional kernels perform the computations independently.

71-76. (canceled)

77. The system of claim 52, wherein the input data comprises one or more strings of characters;
optionally wherein the one or more strings of characters comprises one or more amino acid sequence, one or more nucleic acid sequence, or a combination thereof;
optionally wherein the input data further comprises feature data of the one or more amino acid sequence, one or more nucleic acid sequence, or a combination thereof;
optionally wherein the one or more strings comprises one or more text; and
optionally wherein the one or more text comprises health records.

78-81. (canceled)

82. The system of claim 52, wherein the system comprises regression or classification, optionally wherein the second output data comprise one or more correlation or classification of one or more feature of the input data.

83. (canceled)

84. The system of claim 52, wherein the projected gate convolution module comprises generating local and global features in parallel, the method of the projected gate convolution module comprising of:
a. processing the input data by embedding the input data into a data structure comprising one or more features of the input data;
b. transforming the embedded data with one or more transformation layers;
c. projecting the transformed data with two or more weight matrix modules and two or more bias vector modules;
d. normalizing the projected data with two or more RMS normalizations modules, thereby generating preliminary local data and global data;
e. processing the preliminary local data with one or more 1D convolutional layers, the one or more 1D convolutional layers comprise one or more learnable filters and the one or more bias vector modules, thereby generating local data structure;
f. combining the local data and the global data, thereby generating universal data;
g. projecting the universal data with the one or more weight matrix modules and the one or more bias vector modules; and
h. normalizing the universal data with the one or more RMS normalizations modules, thereby generating the first output data comprising of the universal data.

85. The system of claim 52, further comprising training the projected gate convolution module, state space module, or a combination thereof with training data;
optionally wherein the training data comprises biological data, chemical data, or a combination thereof;
optionally wherein the biological data, chemical data, or a combination thereof comprises genomic data, proteomic data, epidemiological data, pharmacological data, epistatic data, or a combination thereof;
optionally wherein the training data comprises health record data and/or diagnostic data; and
optionally wherein the projected gate convolution module, state space module, or a combination thereof is trained using a method selected independently from the group consisting of unsupervised learning, supervised learning, semi-supervised learning, reinforcement learning, transfer learning, incremental learning, curriculum learning, learning to learn, and contrastive learning.

86-97. (canceled)

98. A system of:
a) determining chromatin profiling, wherein the input data is one or more nucleic acid sequences, and the second output data is one or more chromatin feature;
b) classifying gene regulating regions, wherein the input data is one or more nucleic acid sequences, and the second output data is a determination of one or more gene regulating regions;
c) designing guide molecules for programmable nucleases, wherein the input data is one or more guide-target pairs, and the second output data is activity of the one or more guide-target pairs;
d) determining protein fitness, wherein the input data is one or more amino acid sequence, and the second output data is stability, binding affinity, or a combination thereof of the one or more amino acid sequence; or
e) modeling protein features, wherein the input data is one or more amino acid sequence, and the second output data is remote homology, fluorescence, protein stability, or a combination thereof, and
wherein the system comprises the system of claim 52.

99-102. (canceled)

103. A computer program product, comprising:
a non-transitory computer-readable storage device having computer-executable program instructions embodied thereon that when executed by a computer cause the computer to carry out a machine learning method, the computer-executable program instructions comprising:
a) receive input data;
b) process the input data with a projected gate convolution module and generating, by the projected gate convolution module, a first output data; and
c) process the first output data with a state space module and generating, by the state space module, a second output data,
optionally further comprising computer-executable program instructions to transmit the second output data to a user device associated with a user.

104. (canceled)

105. The computer program product of claim 103, wherein the input data is first processed by one or more linear projections module, one or more root mean square (RMS) normalizations modules, or a combination thereof;
optionally wherein the projected gate convolution module comprises one or more linear projections module, one or more root mean square (RMS) normalizations modules, or a combination thereof;
optionally wherein the one or more linear projections module comprises one or more weight matrix modules, one or more bias vector modules, one or more learnable filters module, or a combination thereof;
optionally wherein the one or more weight matrix modules, the one or more bias vector modules, or a combination thereof independently comprise a probability distribution or random assignment of matrix or vector components, optionally wherein the probability distribution is a gaussian distribution;
optionally wherein the one or more linear projections module, one or more root mean square (RMS) normalizations modules, or combination thereof are carried out in parallel; and
optionally wherein the computer program product further comprises computer-executable program instructions to:
process the second output data by the one or more linear projections module, one or more root mean square (RMS) normalizations modules, or a combination thereof;
generate, by the one or more linear projections module, one or more root mean square (RMS) normalizations modules, or a combination thereof, a third output data; and
transmit the third output data to a user device associated with a user.

106-109. (canceled)

110. The computer program product of claim 103, wherein the projected gate convolution module is not pre-trained.

111-112. (canceled)

113. The computer program product of claim 103, wherein the projected gate convolution module comprises one or more convolutional layer;
optionally wherein the one or more convolution layer comprises a one dimensional (1D) convolutional layer;
optionally wherein the projected gate convolution module comprises Fast Fourier Transform (FFT);
optionally wherein the 1D convolutional layer comprises FFT.

114-116. (canceled)

117. The computer program product of claim 103, wherein the first output data comprises local features of the input data, global features of the input data, or a combination thereof, optionally wherein the local and global features are processes and generated in parallel.

118-119. (canceled)

120. The computer program product of claim 103, wherein the projected gate convolution module comprises embedding.

121. The computer program product of claim 103, wherein the state space module is a structured state space module;
optionally wherein there the structured state space module is a diagonalized structured state space module;
optionally wherein the state space module comprises a linear ordinary differential model or a convolutional model;
optionally wherein the state space module comprises a linear ordinary differential model or a convolutional model;
optionally wherein the linear ordinary differential model or a convolutional model comprises a learning parameter module;
optionally wherein the state space module comprises one or more convolutional kernels;
optionally wherein the one or more convolutional kernels parallelizes training and generating an output; and
optionally wherein the one or more convolutional kernels perform the computations independently.

122-127. (canceled)

128. The computer program product of claim 103, wherein the input data comprises one or more strings of characters;
optionally wherein the one or more strings of characters comprises one or more amino acid sequence, one or more nucleic acid sequence, or a combination thereof;
optionally wherein the input data further comprises feature data of the one or more amino acid sequence, one or more nucleic acid sequence, or a combination thereof;
optionally wherein the one or more strings comprises one or more text; and
optionally wherein the one or more text comprises health records.

129-132. (canceled)

133. The computer program product of claim 103, wherein the product comprises regression or classification, optionally wherein the second output data comprise one or more correlation or classification of one or more feature of the input data.

134. (canceled)

135. The computer program product of claim 103, wherein the projected gate convolution module comprises generating local and global features in parallel, the method of the projected gate convolution module comprising of:
a. processing the input data by embedding the input data into a data structure comprising one or more features of the input data;
b. transforming the embedded data with one or more transformation layers;
c. projecting the transformed data with two or more weight matrix modules and two or more bias vector modules;
d. normalizing the projected data with two or more RMS normalizations modules, thereby generating preliminary local data and global data;
e. processing the preliminary local data with one or more 1D convolutional layers, the one or more 1D convolutional layers comprise one or more learnable filters and the one or more bias vector modules, thereby generating local data structure;
f. combining the local data and the global data, thereby generating universal data;
g. projecting the universal data with the one or more weight matrix modules and the one or more bias vector modules; and
h. normalizing the universal data with the one or more RMS normalizations modules, thereby generating the first output data comprising of the universal data.

136. The computer program product of claim 103, further comprising training the projected gate convolution module, state space module, or a combination thereof with training data;
optionally wherein the training data comprises biological data, chemical data, or a combination thereof;
optionally wherein the biological data, chemical data, or a combination thereof comprises genomic data, proteomic data, epidemiological data, pharmacological data, epistatic data, or a combination thereof;
optionally wherein the training data comprises health record data and/or diagnostic data; and
optionally wherein the projected gate convolution module, state space module, or a combination thereof is trained using a method selected independently from the group consisting of unsupervised learning, supervised learning, semi-supervised learning, reinforcement learning, transfer learning, incremental learning, curriculum learning, learning to learn, and contrastive learning.

137-148. (canceled)

149. A computer program product of:
a) determining chromatin profiling, wherein the input data is one or more nucleic acid sequences, and the second output data is one or more chromatin feature;
b) classifying gene regulating regions, wherein the input data is one or more nucleic acid sequences, and the second output data is a determination of one or more gene regulating regions; or
c) modeling protein features, wherein the input data is one or more amino acid sequence, and the second output data is remote homology, fluorescence, protein stability, or a combination thereof, and
wherein the computer program product comprises the computer program product of claim 103.

150. (canceled)

151. A composition generated from the computer program product of claim 103, wherein the input data is one or more guide-target pairs, the second output data is activity of the one or more guide-target pairs, and the composition one or more guide molecules, or
wherein the input data is one or more amino acid sequence, and the second output data is stability, binding affinity, or a combination thereof of the one or more amino acid sequence.

152-153. (canceled)
